(19) United States
(12) Patent Application Publication
(10) Pub. No.: US 2024/0383087 A1
(43) Pub. Date: Nov. 21, 2024

(54) RUNOUT MONITORING MODULES AND RUNOUT MONITORING METHOD FOR A TOOL TO BE ROTATED DURING OPERATION

(71) Applicant: BLUM-NOVOTEST GMBH, Gruenkraut (DE)

(72) Inventors: Norbert MOERSCH, Wangen (DE); Stefan HAEFELE, Tettnang (DE); Martin KLUGGER, Gruenkraut (DE); Oliver STERN, Weingarten (DE)

(21) Appl. No.: 18/704,284

(22) PCT Filed: Oct. 26, 2022
(86) PCT No.: PCT/EP2022/079892

§ 371 Date: Apr. 24, 2024

(30) Foreign Application Priority Data
Oct. 29, 2021 (DE) 10 2021 128 314.0

(51) Int. Cl. B23Q 17/09

(52) U.S. Cl. CPC B23Q 17/0952; B23B 2260/128

(57) ABSTRACT

A monitoring module comprises a tool interface for holding the tool and a tool holding interface for insertion into a tool holder. The monitoring module has a sensor unit, whereby the axis of rotation of the monitoring module runs through the sensor unit. The sensor unit detects a variable representative of an acceleration in a plane normal to the axis of rotation of the monitoring module when the monitoring module rotates together with the tool/tool holder. A computing unit of the monitoring module receives the variables representative of the acceleration recorded by the sensor unit, determines a total acceleration from this, compares the total acceleration with a threshold value and determines that there is a concentricity error of the tool to be rotated, the monitoring module and/or the tool holder if the total acceleration is greater than the threshold value.

### TECHNICAL AREA

A concentricity monitoring module, a concentricity monitoring tool holder module and a concentricity monitoring tool module for a tool to be rotated during operation are described here. Furthermore, a machine tool ne/machining center and a concentricity monitoring signal interface are described, which interact operatively with the concentricity monitoring module/the concentricity monitoring tool mounting module/the concentricity monitoring tool module for monitoring the concentricity of the tool to be rotated during operation. A concentricity monitoring method for a tool to be rotated in a machine tool/machining center is also described, which is executed by the concentricity monitoring module/the concentricity monitoring tool holder module/the concentricity monitoring tool module, possibly by interacting with the machine tool/the machining center and/or with the concentricity monitoring signal interface. A computer program product comprises commands that cause the execution of the process steps of the concentricity monitoring process.

### BACKGROUND

Individual monitoring modules for monitoring the concentricity of a tool to be rotated during operation are described here. The tool is mounted in a workpiece processing machine. The workpiece processing machine ne can be, for example, a (numerically controlled) machine tool (NC machine), a (multi-axis) machining center, a (multi-axis) milling machine, a flexible manufacturing cell or the like. In the following, the terms machine tool and machining center are also used for such machines.

A machine tool of this type has a (main) spindle into which tools to be used when machining a workpiece, such as drills, milling cutters etc., or the workpieces themselves are inserted. The spindle can be in a fixed position or, for example, can be moved in three orthogonal directions X, Y, Z within a working area of the machine tool. The spindle can also be driven to rotate around the X, Y and Z axes. In modern machining centers, tools often have to be changed during the machining of a single workpiece. This is usually done by automatically changing the tools, whereby a tool located in the spindle is replaced by another tool located in a tool magazine of the machine tool. During the tool change, a clamping device of the spindle for holding the tools is exposed in the working area of the machine. The same can apply to the tools and any pre-mounted tool holders. As a result of chips and other impurities, deposits can build up on the clamping device of the spindle and/or on the tools. In modern machine tools, the clamping device is usually designed as a taper interface and in particular steep tapers (SK) or hollow shank tapers (HSK) are used to insert the tools. If, for example, chips accumulate on the taper interface and/or on the HSK/SK during a tool change, an error-free face contact/complete retraction of the tool or its holder is no longer guaranteed, as the chips are trapped between the taper interface and the holder. When the tool rotates with the spindle in the sequence, a kind of wobbling movement occurs, which results from an imbalance caused by the lack of face contact/incomplete retraction. If the wobbling movement exceeds a permissible level, the tool is said to have a concentricity error. If the concentricity error is not noticed and no countermeasures are taken, radial run-out occurs in the rotating tool during workpiece machining, which leads to non-accurate machining results, inadequate surface quality and imbalance of the tool. Furthermore, a concentricity error puts a strain on the tool itself, as it can lead to increased wear and consequently to damage to the tool (up to and including tool breakage). Concentricity errors can even occur if the tools and the spindle are cleaned during the tool change, e.g. by supplying (cooling) lubricant or compressed air. Another reason for a concentricity error can be damage to the spindle itself. It is therefore important to quickly detect and accurately assess concentricity errors during operation of rotating tools in order to ensure satisfactory machining results and a stable machining environment.

### STATE OF THE ART

One way of detecting a faulty face contact of a tool in the spindle of a machine tool is to monitor the face contact using compressed air. Compressed air is applied in the area of the taper interface of the machine tool in such a way that compressed air escapes between the spindle and the tool holder if the facing system is faulty. By detecting this loss of pressure, the faulty facing system is identified.

The Planko sensor system from OTT-JAKOB Spanntechnik GmbH, D-87663 Lengenwang, determines the flatness of a tool on a machine tool by interrogating several ceramic sensors (resonators). The system is based on a compact, passive electronic assembly consisting of a resonator, cable and connector, which is integrated into the spindle nose. The flatness is determined by the sequential scanning of the resonators during rotation. In the read head, the current measurement results are compared with a previously defined reference value stored in the internal memory. If there is a deviation from the reference value, the measurement data is recorded via a comparator signal and forwarded to the machine control system. In addition thereto, there are at least some measuring systems integrated into the spindle of a machine tool for monitoring the facing system, which utilise force sensors, electromagnetic signals or laser light for evaluation, for example. In this context, reference is also made, for example, to DE 10 2013 201 328 A1, DE 10 2018 201 427 A1, DE 103 51 347 A1, EP 3 360 642 A1, DE 10 2013 100 975 B3 and EP 3 581 328 A1.

Laser measuring systems such as the LC50-DIGILOG from Blum-Novotest GmbH, DE-88287 Grunkraut, Germany, offer another option for monitoring concentricity errors on the rotating tool. This system detects concentricity errors on the rotating tool, which are caused, for example, by a dirty contact surface of the tool holder. Specific tool data is required for each tool and the measurement depends on the desired measuring point. In a learning cycle, a basic concentricity error is first determined, which represents the difference between the longest and shortest cutting edge of the tool. A statement about the concentricity error caused by contamination on the contact surface can then be made by measuring the cylindrical shank of the tool in comparison to the effects on the cutting edges to determine whether a currently measured concentricity error is greater or smaller than the stored basic concentricity error. Calculations are carried out by NC programmes, whereby radius changes of the longest cutting edges in particular are taken into account as wear values.

There are also intelligent tools for monitoring various process variables during machining. In WO 2021/029 404 A1, for example, a vibration of a rotatable tool is determined by means of several acceleration sensors mounted symmetrically on the tool shank with respect to the axis of rotation of the tool. Similarly, according to WO 2021/029 099 A1, vibrations are determined from signals from acceleration sensors and strain gauges attached to the outside of the shank (e.g. of a rolling or milling tool). WO 2019/122 375 A1 describes a sensor module for a rotating tool holder for machining tools, for example, in order to enable reliable detection of operating or system states in real time. For this purpose, a sensor module containing sensors for detecting the application of force, temperature and acceleration (vibrations) is positioned favourably in the tool holder in the axis of rotation and a coolant flow is directed around this position by design. This positioning of the sensor module serves to minimise imbalances and simplify the insertion of the sensor module. The measurement signals are preferably transmitted by radio via a transmitter and an antenna to a machine tool receiver. A control arrangement in the machine tool enables an ad-hoc reaction to instability states that have not yet stabilised. This is realised by a real-time adaptation of machining parameters, such as feed rate, speed, etc., whereby this adaptation is implemented as a function of the process states, such as vibration or the force applied to the tool. Tool systems with monitoring of process variables are also disclosed in WO 2021/033 670 A1, EP 2 103 379 A1, U.S. Pat. No. 10,828,740 B2, U.S. Pat. No. 10,828,739 B2, EP 3 808 503 A1, US 2021/026 322 A1 and JP 5 089 342 B2.

These tool systems are conventionally powered by batteries, for example. However, some tool systems have devices for generating energy in the sense of energy harvesting in order to supply the tool system itself, including the integrated electronics, with energy. For example, EP 3 539 717 A1 describes a machining tool with a generator unit. A first component is permanently connected to the body of the machining tool and a second component is movably connected to the body. When there is a fluid flow to the second component, electrical energy is generated by its relative movement to the first component. EP 2 112 461 B1 describes a measuring probe with a current generator, whereby a flywheel is rotatably connected to the measuring probe. A rotor of the current generator has permanent magnets and is connected to the flywheel, while a stator with induction windings is attached inside the housing of the probe. When a rotational movement of the probe housing is accelerated, the flywheel does not immediately follow the housing movement due to its high moment of inertia. This difference in movement converts kinetic energy into electrical energy for as long as it exists. The flywheel is equipped with a freewheel. Whilst it follows the housing rotation in a first direction of rotation, it can only rotate freely in a second direction of rotation opposite to the first, so that electrical energy is generated. Further tool systems with an energy harvesting principle are also disclosed in DE 10 2016 223 199 A1, US 2015/0 125 230 A1, EP 1 742 011 B1 and TW 1491463 B.

Although the above-mentioned devices and processes for monitoring the concentricity of tools work according to different detection principles, there are ways of improving the reliability and speed of detection of the facing system, particularly with regard to tools for monitoring concentricity. There is also room for improvement in terms of reducing system costs.

For example, in the case of the monitoring of the flat plane using compressed air described above, the pressure does not remain constant if the flat plane is faulty, but more air escapes with increasing time. Monitoring using compressed air therefore only provides limited results. In addition, this system is not able to detect a faulty flat plane if chips accumulate directly at the air outlet on the flat plane and thus block this air outlet. The Planko sensor system from OTT-JAKOB Spanntechnik GmbH, D-87663 Lengenwang, has to be integrated into the spindle nose in a complex manner, which is associated with high system costs. In addition, according to this sensor system, the correct face contact is determined by interrogating several ceramic sensors. In the process, in particular rubbed and/or crushed aluminium chips can adhere to the ceramic sensors. This leads to a total failure of the sensor system, which then no longer recognises any concentricity errors, resulting in a time-consuming and expensive replacement of the sensors. Even if force sensors are integrated in the spindle nose, as for example according to EP 3 360 342 A1, this is associated with complex integration and therefore high system costs. In addition, data acquisition and data evaluation are complex with these systems.

With concentricity monitoring devices that work with laser measuring systems, determining the concentricity is generally time-consuming, as—regardless of the comparatively long measurement time—exact spindle positioning in the measuring room or at the measuring point is necessary.

Although tools equipped with various sensors are now available, e.g. temperature sensors, force sensors and acceleration sensors, these tools are used to record process parameters such as vibrations or cutting forces. However, none of these tools is able to detect a clamping error; there is still no concentricity monitoring integrated into a rotating tool. EP 2 208 017 A2 relates to a technology for regulating the transmission power of a transmitter/receiver device in a position measuring system of a machine, which enables robust and time-critical data transmission and fast connection establishment with low energy consumption. A first transmission power message is sent with a first transmission power and a second transmission power message is sent with a second transmission power, the latter being less than the first transmission power if a transmission power confirmation message was received in response to the first transmission power message sent, and the second transmission power being greater than the first transmission power if no transmission power confirmation message was received in response to the first transmission power message sent. The transmission power messages are used to determine whether radio communication between the transmitter/receiver device and a base station is possible with the current transmission power. Depending on the transmission conditions via the air interface, i.e. in the event of interference with other signals, the transmission power of the transceiver is readjusted. In this way, the lower transmission power limit can be determined in order to avoid permanent transmission with excessive transmission power. This saves energy in the transceiver. The transceiver sends the transmission power messages to a base station connected to the transceiver. After transmitting the transmit power message, the transceiver waits for a transmit power confirmation message to be received. If the transmit power message is received by a base station connected to the transceiver, the base station sends a transmit power confirmation message. Depending on the receipt of the transmission power confirmation message, the transceiver knows whether a radio connection between the transceiver and the base station is possible. Depending on this information, the transceiver can increase or decrease the transmission power for a subsequent transmission power message.

After the second transmit power message, a third transmit power message can be sent with a third transmit power. If the transmission power of the second transmission power message was lower than the transmission power of the first transmission power message and a transmission power confirmation message is received for the second transmission power message, the third transmission power is lower than the second transmission power. If the transmission power of the second transmission power message was less than the transmission power of the first transmission power message and no transmission power confirmation message is received for the second transmission power message, the third transmission power is greater than the second transmission power. If the transmission power of the second transmission power message was greater than the transmission power of the first transmission power message and a transmission power confirmation message is received in response to the second transmission power message, the third transmission power is equal to the second transmission power. If the transmission power of the second transmission power message was greater than the transmission power of the first transmission power message and no transmission power confirmation message is received in response to the second transmission power message, the third transmission power is greater than the second transmission power.

### Problem to be Solved

The aim of the solution presented here is to provide a methodology and devices for monitoring the concentricity of a rotating tool (during operation).

### Solution Presented Here

One of these devices is a machine tool-independent runout monitoring module with an integrated tool, which is able to determine the runout error (or underlying data) during rotation and, if necessary, to send one or more corresponding status and/or measurement signals, in particular via a communication interface, to the control of a (runout monitoring) signal interface or a machine tool. The devices and methods improve the existing solutions in terms of accuracy and speed of detecting the face contact (and subsequently checking the concentricity) and are quick, easy and inexpensive to manufacture (in comparison to spindle-integrated systems, even significantly cheaper). Simple integration into existing machine tools or a simple combination with available tools or tool systems is also possible. This makes it possible to assemble task-specific tools with concentricity monitoring function according to requirements with little effort.

According to a first aspect, this task is solved by a concentricity monitoring module for a tool to be rotated during operation. The concentricity monitoring module comprises a tool interface, set up for receiving the tool to be rotated, and a tool receiving interface, set up for insertion into a tool holder, in particular of a machine tool or a machining center. In addition, the concentricity monitoring module comprises a sensor unit which is assigned to the concentricity monitoring module in such a way that an axis of rotation of the concentricity monitoring module runs through the sensor unit, whereby the sensor unit is set up to detect variables representative of an acceleration in a plane orientated essentially normal to the axis of rotation of the concentricity monitoring module when the concentricity monitoring module rotates, in particular together with the tool to be rotated and/or with the tool holder. A computing unit of the concentricity monitoring module is set up to receive the quantities representative of the acceleration detected by the sensor unit, to determine a total acceleration based on the detected quantities representative of the acceleration, to compare the total acceleration with a threshold value dependent on a rotational speed of the concentricity monitoring module during the detection of the quantities representative of the acceleration and to determine that a concentricity error of the tool to be rotated, the concentricity monitoring module and/or the tool holder is present if the total acceleration is greater than the threshold value. A communication unit of the concentricity monitoring module is communicatively connected to the computing unit and is set up to signal to the machine tool/machining center whether or not there is a concentricity error of the tool to be rotated, the concentricity monitoring module and/or the tool holder.

The tool interface can be, for example, an ABS holder (ABS system) or an ABS adapter (ABS connection) into which the tool to be rotated or a corresponding ABS adapter of the tool to be rotated can be inserted. This ABS system can be an ABS system from Ceratizit S. A., for example. Alternatively, it is possible for the tool interface to be equipped with a collet holder into which the tool to be rotated can be inserted. Finally, the tool interface can be connected stably and concentrically to the tool to be rotated in any other suitable way.

Similarly, the tool holder interface can be designed as an ABS adapter in order to be inserted into the tool holder, which is also designed as an ABS holder, for example. This tool holder can be pre-assembled on the machine tool/machining center, or only inserted into the machine tool together with the concentricity monitoring module between the concentricity monitoring module and the spindle. Alternatively, the tool holder interface can also be connected to the tool holder in a stable and concentric manner in any other suitable way.

The concentricity monitoring module thus establishes a customisable connection with a concentricity monitoring function between the spindle of a machine tool and the tool to be rotated. In this way, a structure of a modular concentricity monitoring module is provided that is suitable for every common machine tool interface such as SK, SK-FC, BT, BT-FC, HSK-A, PSC and HSK-E and thus offers the greatest possible flexibility without loss of the concentricity monitoring function, as different tools with different spindle interfaces can be combined for machining workpieces.

A second aspect relates to a concentricity monitoring tool holder module for a tool to be rotated during operation. The concentricity monitoring tool holder module comprises a tool interface, adapted to receive the tool to be rotated, and a tool holder, adapted to be inserted into a spindle of a machine tool or machining center. The concentricity monitoring tool holder module also comprises a sensor unit which is assigned to the concentricity monitoring tool holder module in such a way that an axis of rotation of the concentricity monitoring tool holder module runs through the sensor unit, whereby the sensor unit is set up for this purpose, to detect variables representative of an acceleration in a plane orientated essentially normal to the axis of rotation of the concentricity monitoring tool mounting module when the concentricity monitoring tool mounting module rotates, in particular together with the tool to be rotated and/or with the spindle. A computing unit of the concentricity monitoring tool holder module is set up to receive the variables representative of the acceleration detected by the sensor unit and to determine a total acceleration based on the detected variables representative of the acceleration, to compare the total acceleration with a threshold value dependent on a rotational speed of the concentricity monitoring tool holder module during the detection of the variables representative of the acceleration and to determine that a concentricity error of the tool to be rotated and/or the tool holder is present if the total acceleration is greater than the threshold value. A communication unit of the concentricity monitoring tool holder module is communicatively connected to the computing unit and is set up to signal to the machine tool/machining center whether or not there is a concentricity error of the tool to be rotated and/or the tool holder.

The tool interface can, for example, be an ABS holder (ABS system) or an ABS adapter (ABS connection) into which the tool to be rotated or a corresponding ABS adapter of the tool to be rotated can be inserted. Alternatively, it is possible that the tool interface is equipped with a collet holder into which the tool to be rotated can be inserted.

The tool holder can be designed as an ABS holder and in particular as an HSK or SK, which is used to insert the concentricity monitoring tool holder module into the spindle of the machine tool/machining center.

The concentricity monitoring tool holder module can therefore consist of a central housing in which the sensor unit, the computing unit and the communication unit are accommodated and which is permanently connected to the tool holder. The concentricity monitoring tool holder module, which establishes a connection between the spindle and the tool to be rotated, thus offers the option of using different tools flexibly for machining workpieces without losing the concentricity monitoring function.

A third aspect relates to a concentricity monitoring tool module. The concentricity monitoring tool module comprises a tool to be rotated during operation and a tool holder me, set up for insertion into a spindle of a machine tool or a machining center. The concentricity monitoring tool module also comprises a sensor unit which is assigned to the concentricity monitoring tool module in such a way that an axis of rotation of the concentricity monitoring tool module runs through the sensor unit, wherein the sensor unit is set up to detect variables representative of acceleration in a plane orientated essentially normal to the axis of rotation of the concentricity monitoring tool module when the concentricity monitoring tool module rotates, in particular together with the spindle. A computing unit of the concentricity monitoring tool module is arranged to receive the quantities representative of the acceleration detected by the sensor unit, to determine a total acceleration based on the detected quantities representative of the acceleration, to compare the total acceleration with a threshold value dependent on a rotational speed of the concentricity monitoring tool module during the detection of the quantities representative of the acceleration, and to determine that a concentricity error of the concentricity monitoring tool module is present if the total acceleration is greater than the threshold value. A communication unit of the concentricity monitoring tool module is communicatively connected to the computing unit and is set up to signal to the machine tool/machining center whether or not there is a concentricity error of the concentricity monitoring tool module.

The tool holder can therefore be a mechanical interface between the tool to be rotated and the spindle of the machine tool. The tool holder can be designed as an ABS holder and in particular as an HSK or SK, which is used to insert the concentricity monitoring tool module into the spindle of the machine tool/machining center.

The concentricity monitoring tool module, which establishes the connection between the spindle and the tool to be rotated, can be manufactured as a unit by a tool manufacturer, for example. This eliminates the need for detachable interfaces (and therefore possible sources of contamination or build-up that prevent an exact axial run-out), such as the tool interface and the tool mounting interface according to the first aspect. This means that different tools can be provided with further improved concentricity monitoring function, which is particularly in demand for high-precision applications.

When features of a “module” or a “monitoring module” are described below, these features may in particular refer respectively to the concentricity monitoring module according to the first aspect, to the concentricity monitoring tool holder module according to the second aspect and to the concentricity monitoring tool module according to the third aspect. This applies in particular when components such as the computing unit, the sensor unit and the communication unit are described, which are contained in the modules according to the first to third aspects.

The computing unit of the monitoring module can be included in a data processing unit. This data processing unit can also include an (intermediate) memory. In this way, the variables recorded by the sensor unit can be processed and temporarily stored in the data processing unit or transmitted as data to the machine tool or a concentricity monitoring signal interface. The data processing unit, the sensor unit and the communication unit (also data transmission unit) can be comprised of an electronics unit.

Digital IO signals (IO: OK, or NOK: not OK) can be transmitted to the machine tool as 1-bit signals when signalling whether there is a concentricity error in the tool to be rotated. As with the rest of the communication between the monitoring module and the machine tool, the transmission can be wireless.

The sensor unit can comprise an acceleration sensor. The acceleration sensor can be a piezoelectric acceleration sensor or be based on a spring-mass system. Alternatively, strain gauges can be used or acceleration sensors that work with magnetic induction.

The acceleration sensor of the sensor unit can be a two-axis acceleration sensor, which is set up, for example, to measure accelerations in orthogonal x and y directions. Alternatively, the acceleration sensor can be two single-axis acceleration sensors, in particular of identical construction, which are arranged e.g. one above the other or next to each other and offset by 90° with respect to their sensitive axes (the axes of inertia in which accelerations are measured), so that accelerations can be measured in orthogonal x and y directions. Alternatively, a three-axis acceleration sensor can also be used to additionally record process variables such as vibrations in a z-direction orthogonal to the x- and y-directions.

The axis of rotation of the monitoring module can run at least approximately centrally through a body of the sensor unit, but does not have to run through the acceleration sensor itself (although this is of course also possible). In other words, the sensor unit can be arranged within the monitoring module such that at least one axis of inertia of the sensor unit is orientated at least approximately coaxially to the axis of rotation of the monitoring module, in particular within a tolerance distance. This axis of inertia can be the z-axis of the acceleration sensor, even in the case of a biaxial acceleration sensor that is set up to measure accelerations in the x and y directions. In other words, this axis of inertia does not have to coincide with a sensitive axis of the sensor unit (this also applies if the sensor unit comprises two single-axis acceleration sensors), which is, however, the case with a three-axis acceleration sensor.

If a two- or three-axis acceleration sensor is used, it can comprise two or three measuring chips (for two or three different measuring directions) that are minimally spaced apart from each other. In order to obtain acceleration values close to zero with perfect concentricity, the sensor unit can be arranged in the monitoring module in such a way that the orientations of an x measuring chip (which measures accelerations in the x direction) of the two- or three-axis acceleration sensor coincide with the y-z plane of the monitoring module and a y measuring chip (which measures accelerations in the y direction) of the two- or three-axis acceleration sensor coincide with the x-z plane of the monitoring module. In these variants, the axis of inertia of the sensor unit, which is orientated at least approximately coaxially to the axis of rotation of the monitoring module, particularly within the tolerance distance, is not a sensitive axis of one of the measuring chips itself, but the z-axis of inertia of the body of the sensor unit.

The spatially separated arrangement of the x- and y-measuring chips allows a circular recess, for example, to extend through the body of the sensor unit along the z-axis of inertia of the sensor unit body and between the individual measuring chips.

In particular, the tolerance distance can be a radial (normal) distance from the axis of rotation of the monitoring module to the axis of inertia of the sensor unit, which can be in a range of up to ±10 μm.

The fact that the axis of inertia of the sensor unit is orientated at least approximately coaxially to the axis of rotation of the monitoring module means that there can be a maximum angular error (angular offset) of up to ±3 between the axis of inertia and the axis of rotation.

In principle, the sensor unit can be arranged in the monitoring module in such a way that, in the event of a given concentricity error, there is a change in position or orientation of the sensor unit to a known position at a known speed, in particular due to prior calibration. This indicates a faulty flat contact of the monitoring module with the tool holder (spindle) of the machine tool.

In particular, the sensor unit can therefore be mounted in the monitoring module in such a way that the acceleration sensor is arranged as ideally as possible in the axis of rotation. This makes it possible to detect the variables representative of the acceleration in the x-y plane, which is normal to the axis of rotation (which runs in the z direction), as a tilt and/or a lateral offset of the axis of rotation of the monitoring module, caused for example by a jammed chip or a defective spindle, is detected as a change in the acceleration in the (radial) x-y plane. This change can preferably relate to reference acceleration values determined in the course of a calibration process and thus to a “learnt” reference system.

The positioning of the sensor unit can therefore be selected so that the acceleration sensor delivers the largest possible deflection with the lowest possible tilt/eccentricity, so that the acceleration sensor reliably detects the increasing concentricity error with increasing tilt (of the monitoring module relative to the spindle or to an axis of rotation of the spindle of the machine tool).

An acceleration sensor positioned exactly in the axis of rotation of the monitoring module measures a centrifugal acceleration of zero even at comparatively high speeds (radial distance of the acceleration sensor from the axis of rotation of the monitoring module r=0). An offset from the center, for example due to a clamping error (r≠0), on the other hand, causes the acceleration sensor to experience centrifugal acceleration during rotation. To monitor the tool rotation, this centrifugal acceleration in the x-y plane (plane of rotation) in particular can be recorded as the variables representative of the acceleration. The selected position of the acceleration sensor in the monitoring module, which aligns it as centrally as possible to the tool holder of the machine tool when the monitoring module is inserted into the machine tool, can ensure in particular that a maximum change in the centrifugal forces acting on the acceleration sensor is given with the smallest concentricity errors.

For the centrifugal acceleration a applies: a=ω²*r where ω=2*π*n and therefore a=4*π²*n²*r where n=speed of the monitoring module (and consequently the sensor unit) in 1/sec, ω=angular velocity and r=radial distance of the acceleration sensor from the axis of rotation of the monitoring module.

The speed is included in this calculation of the centrifugal acceleration squared. It can therefore be important for the detection (determination of the centrifugal acceleration) that the speed at which the detection takes place is known exactly. This (test) speed can, for example, have an essentially constant value over the entire detection or alternatively lie within a tolerance range of up to ±10% of a specified speed value.

The sensor unit can be used to record the variables representative of the acceleration within a specific evaluation time (also referred to as the recording time). The evaluation time can be a time window of a few seconds, e.g. 0.1 seconds to 5 seconds. In particular, however, it can alternatively also be a certain number of revolutions (of the monitoring module and thus also of the tool in the machine tool), over which the variables representative of the acceleration are recorded. The evaluation time can, for example, be 4 or 8 or 16 or 32 or 64 revolutions, but the present disclosure is not limited to this. This “evaluation time” also applies to all other variables to be detected by the monitoring module, unless otherwise specified in the relevant places.

Since the direction of the center offset (eccentricity) is not known prior to detection, acceleration values in the x and y directions (in the plane of rotation) can be detected in particular by means of the two-axis acceleration sensor or by means of the three-axis acceleration sensor and calculated to form a (total) acceleration vector. In this way, the total acceleration value can be determined from the values recorded by the sensor unit that are representative of the acceleration as follows a_tot=√(a_x\hat{ }2+a_y\hat{ }2). If this total acceleration value exceeds the threshold value defined for the speed during detection, an error (NOK) can be signalled to the machine tool. Alternatively or additionally, the center offset can be calculated and transmitted to the machine tool as a value.

The calculation of the total acceleration and other calculations described in the context of this disclosure, which are based on variables recorded by the sensor unit, can in each case be performed based on acceleration values output by the acceleration sensor. Alternatively, it is possible for such calculations to be performed using (digital) transducer values (raw data) generated by a transducer associated with the acceleration sensor.

The data processing unit (computing unit) of the monitoring module can be connected to the sensor unit via a digital or analogue communication interface. For example, a digital SPI or I²C interface between the sensor unit and the data processing unit is possible. It is also conceivable to provide analogue acceleration values at the output of the sensor unit and then record these analogue acceleration values in the data processing unit using an analogue-to-digital converter (ADC).

A fourth aspect relates to a machine tool or machining center. The machine tool/machining center comprises a spindle to be rotated about an axis of rotation during operation of the machine tool/machining center, which spindle is arranged to receive a tool receiving interface of a concentricity monitoring module according to the first aspect, a tool holder of a concentricity monitoring tool receiving module according to the second aspect and/or a tool holder of a concentricity monitoring tool module according to the third aspect and to cooperate operatively therewith. A communication unit of the machine tool/machining center is arranged to receive signals from the communication unit of the runout monitoring module according to the first aspect, the communication unit of the runout monitoring tool holder module according to the second aspect and/or the communication unit of the runout monitoring tool module according to the third aspect. A controller of the machine tool/machining center is connected to the communication unit of the machine tool/machining center and is arranged to receive acceleration representative quantities detected by the sensor unit of the runout monitoring module according to the first aspect, the sensor unit of the runout monitoring tool holder module according to the second aspect and/or the sensor unit of the runout monitoring tool module according to the third aspect, determining a total acceleration based on the detected acceleration representative quantities, comparing the total acceleration with a threshold value dependent on a rotational speed of the spindle during detection of the acceleration representative quantities, and determining that a runout error of the runout monitoring module according to the first aspect, the runout monitoring tool pickup module according to the second aspect, and/or the runout monitoring tool module according to the third aspect is present when the total acceleration is greater than the threshold value.

In particular, the spindle of the machine tool/machining center can be set up to interact operatively with tool holders such as steep tapers or hollow shank tapers.

Via the communication unit, which can also fulfil the function of a data transmission unit and which can be part of an interface on the machine tool side, the variables representative of the acceleration received by the monitoring module can be transmitted as process data to the control system of the machine tool. Alternatively, the variables representative of the acceleration can be transmitted to the control system of the machine tool via a separate data transmission unit, which can be set up in particular for wireless data and signal transmission from/to the monitoring module and in particular for wired data and signal transmission from/to the machine tool. Preferably, radio-based transmission techniques or transmission by means of infrared signals can be considered for wireless transmission.

The controller can also be set up to cause the spindle to rotate at a certain speed when the variables representative of the acceleration are detected and/or to transmit this speed to the monitoring module. If there is no concentricity error, a center axis of the monitoring module can run essentially coaxially to the axis of rotation of the spindle to be rotated. The machine tool/machining center can also be set up to initiate an (automatic) insertion of the monitoring module into the spindle of the machine tool. The machine tool/machining center can also be set up to signal to the monitoring module, e.g. via the communication unit, that the acquisition of the variables representative of the acceleration should start. This start command for acquisition can, for example, only be transmitted to the monitoring module after the machine tool has signalled to the monitoring module that it is ready for data acquisition (in this case of the variables representative of the acceleration).

If the control system of the machine tool/machining center determines that there is no concentricity error in the monitoring module, the machine tool/machining center can also be set up to enable workpiece machining of a workpiece to be machined by the machine tool, in particular directly after determining that there is no concentricity error. Machining can then begin immediately without any further tool changes being necessary.

If the control system of the machine tool/machining center determines that a concentricity error is present, the machine tool/machining center can also be set up to block a pending workpiece machining operation, stop the spindle and put the entire machine tool into a safe state and/or output an optical and/or acoustic error signal, e.g. via a display and/or a loudspeaker of the machine tool/machining center. Before one or more of these measures are taken, the machine tool/machining center can be set up to remove the monitoring module and/or the tool from the spindle and replace it. In the meantime, the spindle (taper interface) can be blown off with a stream of compressed air for cleaning. The corresponding measures are then only taken if the concentricity error persists after the monitoring module has been replaced.

A fifth aspect relates to a runout monitoring signalling interface. The runout monitoring signal interface comprises a communication unit arranged to receive signals from a communication unit of a runout monitoring module according to the first aspect, a communication unit of a runout monitoring tool holder module according to the second aspect and/or a communication unit of a runout monitoring tool module according to the third aspect, and to transmit signals to a communication unit of a machine tool/machining center according to the fourth aspect. The runout monitoring signal interface further comprises a computing unit which is connected to the communication unit of the runout monitoring signal interface and is arranged to receive acceleration representative quantities detected by the sensor unit of the runout monitoring module according to the first aspect, the sensor unit of the runout monitoring tool holder module according to the second aspect and/or the sensor unit of the runout monitoring tool module according to the third aspect, to determine a total acceleration based on the detected acceleration representative quantities, comparing and determining the total acceleration with a threshold value dependent on a rotational speed of the spindle, a rotational speed of the runout monitoring module, a rotational speed of the runout monitoring tool holder module or a rotational speed of the runout monitoring tool module during the detection of the quantities representative of the acceleration. that a runout error of the runout monitoring module according to the first aspect, the runout monitoring tool holder module according to the second aspect and/or the runout monitoring tool module according to the third aspect is present if the total acceleration is greater than the threshold value. The communication unit of the runout monitoring signal interface is arranged to signal to the machine tool/machining center whether or not there is a runout error of the tool to be rotated during operation, the runout monitoring module, the runout monitoring tool holder module and/or the runout monitoring tool module.

The concentricity monitoring signal interface with its computing unit (data processing unit) and communication unit components can communicate with the monitoring module via the communication unit or via a separate data transmission unit. This data transmission unit can be used in particular for wireless data and signal transmission between the monitoring module and the concentricity monitoring signal interface and in particular for wired data and signal transmission between the concentricity monitoring signal interface and the machine tool. Preferably, radio-based transmission techniques or transmission by means of infrared signals can be considered for wireless transmission.

The concentricity monitoring signal interface can therefore be used to perform the same calculations as with the monitoring module if the monitoring module transmits the corresponding measured variables (in this case the variables representative of the acceleration) to the concentricity monitoring signal interface. Once these calculations have been carried out, calculated results such as the total acceleration and/or the measured variables on which the calculation is based can be transmitted to the machine tool controller in addition to signalling whether a concentricity error is present (OK or NOK signal). If larger amounts of data are transmitted, this can be in the form of data words between the concentricity monitoring signal interface and the machine tool, whereby a digital bus system can be used for transmission in particular. Preferably, field bus systems such as Profibus, Profinet, Ethercat or Ethernet can be used for this purpose.

The concentricity monitoring signal interface can also be set up to activate the monitoring module, i.e. to set it to a monitoring mode (measuring mode) before the monitoring module determines the variables representative of the acceleration. Furthermore, the concentricity monitoring signal interface can also be set up to determine the rotational speed during the acquisition of the measured variables and transmit it to the monitoring module and/or to the machine tool/machining center. Alternatively or additionally, the rotational speed can be specified by the control system of the machine tool during detection or determined by the monitoring module and transmitted to the concentricity monitoring signal interface.

The concentricity monitoring signal interface can be set up to wait for a signal from the monitoring module, in particular when the monitoring module is activated, with which the monitoring module signals that it is ready for data acquisition. After data acquisition is complete, the concentricity monitoring signal interface can be set up to deactivate the monitoring module again, i.e. to put it in a state in which concentricity monitoring is not possible. This allows energy to be saved between individual concentricity measurements. Both the activation and deactivation of the monitoring module can alternatively be carried out by the monitoring module itself or by the machine tool/machining center. The concentricity monitoring signal interface can be set up to transmit the result of whether a concentricity error is present to the machine tool controller by means of a test signal (OK or NOK), so that the machine tool controller can take the measures described above (block machining, display error, etc.) if necessary.

A sixth aspect relates to a concentricity monitoring method for a tool to be rotated in a machine tool or machining center during operation. The concentricity monitoring method comprises the following steps: (i) automatically inserting a monitoring module to be rotated in operation or the monitoring module to be rotated in operation and the tool to be rotated into a spindle of the machine tool/machining center, wherein the monitoring module to be rotated comprises a sensor unit associated with the monitoring module to be rotated such that an axis of rotation of the monitoring module to be rotated passes through the sensor unit; (ii) rotating the spindle of the machine tool/machining center at a predetermined rotational speed; (iii) receiving and/or detecting quantities representative of acceleration in a plane oriented substantially normal to the axis of rotation of the monitoring module to be rotated, while the monitoring module to be rotated rotates at the predetermined speed; (iv) determining a total acceleration based on the detected quantities representative of acceleration; (v) comparing the total acceleration with a threshold value dependent on a rotational speed of the monitoring module to be rotated while detecting the acceleration representative quantities; and (vi) determining that a runout error of the monitoring module to be rotated and/or the tool to be rotated exists when the total acceleration is greater than the threshold value.

The “rotating monitoring module” is to be understood in particular as the concentricity monitoring tool module according to the third aspect, which already has an integrated tool. On the other hand, the “monitoring module to be rotated during operation and the tool to be rotated” refers in particular to the concentricity monitoring module according to the first aspect and the concentricity monitoring tool holder module according to the second aspect, into which a tool to be rotated during operation is inserted prior to workpiece machining.

The concentricity monitoring process or individual steps thereof can be carried out or at least initiated by different components such as the monitoring module (which is always responsible for recording the variables representative of the acceleration by means of the sensor unit), the machine tool/machining center and/or the concentricity monitoring signal interface. Thus, in one variant, it is envisaged that all steps of the concentricity monitoring process are carried out by the machine tool. Step (iii) then comprises, in particular, receiving the variables representative of the acceleration from the monitoring module and/or from the concentricity monitoring signal interface.

In certain variants, only steps (i) and (ii) of the concentricity monitoring process can be carried out by the machine tool. Steps (iii) to (vi) can then be carried out by the monitoring module or by the concentricity monitoring signalling interface, whereby in the latter case, step (iii) then in particular comprises receiving the variables representative of the acceleration by the concentricity monitoring signalling interface. Further steps can then follow, such as signalling to the concentricity monitoring signal interface (if steps (iii) to (vi) are carried out by the monitoring module) or to the machine tool (if steps (iii) to (vi) are carried out by the concentricity monitoring signal interface) whether a concentricity error is present.

If steps (iii) to (vi) are carried out by the monitoring module, the recorded variables representative of the acceleration can be temporarily stored in the data processing unit of the module or in another module memory before they are processed further in order to subsequently determine the overall acceleration, preferably taking into account initial variables representative of the acceleration determined in a calibration run. This total acceleration is then compared with the threshold value in order to determine whether a specified tolerance threshold is exceeded or at least reached.

If steps (iii) to (vi) are carried out by the machine tool or the concentricity monitoring signal interface, the variables representative of the acceleration can be transmitted continuously to the machine tool/the concentricity monitoring signal interface, in particular continuously during the measurement process (the acquisition of the variables representative of the acceleration). In this case, if available, the variables representative of the initial acceleration can also be transmitted to the machine tool/concentricity monitoring signal interface. Evaluation, filtering, offsetting against the initial values and calculation of the total acceleration and comparison of the total acceleration with the threshold value can then be carried out by the computing unit of the concentricity monitoring signal interface/by the control system of the machine tool.

Since the threshold value characterises the permissible range of the eccentricity of the tool to be rotated during operation, this value can be known or made known (by one of the other components) to the computing unit of the monitoring module, the control unit of the machine tool and/or the computing unit of the concentricity monitoring signal interface in all the cases described above. The threshold value can be available as an analogue value or as a digital value, e.g. in micrometres (μm). The threshold value can be adjustable. This can be done directly on the monitoring module using suitable means, for example. For example, the threshold value can be entered on the monitoring module using a magnetic pen and SET/MODE. Alternatively, the threshold value can be entered in the control system of the machine tool/machining center and then transmitted to the monitoring module via the concentricity monitoring signal interface, if necessary. This procedure is intended in particular if steps (iii) to (vi) of the concentricity monitoring procedure are carried out by the monitoring module.

If, on the other hand, the variables representative of the acceleration are evaluated in the machine tool/the concentricity monitoring signal interface, the threshold value can preferably be entered directly at the machine tool and—if evaluated in the concentricity monitoring signal interface-transmitted to it and stored in a memory.

The concentricity monitoring method can include a further optional step of activating the monitoring module so that the monitoring module is set to a monitoring mode (measurement mode) before the monitoring module determines the variables representative of the acceleration. This further step thus precedes at least step (iii) in terms of time. The activation step can be followed by a step in which the speed is waited for when the values representative of the acceleration (i.e. the test speed) are recorded.

The concentricity monitoring process can include a further optional step in which, if necessary, a signal from the monitoring module is waited for after the monitoring module is activated, with which the monitoring module signals that it is ready for data acquisition. In addition, in a further optional step of the concentricity monitoring process, the monitoring module can be deactivated again, i.e. set to a state in which no concentricity monitoring takes place. This optional step is carried out at the earliest when the recording of the variables according to step (iii) has been completed.

In a further optional process step of the concentricity monitoring process, the rotational speed can be determined, for example by the monitoring module, when the measured variables are recorded and transmitted to the concentricity monitoring signal interface and/or to the machine tool/machining center. This step can be omitted in particular if process steps (iii) to (vi) are carried out by the monitoring module. Alternatively or additionally, the rotational speed can be specified by the control system of the machine tool during detection.

The concentricity monitoring procedure can be carried out for a single predetermined speed when recording the variables representative of the acceleration. Alternatively or additionally, it is possible for the method steps (iii) to (vi) to be repeated for different rotational speeds. In particular, between one and five repetitions are possible at different rotational speeds, but the present disclosure is not limited to the specific number of repetitions. If this is the case, the different speeds are each set in step (ii). The optional signalling to the machine tool/the concentricity monitoring signal interface as to whether a concentricity error is present can then take place, for example, once for all (test) speeds together or for each test speed individually, whereby the corresponding test speed can be transmitted additionally in each case.

In particular, if method steps (iii) to (vi) are carried out repeatedly, it is conceivable that the test speed is determined by the monitoring module or at least on the basis of measured variables (such as other variables representative of acceleration) recorded by the monitoring module.

Common to all the aspects described above is that the quantities representative of the acceleration (i.e. the radial accelerations in an x-y plane of the monitoring module and the sensor unit associated with the monitoring module) can be filtered, for example using a low-pass or band-pass filter, before the overall acceleration is determined. In addition, suitable memories can be assigned to all of the aforementioned computing units and control units, in which received signals and signals to be transmitted, which are described within the scope of this disclosure and which are in some way related to the concentricity monitoring, can be (temporarily) stored.

A seventh aspect relates to a computer program product comprising instructions that cause the machine tool/machining center of the fourth aspect to perform process steps (i) to (vi) according to the sixth aspect and/or that the runout monitoring module of the first aspect the runout monitoring tool holder module of the second aspect, or the runout monitoring tool module of the third aspect performs the method steps (iii) to (vi) according to the sixth aspect and/or that the runout monitoring signal interface of the fifth aspect performs the method steps (iii) to (vi) according to the sixth aspect.

The computer program product may include further instructions that cause optional steps described in relation to the concentricity monitoring process to be executed by the corresponding components (monitoring module, machine tool and/or concentricity monitoring signal interface).

In principle, it is important for the accuracy of the run-out error determination that the monitoring module/machine tool/run-out monitoring interface knows exactly the test speed when recording the (initial) variables representative of the acceleration in order to be able to make an exact statement as to whether the run-out of the tool to be rotated during operation is still below the specified threshold value.

The machine tool controller can communicate the exact test speed to the computing unit of the concentricity monitoring signal interface/the monitoring module. This test speed is then taken as given and no further checking in terms of speed calibration is required.

In certain variants, the monitoring module can also comprise a further sensor unit which is radially spaced from the axis of rotation and is set up to detect further variables representative of acceleration in a plane orientated essentially normal to the axis of rotation at essentially the same time as the variables representative of acceleration are detected. The computing unit is furthermore set up to receive the further variables representative of acceleration detected by the further sensor unit and to determine the rotational speed of the concentricity monitoring module/the concentricity monitoring tool holder module/the concentricity monitoring tool module from the further variables representative of acceleration during the detection of the variables representative of acceleration. Alternatively, in some variants, the communication unit may be arranged to transmit the further acceleration representative variables to the machine tool/machining center according to the fourth aspect and/or to the runout monitoring signal interface according to the fifth aspect.

The other (second) sensor unit can be designed similarly or identically to the (first) sensor unit in terms of its sensitivity and the possible detection directions. For example, the further sensor unit can also be a two-axis acceleration sensor, which is set up and arranged in the monitoring module in such a way that it can detect further variables representative of the acceleration in an x-y plane and normal to the axis of rotation of the monitoring module. Alternatively, it is possible in particular that the further (second) sensor unit comprises a single-axis acceleration sensor whose sensitive axis is arranged in a radial direction, i.e. in such a way that this single-axis acceleration sensor can detect the further variables representative of the acceleration in the x-y plane and normal to the axis of rotation of the monitoring module. If the single-axis acceleration sensor is used in the additional sensor unit, the “other variables representative of the acceleration” generally only include a single “variable representative of the acceleration”. For this reason, the terms “quantities representative of the acceleration” and “quantity representative of the acceleration” are also used synonymously in the context of this disclosure, unless otherwise specified at the relevant point or a contrary technical meaning is apparent.

In one variant, the additional sensor unit can also comprise two opposing acceleration sensors that are radially spaced from the axis of rotation and are arranged in a plane orientated normal to the axis of rotation. In this case, the acceleration sensors each have measuring axes that lie in alignment or in a plane orthogonal to the plane containing the axis of rotation. Preferably, the acceleration sensors provide measured values from which respective mean values of the other variables representative of the acceleration are formed. While the speed determined with just one sensor as described above can be influenced by any concentricity error that may be present, this influence can be minimised or even eliminated by arranging the two opposing sensors. If a run-out error is present, the radial distance to the axis of rotation of the first acceleration sensor increases, for example, while the radial distance of the second acceleration sensor decreases accordingly. The mean value of the accelerations measured with the two opposing acceleration sensors is therefore independent of any concentricity error that may be present. The calculation of the rotational speed can be carried out in the computing unit if necessary.

If the other variables representative of the acceleration are transmitted to the machine tool/the concentricity monitoring signal interface, the speed can be determined based on these variables by the machine tool controller/by the computing unit of the concentricity monitoring signal interface.

The further sensor unit can, for example, be arranged adjacent to and/or in contact with an inner circumferential surface of the monitoring module. This circumferential surface can be an essentially cylindrical circumferential surface. The further sensor unit can thus be placed in particular outside the centric position (off-center), so that it is radially spaced from the sensor unit and so that the axis of rotation of the monitoring module does not run through the further sensor unit.

An eccentric acceleration sensor arranged in this way (as the further sensor unit) supplies the other variables representative of the acceleration (as acceleration values or as transducer values).

The speed is then calculated from these variables representative of the centrifugal acceleration of the other sensor unit.

In some variants, the computing unit of the monitoring module may be arranged to determine the rotational speed of the monitoring module during detection of the acceleration representative variables based on a signal frequency prevailing during detection of the acceleration representative variables if the rotational axis of the monitoring module is oriented substantially horizontally during detection of the acceleration representative variables.

This can be particularly advantageous for applications in which the monitoring module must be orientated exclusively horizontally, or at least for concentricity testing purposes, as this means that no additional sensor unit is required in the monitoring module to determine the speed. This can save costs in particular. This is because if the monitoring module is orientated horizontally when recording the variables representative of the acceleration, a sinusoidal signal caused by the acceleration due to gravity is superimposed on these variables. This sinusoidal signal can be analysed separately in the computing unit of the monitoring module and provides an amplitude that corresponds at least approximately to the acceleration due to gravity (1 g). The frequency of the sinusoidal signal corresponds to the rotational speed during detection, i.e. the test rotational speed. This type of speed determination can be particularly efficient as it does not need to be calibrated.

In some variants, the monitoring module may further comprise a photosensitive unit having a photosensitive surface located on the outer periphery of the monitoring module, wherein the photosensitive unit is adapted to detect differences in brightness during detection of the quantities representative of acceleration, wherein the computing unit is adapted to determine the rotational speed of the monitoring module during detection of the quantities representative of acceleration based on a frequency of the differences in brightness.

This can therefore be an optical test speed detection, whereby the photosensitive unit can have a photodetector, e.g. a photodiode, which can be integrated into the monitoring module in such a way that the photosensitive surface is directed radially outwards. During speed detection, a light signal that is generated during the rotation of the monitoring module due to the prevailing light conditions can then be detected. The sequence of light-dark differences creates a light pattern that is converted into a voltage by the photosensitive unit. This light pattern, and therefore also the voltage pattern, is repeated with each rotation. It is therefore possible to determine the basic frequency of the light pattern by applying a corresponding signal evaluation. This basic frequency of the light pattern corresponds to the test speed.

In certain modifications, it is conceivable that an IR photodiode is used in the photosensitive unit. If this is the case, it is not the ambient light that is detected, but light beams with frequencies in the infrared range that are emitted, for example, by IR LEDs that are assigned to the machine tool and, in particular, are arranged on or in the machine tool in such a way that they can illuminate its photosensitive surface when the monitoring module is located in the spindle of the machine tool. In this way, the test speed can be reliably determined, particularly in poor (dark) lighting conditions. This type of optical test speed detection can also be particularly efficient, as it does not need to be calibrated.

In some variants of the monitoring module, at least the sensor unit and preferably additionally the further sensor unit can be arranged on a sensor circuit board, wherein the sensor circuit board is connected to a circuit board holder, and wherein a position of the circuit board holder can be adjusted normal to the axis of rotation via adjustment means of the monitoring module.

In one variant, the sensor circuit board is fixed to the circuit board holder. In addition, in one variant the circuit board holder is floatingly suspended (mounted) and in one variant it is positioned exactly in the (rotary) center of the monitoring module via the adjustment means. Threaded pins attached radially to the circuit board holder of the monitoring module, for example, are used for lateral fine adjustment of the circuit board holder and thus the sensor unit. In one variant, this fine adjustment is carried out in particular by the manufacturer, but the present disclosure is not limited to this.

Other grub screws, which differ from the grub screws for fine adjustment of the blank holder and can be used in particular for fine balancing of the monitoring module by the user, can have different weights and/or be designed to accommodate an additional mass. The fine balancing of the monitoring module can be carried out via threaded holes on the circumference of the monitoring module, in particular after a tool change using these threaded pins.

In certain variants, the monitoring module may further comprise a power supply unit adapted to be switched from a power saving or standby mode to a monitoring mode, preferably in response to a wake-up signal, and/or to switch the sensor unit, the further sensor unit, the computing unit and/or the communication unit from a power saving or standby mode to a monitoring mode, preferably in response to a wake-up signal.

For example, the activation of the concentricity monitoring module described above may involve activation by means of the wake-up signal.

In energy-saving mode, the computing unit (data processing unit), the sensor unit and the communication unit (also data transmission unit) of the electronic unit of the monitoring module can be on standby and consume comparatively little energy. In the monitoring mode (also measurement mode), the electronic unit can be in a standard mode in which all measurements described in the context of this disclosure can be carried out. The electronic unit can consume a lot of energy in measurement mode compared to energy-saving mode.

In some variants, the energy supply unit can comprise an energy storage unit for storing electrical energy. In some variants, the energy supply unit can also comprise a generator unit for generating electrical energy. The energy supply unit can therefore be responsible for generating and/or storing and preferably also for conditioning the supply voltage of all components of the electronic unit. The energy supply unit can supply the components of the electronic unit with energy that is stored in at least one battery or in at least one accumulator. In this case, the generator unit can be omitted and the battery/accumulator can have a comparatively high capacity and/or energy density. Alternatively or additionally, the monitoring module can generate its own power via the generator unit, for which, for example, the energy of the rotating spindle of the machine tool or a pressurised medium can be used. These different forms of energy can be converted into electrical energy by using the generator unit. In these cases, comparatively small energy storage devices with a lower capacity and/or energy density, such as one or more small batteries and/or one or more small capacitors, can be used for energy storage (in particular compared to the energy supply from an accumulator). The generator unit can, for example, have a first part that comprises three induction coils arranged offset by 120° to each other. A second part of the generator unit, which is rotatable relative to the first part of the generator unit, can, for example, comprise one or more permanent magnets. Alternatively, the first part may also comprise the permanent magnets and the second part the coils. When the first part rotates relative to the second part, alternating voltages are generated which are shifted by 120° relative to each other with respect to their phase position. However, the present disclosure is not limited to this specific embodiment of the generator unit. For example, variants with six induction coils are also conceivable, of which, for example, two induction coils are connected in series in each case, or variants with nine induction coils, of which, for example, three induction coils are connected in series in each case. In these cases, there are also more permanent magnets in the second part of the generator unit, so the number of permanent magnets increases in particular as the number of induction coils increases. The power supply unit can also include a rectifier that converts the AC voltages generated in the generator unit into a DC voltage and smoothes it out.

In certain variants of the monitoring module, the wake-up signal may be a signal or may be triggered by a signal generated by the further sensor unit as soon as the further quantities representative of the acceleration exceed a wake-up threshold, or is received via the communication unit from the machine tool/machining center according to the fourth aspect and/or from the concentricity monitoring signal interface according to the fifth aspect, or is generated when an amount of energy generated by the energy supply unit exceeds a predetermined level.

In one variant, the additional sensor unit can be set in such a way that it generates the wakeup signal when a set wake-up threshold is reached or exceeded. This wake-up signal allows the power supply unit, the computing unit and the communication unit of the monitoring module to switch from energy-saving mode to monitoring mode. The following sequence (activation sequence) is conceivable in order to ensure the safest possible activation of the monitoring module or its components and thus avoid incorrect activation.

First, the monitoring module (see e.g. step (i) according to the sixth aspect) is inserted into the spindle of the machine tool. Then the monitoring module is rotated in the spindle (see step (ii) according to the sixth aspect), whereby the further sensor unit experiences a centrifugal acceleration and generates the wake-up signal. The wake-up signal of the further sensor unit activates the electronic unit of the monitoring module. As described above, the electronics unit can check whether a rotational speed is actually present at the monitoring module. If the monitoring module is actually rotating, the electronics unit remains in monitoring mode. In one variant, the monitoring module (within the spindle or alone, i.e. removed from the spindle) is not rotated. The electronics unit can then check whether there is still a speed at the monitoring module. If the monitoring module is indeed not rotating, the electronics unit switches back to energy-saving mode. This ensures that the monitoring module remains in monitoring mode for as long as necessary but as short a time as possible. This ultimately saves energy for supplying the components of the electronics unit or the entire monitoring module.

When the wake-up signal is received from the machine tool/rotation monitoring signal interface, the control unit of the machine tool/computing unit of the rotation monitoring signal interface sends the activation signal (the wake-up signal) to the monitoring module via its corresponding communication unit, which then switches to monitoring mode. If the wake-up signal is generated when the amount of energy generated by the energy supply unit exceeds a predetermined level, the monitoring module is also initially changed into the spindle of the machine tool according to step (i) in accordance with the sixth aspect. As soon as the monitoring module is rotated according to step (ii) according to the sixth aspect, the generator unit begins to generate energy. When a certain level is reached, the electronic unit is automatically energised and set to monitoring mode. In addition to all variants of activation, i.e. setting the monitoring module to monitoring mode, shock events such as a fall onto the floor or a collision with an object in the machine room can be logged. The results of this logging can be stored in the module and/or transmitted to the machine tool and/or to the concentricity monitoring signal interface. The activation sequence described above may or may not be carried out, regardless of which variant is used to activate the monitoring module. In some variants, the generator unit comprises a stator which is directly or indirectly coupled to the tool holder of the monitoring module, or is directly or indirectly couplable to the tool holder according to the first aspect, and wherein the generator unit further comprises a rotor which is associated with the monitoring module such that it co-operates with the stator such that the generator unit generates electrical energy upon a rotational acceleration of the monitoring module about the axis of rotation. The rotational acceleration can be a positive or negative rotational acceleration, which is generated when the spindle speed is increased or when the spindle speed is reduced. Alternatively, the stator can be coupled directly or indirectly to the monitoring module. The stator can be the first part of the generator unit described above. In this case, the rotor may be the second part of the generator unit described above. Alternatively, it is possible that the stator is the second part of the generator unit described above. In this case, the rotor can be the first part of the generator unit described above. In this case, a flywheel with permanent magnets can represent the rotor. The stator can then be provided with one or more induction coils. The induction coils can be coils with a manganese-zinc-ferrite core, for example, which are interconnected via a circuit board. In addition, the coils can be arranged in corresponding recesses in a coil cage and/or bonded to it. This ensures a high level of stability at high machining speeds. If the spindle of the machine tool is accelerated around the axis of rotation (or later decelerated again), the inertia of the flywheel results in a speed difference between the stator and rotor (i.e. the flywheel). This induces a voltage in the induction coils, which is then fed directly to the load (i.e. the components of the electronic module itself, especially if it is currently in monitoring mode) or stored in the energy store of the monitoring module. In this way, when the spindle speed changes, a voltage is generated until the flywheel has reached the (new) spindle speed, i.e. when there is no longer any negative or positive acceleration. The mechanical energy (rotational energy) theoretically available when the spindle speed changes is calculated: E_rot=1/2*I*(ω_2−ω_1)\hat{ }2 This results in the moment of inertia I of a hollow cylinder rotating around the axis of symmetry is given by I=m((r_1\hat{ }2+r_2\hat{ }2)/2). Since the mass and radii of the flywheel are known, the rotational energy can be calculated for a given angular frequency (ω=2πf), the rotational energy can be calculated, whereby both frictional and eddy current losses as well as losses on the electrical side (in the induction coils, in the rectifier, in electrical resistors etc.) are not taken into account.

The time required for a concentricity monitoring cycle, i.e. the activation of the electronic unit, the recording of the variables representative of the acceleration, the other variables representative of the acceleration and, if applicable, the rotational speed(s), the determination of the overall acceleration, the determination of whether a concentricity error is present and the signalling of whether a concentricity error is present, can be between one second and two seconds in particular. To cover the energy requirement for this period, the amount of energy that can be generated by the generator unit when the spindle and thus the tool to be rotated is run up to a normal machining speed for a workpiece is already sufficient. However, if the amount of energy is not sufficient in certain cases, e.g. because the machining speed is very low, additional energy can be generated by repeatedly changing the speed. For example, the spindle can be accelerated to 1000 rpm for a relatively short period of time (e.g. 2 to 3 seconds) and then decelerated to a machining speed of 500 rpm, whereby energy can be generated during acceleration and deceleration. In some variants, the monitoring module can also comprise a fluid channel that extends in a fluid-tight manner between two outer sides of the monitoring module that are spaced apart in the axial direction of the axis of rotation. In some variants, the generator unit may comprise a turbine unit with a turbine wheel arranged within the fluid channel and a generator integrated in the turbine unit, which is arranged to generate electrical energy when fluid flows through the turbine wheel. In this way, the aforementioned energy conversion of a pressurised medium, e.g. a coolant and/or lubricant used in the machine tool, can be realised. The medium available in the spindle can be channelled to the turbine via the fluid channel and/or a coolant pipe inside the monitoring module.

The flow of the medium through the turbine wheel causes it to rotate so that a voltage is induced by the integrated generator, which in turn is supplied to the monitoring module itself or its components as a load or stored in the energy storage unit of the monitoring module. In particular, the turbine wheel can be the second part of the generator unit (generator) described above. In particular, the permanent magnets can be attached to a lower surface of the turbine wheel or incorporated into it. The stator with the induction coils can then be permanently arranged on a circuit board in the monitoring module below the turbine wheel. In order to monitor the functioning of this form of energy generation, the monitoring module can, for example, output an error to the machine tool/the concentricity monitoring signal interface if the monitoring module detects that no energy is being generated, even if the spindle of the machine tool is accelerated positively or negatively.

As the sensor unit can be arranged exactly in the (rotation) center (in the axis of rotation) of the monitoring module, it may be necessary to guide the medium, which is usually fed centrally through a coolant channel, past the sensor board. For this purpose, a distributor can be provided in the monitoring module, which directs the medium flow past the sensor board and the sensor unit and can simultaneously supply the medium to the tool to be rotated.

By generating its own power (self-generation), it is possible to provide a continuous power supply for the monitoring module. This can be particularly desirable if data is to be continuously recorded by the sensor unit or the additional sensor unit during the machining process of a workpiece and transmitted to an external evaluation unit such as the concentricity monitoring signal interface or the machine tool. In some variants of the monitoring module, the sensor unit is set up to record, separately in time from normal operation in which the monitoring module rotates, in particular together with the spindle, initial values representative of an acceleration in the plane oriented essentially normal to the axis of rotation at an essentially constant rotational speed or at several different essentially constant rotational speeds, whereby the computing unit is set up to record the initial values representative of an acceleration in the plane oriented essentially normal to the axis of rotation at an essentially constant rotational speed or at several different essentially constant rotational speeds, to store the initial quantities representative of the acceleration together with the corresponding rotational speed(s) in a memory of the monitoring module, and/or wherein the communication unit is arranged to transmit the initial quantities representative of the acceleration preferably together with the corresponding rotational speed(s) to the machine tool/machining center according to the fourth aspect and/or to the concentricity monitoring signal interface according to the fifth aspect. The initial values representative of the acceleration can be recorded separately from normal operation (in which the machine tool can machine a workpiece), in particular in a calibration mode (calibration run). This calibration run can take place in particular under conditions in which the machine tool, the spindle, the tool changer, the working area of the machine tool, the concentricity monitoring signal interface and the monitoring module (here in particular the correct centerd alignment of the sensor unit) are in a state in which they operate without errors. In particular, in calibration mode, the tool holder in the spindle should be as ideally flat as possible, with no chips or other contamination in the area of the spindle and the tool holder. If necessary, this can be monitored by the manufacturer and/or the user.

The calibration run, which can be carried out in particular by the manufacturer, can be provided in particular because it can be extremely complex in terms of assembly (primarily due to manufacturing and assembly tolerances) to position the sensor unit exactly in the center (i.e. in the axis of rotation of the monitoring module). It is also not always possible to expect the monitoring module to be clamped exactly in the center of the spindle (so that the axes of rotation of the monitoring module and spindle are exactly coaxial), as there are also certain tolerances. This can result in an “off-center position” of the sensor unit, in which in particular an axis of inertia (e.g. the z-axis, which does not have to be a sensitive axis) of the sensor unit (or alternatively an axis of inertia of the acceleration sensor of the sensor unit) is radially spaced from the axis of rotation of the monitoring module, in particular within the tolerance distance described above, and the angular error described above between the axis of rotation of the monitoring module and the axis of inertia of the sensor unit is maintained. This eccentricity can result in offset values that can distort the actual values representative of the acceleration.

For this reason, the offset values mentioned can be determined in the calibration run as initial values representative of the acceleration and taken into account when calculating the overall acceleration. The calibration run is therefore a “learning cycle” for determining the initial values of the corresponding monitoring module that are representative of the acceleration. The calibration run can take place in a calibration mode in which the initial values representative of the acceleration are determined for one test speed or for several test speeds. The test speed(s) themselves can be specified and/or determined as described above. If the test speed is determined using the additional sensor unit, it is particularly possible that this speed determination is also calibrated by the manufacturer or via the calibration process at a known speed.

A function of the initial values representative of the acceleration that is dependent on the test speed can then be calculated. This speed-dependent function can be stored in the memory of the monitoring module and/or transmitted to the concentricity monitoring signal interface/the machine tool. The calculations required for the calibration can then be carried out by the machine tool/concentricity monitoring signal interface.

The detection of the initial variables representative of the acceleration can—similarly to the detection of the variables representative of the acceleration—take place over a certain evaluation time, which can be characterised in particular by a certain number of revolutions (e.g. between 4 and 100 revolutions) of the spindle. Over the evaluation time, the speed (or speeds) can be essentially constant or fluctuate within a range of at most 10% of the speed(s) in order to determine initial acceleration variables as accurately as possible. It may be intended that the recording of the initial values representative of the acceleration is only started when the speed(s) is/are reached, i.e. outside the run-up phase of the spindle to the corresponding speed(s). This also applies to the determination of the variables representative of the acceleration. If the initial quantities representative of the acceleration and the quantities representative of the acceleration at essentially the same speeds are known, the total acceleration can be determined as a function of these quantities in the sense of a resulting total acceleration. As with the method according to the sixth aspect, the calibration run can be performed at least in part by different components described above, such as monitoring module, runout monitoring signal interface, machine tool and/or by an interaction of these components.

If the calibration run is carried out completely by the monitoring module itself, the monitoring module of the machine tool/concentricity monitoring signal interface can signal its readiness for the calibration run. The initial variables representative of the acceleration can then be recorded, filtered and stored, whereby the recording can be carried out in particular at a stable speed over the recording period. If the calibration run is carried out for several speeds, the respective speed can also be determined during the acquisition. The speed can then be changed if necessary and the filtering and determination of the variables representative of the initial acceleration can be carried out again for the changed speed. This results in the aforementioned speed-dependent function or—in the case of a calibration run with a single speed—a pair of test speed and initial acceleration values that can be stored in the monitoring module. When this sequence is complete, the monitoring module can signal to the machine tool/concentricity monitoring signal interface that the calibration run is complete. Alternatively or additionally, the monitoring module can transmit a signal (OK or NOK) to signal to the machine tool/concentricity monitoring signal interface that the calibration process has been successfully completed or that an error has occurred.

Alternatively, the filtering and storage of the initial values representative of the acceleration can also take place in the machine tool/concentricity monitoring interface. Here too, the tool module can transmit its readiness for the calibration run to the machine tool/concentricity monitoring signal interface, if necessary in response to a request from the latter. The initial values representative of the acceleration can then be recorded at the stable speed over the recording period. The recorded values can, for example, be transmitted continuously to the machine tool/concentricity monitoring signal interface until the recording period is reached. Then, if the calibration run is to be carried out for several speeds, the speed can be changed. The initial values representative of the acceleration can then be recorded and transmitted at the newly set speed until the recording time is reached again. Once the initial acceleration values for all test speeds have been recorded and transmitted, the calibration run can be ended, e.g. by a signal from the machine tool/concentricity monitoring signal interface. The initial acceleration values can then be filtered in the machine tool/concentricity monitoring signal interface and stored together with the speed(s) during the calibration run, in particular as a speed-dependent function of the initial acceleration values.

In some variants of the monitoring module, the computing unit may further be arranged to process the acceleration-representative quantities detected by the sensor unit and/or the initial acceleration-representative quantities and/or the further acceleration-representative quantities detected by the further sensor unit and/or the rotational speed of the monitoring module during the detection of the acceleration-representative quantities, each for a specific time window of preferably between 50 ms and 200 ms, in the form of a data packet, wherein the processing is performed by operations such as signal filtering, averaging and/or determining a frequency spectrum per time window, and transmitting the data packet after processing to the machine tool/machining center according to the fourth aspect and/or to the concentricity monitoring signal interface according to the fifth aspect.

This can be a variant of continuous process data transmission, in which all variables recorded by the sensor units and/or the other units (e.g. the photosensitive unit) of the monitoring module are continuously transmitted to the machine tool/concentricity monitoring signal interface. This is particularly important when monitoring and controlling complex manufacturing processes in which the monitoring module/machine tool/concentricity monitoring signal interface may be integrated. A high bandwidth may be required for this continuous transmission, particularly if a high temporal resolution is required (e.g. if a vibration measurement is also to be carried out based on the variables recorded by the sensor units), or if a large number of recorded variables are to be transmitted simultaneously by the monitoring module. Wireless data transmission between the monitoring module and the machine tool/concentricity monitoring signal interface can represent a bottleneck and thus have a limiting effect on data transmission. In these cases, it is possible for the variables recorded by the sensor units to be partially analysed in the monitoring module so that secure and complete wireless data transmission can take place. In this variant, it is particularly conceivable that the monitoring module monitors the concentricity of the tool to be rotated during operation continuously and preferably during the entire machining cycle of a workpiece (or at least the part of the machining cycle that is carried out using the corresponding monitoring module). For this purpose, the machine tool/the concentricity monitoring signal interface can in turn wait for a signal from the monitoring module, possibly in response to a request, signalling its readiness for data acquisition. In particular, the monitoring module can then continuously record the variables representative of the acceleration and the other variables representative of the acceleration as process parameters and transmit the data packet with these and possibly other process parameters such as coolant flow and/or pressure or determined vibrations to the machine tool/concentricity monitoring signal interface within the time window or at the end of the time window. The recorded process parameters and/or the data packet can be temporarily stored in the memory of the monitoring module.

As part of the preparation of the process parameters as a data packet, which does not necessarily have to take place, but is particularly useful for complex process parameters such as vibrations, the RMS value of the recorded variables can be determined over the time window, for example. The data packet can also include the peak value occurring within the time window and the frequency spectrum of the recorded variables per time window determined using an FFT. In this way, a data packet summarizing the process variables determined in the respective time window can be transmitted to the machine tool/the concentricity monitoring signal interface for each time unit.

In these cases, the evaluation of the data packets with speed determination, filtering of the process parameters or the recorded acceleration variables, determination of acceleration values, determination of the total acceleration and/or comparison of these with the threshold value can take place in the machine tool/in the concentricity monitoring signal interface. If the evaluation takes place in the concentricity monitoring signal interface, the concentricity monitoring signal interface can then signal to the machine tool whether or not there is a concentricity error in the monitoring module.

In some variants of the monitoring module, the communication unit is further arranged to transmit the acceleration representative quantities detected by the sensor unit and/or the initial acceleration representative quantities and/or the further acceleration representative quantities detected by the further sensor unit and/or the rotational speed of the monitoring module during detection of the acceleration representative quantities and/or the data packet to the machine tool/machining center according to the fourth aspect and/or to the concentricity monitoring signal interface according to the fifth aspect when a buffer of the monitoring module is at least approximately full.

This variant can, for example, be combined in particular with the variant (in this respect, the explanations described for this variant apply analogously), according to which the recorded process variables are transmitted to the machine tool/the concentricity monitoring signal interface per time window. It is conceivable that the recorded process variables are initially temporarily stored in the monitoring module and that the transmission of the process variables is started as soon as the memory of the monitoring module is full or 90% or 80% or 70% full. This transmission can then be maintained until the intended recording duration is reached or until the memory of the monitoring module is almost empty again (e.g. only 30% or 20% or 10% full) or completely empty.

In some variants of the monitoring module, the computing unit may be arranged to determine the total acceleration based on a subtraction of the quantities representative of the initial acceleration from the corresponding quantities representative of the acceleration.

This determination of the overall acceleration can—if not all steps according to the sixth aspect are carried out by the monitoring module—of course also be carried out by the machine tool/the concentricity monitoring signal interface.

The total acceleration value can therefore be a resulting value of the variables (ax, ay) representative of the acceleration from the sensor unit, taking into account the initial variables representative of the acceleration (also initial values ax_initial, ay_initial). If these variables are known at essentially corresponding speeds, the total acceleration (in the sense of a resulting total acceleration) can be calculated as a_tot=a_resulting=√((a_x−a_(x, initial))\hat{ }2+(a_y−a_(y, initial))\hat{ }2). When the resulting overall acceleration is mentioned in the context of this disclosure, this means in any case that the initial values ax_initial, ay_initial are taken into account, while the expression a_tot is used for an overall acceleration both taking into account the initial values and without taking into account the initial values.

The threshold value with which this total acceleration is compared in order to determine whether or not there is a concentricity error of the monitoring module can, in particular, be a threshold value that relates to the deviation of the variables representative of the acceleration from the initial values. Thus, this threshold value can characterise the still permissible range of eccentricity (i.e. the deviation from an ideal concentricity, but where there is still no concentricity error in the sense of this disclosure) of the tool to be rotated. Accordingly, a concentricity error of the monitoring module may be present in particular (the machine tool/the concentricity monitoring interface is signalled NOK) if the total acceleration exceeds the threshold value. The (speed-dependent) threshold value can be specified, for example, as a digital value or as an analogue value and, for example, as a μm value.

In some variants of the monitoring module, the computing unit may be arranged to determine the amount of the runout error and/or the direction of the runout error when a runout error is present. The communication unit may then be arranged to transmit the amount and/or the direction of the runout error to the machine tool/machining center according to the fourth aspect or to the runout monitoring signal interface according to the fifth aspect. Additionally or alternatively, the communication unit can be set up to signal the presence of the runout error to the machine tool/machining center according to the fourth aspect and/or the runout monitoring signal interface according to the fifth aspect when a runout error is present, while the monitoring module rotates, in particular together with the spindle.

In this way, it is possible in particular to quickly and efficiently signal to the machine tool/concentricity monitoring signal interface—preferably before a workpiece is machined by the machine tool—that there is a concentricity error in the monitoring module, so that the machine tool can quickly take appropriate countermeasures. The amount of the concentricity error and the direction of the concentricity error can, for example, be transmitted as digital values (e.g.: 30 μm at 110°). The amount r of the concentricity error is calculated taking into account a_resulting and the speed n during detection as follows r=a_resulting/(4*π\hat{ }2*n²). When determining the direction of the concentricity error, the angle α of the largest concentricity deviation can be determined by the calculation unit of the monitoring module. A distinction is made in the calculation as to which quadrant the direction vector lies in. The determination of the direction angle α of the largest concentricity deviation using a tangent function, taking into account ay, ay_initial, ax and ax_initial, can essentially be carried out according to the following table.

| ax − | ay − | Quad- | |
|---|---|---|---|
| ax_initial | ay_initial | rant | Calculation |
| >0 | >0 | QI | α = arctan((a_y − a_(y_initial))/ |
| | | | (a_x − a_(x_initial) )) |
| =0 | >0 | — | α = 90° |
| <0 | >0 | QII | α = arctan((a_y − a_(y_initial))/ |
| | | | (a_x − a_(x_initial) )) + 180° |
| <0 | <0 | QIII | α = arctan((a_y − a_(y_initial))/ |
| | | | (a_x − a_(x_initial) )) + 180° |
| =0 | <0 | — | α = 270° |
| >0 | <0 | QIV | α = arctan((a_y − a_(y_initial))/ |
| | | | (a_x − a_(x_initial) )) + 360° |

In some variants, the monitoring module is set up to carry out the detection of the further variables representative of the acceleration, the detection of the further variables representative of the acceleration, the determination of the total acceleration, the determination of whether a concentricity error is present and the signalling of whether a concentricity error is present within a period of time in which the monitoring module, in particular together with the spindle, is moved by a machine tool/machining center from a spindle start position to a machining position of a workpiece, and wherein this period of time is in particular less than 5 seconds and preferably less than 3 seconds. The time period can be between one second and two seconds, for example. Thus, in contrast to many other tactile concentricity monitoring methods (or those with a laser measuring system), it is possible to perform the entire concentricity check, including the transmission of the result, essentially parallel to machining time, i.e. during the approach of the tool to be rotated to the machining position. In some variants, the monitoring module may further comprise at least one antenna unit with at least one antenna and at least one antenna cover, wherein the antenna is arranged inside the monitoring module and the antenna cover covers the antenna from the view of the axis of rotation to the outside, wherein the antenna cover extends in the axial direction of the axis of rotation over a greater length than the antenna.

In particular, the antenna can be used for wireless data transmission and communication with the machine tool/concentricity monitoring signal interface. There may also be one further antenna or two (or three or more, if necessary) further antennas in the antenna unit. Alternatively, two, three or more antenna units can also be provided, each with an antenna and an antenna cover. In some variants, the antenna cover can be omitted. As a result, a better circular radiation characteristic can be achieved and a better data transmission quality is achieved, particularly with a rapidly rotating monitoring module.

What all the aspects described above have in common is that vibrations that occur, in particular while a workpiece is being machined by the machine tool with the monitoring module, can be detected. In particular, the variables representative of the acceleration recorded by the sensor unit and/or the other variables representative of the acceleration recorded by the additional sensor unit can be analysed for this purpose. In particular, the vibration width (peak-to-peak value), the effective value (RMS value) and RMS values of harmonic vibration components of the recorded variables can be analysed. Preferably, the frequency spectrum of the recorded variables can also be analysed, e.g. using FFT.

If the sensor unit/the additional sensor unit comprises a three-axis acceleration sensor, the acceleration variables can be analysed in all three axis directions (X, Y and Z); the same applies to a two-axis acceleration sensor, where the acceleration variables can be analysed in both axis directions (X and Y). Alternatively, it is also conceivable to analyse the vibrations based on an acceleration occurring along a single one of the three or two axis directions. In these cases, the axis direction along which the greatest acceleration occurs can be analysed in particular.

The vibrations (oscillations) can be analysed in the monitoring module. The monitoring module then sends an error signal to the machine tool/the concentricity monitoring signal interface if the vibrations reach or exceed a defined tolerance threshold. Alternatively, it is possible that only the raw data on which the vibration analysis is based, i.e. the variables representative of the acceleration and/or the other variables representative of the acceleration, are transmitted to the machine tool/concentricity monitoring signal interface, where they are analysed and compared with the defined tolerance threshold. If the tolerance threshold is exceeded, the machine tool can change machining parameters and/or stop machining and set the machine tool to a safe state. By measuring and analysing the vibrations and other process parameters during workpiece machining, it is possible in particular to monitor the entire machining process, the condition of the tool (wear, tool breakage) and the spindle bearing condition in addition to concentricity monitoring in order to be able to react quickly if problems occur.

Thus, in some variants, the computing unit of the monitoring module is set up to monitor at least one further process parameter when the monitoring module rotates, in particular together with the tool to be rotated and/or with the tool holder and/or with the spindle, wherein the at least one process parameter comprises a vibration, a temperature, a coolant pressure, a coolant flow rate, a cutting force and/or a torque. If one of the parameters exceeds or falls below a certain threshold value, the monitoring module of the concentricity monitoring signal interface/the machine tool can signal a corresponding error.

Each of the monitoring modules can also have additional sensors for this purpose. This includes, for example, a temperature sensor for monitoring the tool temperature, in particular during the machining of a workpiece by the machine tool with the monitoring module in place. Furthermore, strain gauge sensors and/or piezo sensors can be provided on/in the monitoring module in order to determine variables such as forces (e.g. cutting forces) and torques that occur during workpiece machining. A flow sensor can also be assigned to the monitoring module. This makes it possible, for example, to continuously check whether sufficient medium is flowing through the turbine wheel to generate energy by means of the turbine unit.

The flow sensor can comprise a flow sensor unit that is arranged within the monitoring module. Alternatively, it is possible to determine the media flow rate via the speed of the turbine wheel. Additionally and/or alternatively, a pressure sensor can be provided in the monitoring module, which measures the pressure of the medium in the fluid channel/coolant pipe. If the pressure drops, a lack of flow of the medium and consequently a problem with the energy generation by the turbine unit can be inferred. The concentricity monitoring signal interface and the machine tool can then be set up to receive the error signalled by the monitoring module (in the case of the machine tool, possibly via the concentricity monitoring signal interface) and initiate appropriate countermeasures.

In a further variant, the monitoring module can be kept completely in “deep sleep” until it “wakes up” to save even more energy. In this case, operational readiness can be established via a predefined speed (sequence) for (in each case) a predefined duration (sequence), as well as via manual activation using an input device. This is in contrast to established radio transmission systems, in which end devices wake up from deep sleep at regular intervals and enquire whether communication is required or transmit their status at regular intervals. In the variants presented here, the monitoring module can only send an event signal for certain events. The receiver unit confirms receipt of the signal with a confirmation signal, as explained, for example, in EP 2 208 017 A2. The confirmation signal can also contain instructions. These instructions can include a change of operating mode in the radio transmission, so that the monitoring unit does not send any further event signals, but switches to bidirectional data transmission.

In one variant, an operating mode can be selected via a speed level profile. Communication between the monitoring module and a receiver base station can be established in a variant, e.g. as described in EP 2 208 017 A2. In one variant, the monitoring module is made known to the base station by means of a teach-in or pairing process. In one variant, the monitoring module carries out the teach-in process by the spindle of the machine tool executing a predefined speed pattern or a predefined first speed profile. The monitoring module is set up to recognise the profile by means of its own sensors (e.g. acceleration sensors) or by evaluating the generator voltage and then switching to the operating mode “Perform teach-in or pairing process”. Further functions can be executed by the monitoring module using predefined additional speed profiles, e.g. an “Execute calibration process” function. Here, the monitoring module automatically records the calibration values. After successful calibration, a confirmation signal is sent. In one variant, (i) the speed, (ii) the duration of a predefined speed (sequence), (iii) the gradient of the change from one speed level to the next and/or (iv) the duration of the change from one speed level to the next of the spindle of the machine tool are provided as parameters of the speed profiles. In particular, the individual parameters of these profiles can be detected by analysing the generator voltage. An example of such a speed profile is: 200 rpm for 1 sec, then 400 rpm for 0.5 sec, then 200 rpm for 1 sec. Another example of such a speed profile is: 200 upm for 1 sec, then 0.5 sec for the transition to 500 upm (gradient of change: Δupm/Δt=300/0.5=600), then 500 upm for 0.5 sec, then 0.5 sec for the transition to 300 upm (gradient of change: Δupm/Δt=200/0.5=400), then 300 upm for 1 sec. It should be understood that the sequence can have several different speed steps, each of which can be longer or shorter. This also applies to the duration of the speed changes.

In addition to the functions “Perform teach-in or pairing process”, “Perform calibration process”, the functions “Generate wake-up or wake-up signal”, “Assume monitoring or measuring mode”, “Assume deep sleep or stand by mode” and other functions are to be transmitted from the machine tool control system to the concentricity monitoring system by means of such predefined speeds or speed sequences of the machine tool spindle.

In one variant, the concentricity monitoring module, the concentricity monitoring tool holder module or the concentricity monitoring tool module are set up to start the detection of the variables representative of the acceleration, the detection of the further variables representative of the acceleration, the determination of the total acceleration, determining whether a concentricity error is present, or signalling whether a concentricity error is present, only begin when a defined rotational speed is reached, whereby during the evaluation time the spindle rotational speed is essentially constant or varies within a range of at most 10% of the rotational speed.

The machine tool (or its controller), the runout monitoring signal interface and the monitoring module (i.e. both the runout monitoring module according to the first aspect and the runout monitoring tool holder module according to the second aspect as well as the runout monitoring tool module according to the third aspect) may be included in a runout monitoring system. Such a runout monitoring system may comprise all the features described above in relation to the individual components. In particular, the concentricity monitoring signal interface can serve as a communication interface (machine interface) between the monitoring module and the machine tool. It may be provided that at least partial evaluations of variables recorded by the monitoring module are carried out in the machine interface (concentricity monitoring signal interface), or that only data to be transmitted from the monitoring module to the machine tool are forwarded by the machine interface in order to carry out the corresponding evaluations in the machine tool itself. The communication and data transmission between the monitoring module and the machine interface can take place wirelessly and preferably be a radio-based transmission or an IR transmission. Communication and data transmission between the machine interface and the machine tool can be wired and, in the case of analyses in the machine interface, can be carried out using I/O status signals, for example. Alternatively, data words (for a large amount of data to be transmitted, e.g. for continuous process data monitoring) can be transmitted between the machine interface and the machine tool via a digital bus system (e.g. field bus systems such as Profibus, Profinet, Ethercat or Ethernet). The applicant reserves the right to make an independent claim for such a concentricity monitoring system.

The aspects described above provide modular solutions for improving the concentricity monitoring of a tool to be rotated during operation. No additional installation costs are incurred if a measuring system, particularly with a radio-based communication interface, is already installed on the machine tool. This results in easy retrofitting, which (in addition to the general design of the monitoring module) leads to significant cost savings compared to conventional spindle-integrated systems; this is because the complex design of sensors integrated in a spindle and the deep integration into the machine tool make these spindle-integrated systems expensive and retrofitting involves considerable intervention in the machine tool structure.

The modularity also leads to increased flexibility, as the monitoring modules are not machine-bound, but can be used in a wide variety of machine tools. This means that task-specific tools with concentricity monitoring can be put together as required with little effort. The monitoring modules can also be flexibly combined with other cutting tools when converting an entire production line.

Compared to a tactile concentricity check or a concentricity measurement with a laser measuring system, concentricity monitoring according to the aspects described above can be carried out more quickly and, in particular, at least almost parallel to machining time during the approach of the tool to the machining point, as the concentricity monitoring modules provide the necessary measurement results in a very short time.

It is apparent to a person skilled in the art that the aspects and features described above (with the exception of those relating to the structural components, which have only been described with reference to the monitoring module) can be combined as desired in a monitoring module, in a runout monitoring signal interface, in a machine tool, in a runout monitoring system and/or in a runout monitoring method for a tool to be rotated in a machine tool/in a machining center during operation.

### BRIEF DESCRIPTION OF THE FIG.

Further objectives, features, advantages, possible applications and possible modifications are shown in the following description of non-limiting examples of embodiments and variants with reference to the associated drawings. All the features described and/or illustrated, either individually or in any combination, show the object disclosed here. The dimensions and proportions of the components shown schematically in Fig. are not to scale. Identical or similarly acting components are labelled with the same reference signs. Wherever reference is made to value ranges in the present disclosure, the upper and lower range limits are included in the ranges. It is noted that all calculations in the present disclosure as well as the representations of values in Figs. are performed on digital output values (as raw data) from, for example, acceleration sensors. Alternatively, all calculations can in particular be based on analogue output values of the corresponding acceleration sensors. If (partial) process steps are described in the following description with reference to a specific Fig. and the same (partial) process steps exist in another Fig., the description with reference to the specific Fig. is equally valid there, unless otherwise stated. When terms such as “essentially” or “approximately” are used in connection with the structural unit of a device (monitoring module, etc.), the terms “essentially” or “approximately” refer to technical features that are produced within the technical tolerance limits of the respective manufacturing processes.

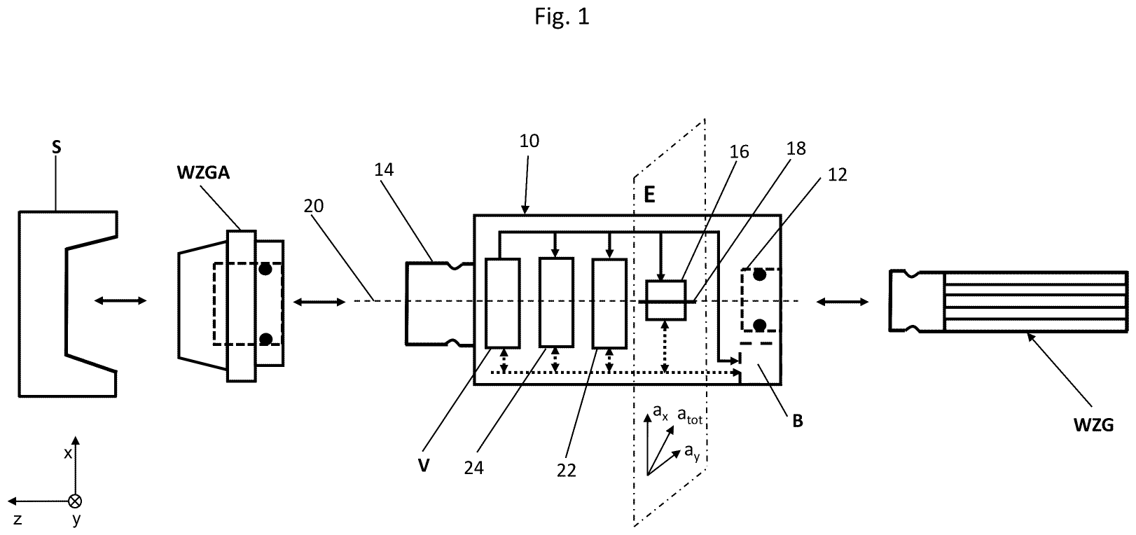

FIG. 1 shows a concentricity monitoring module according to certain embodiments.

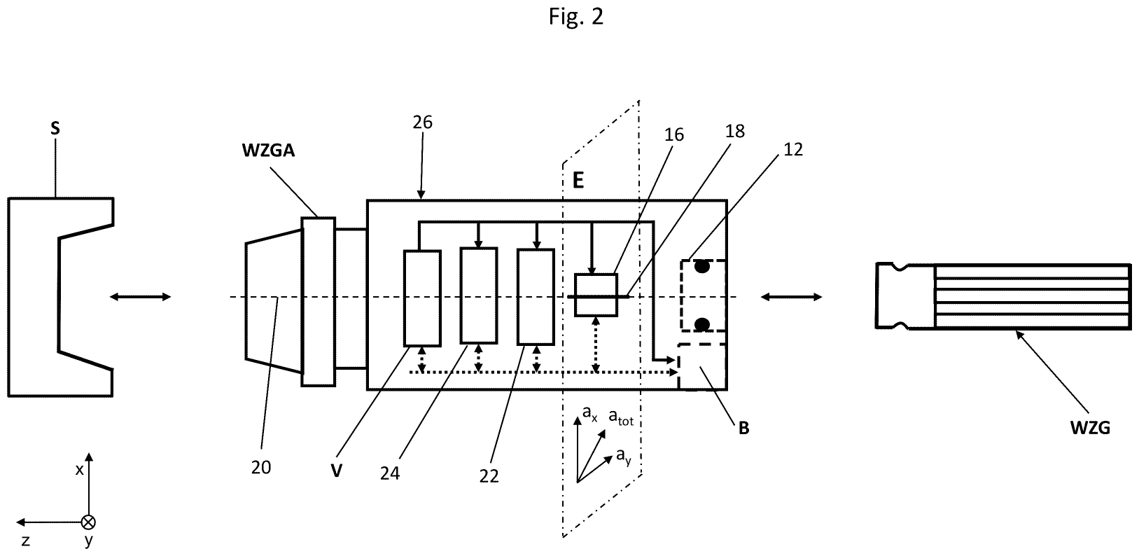

FIG. 2 shows a concentricity monitoring tool holder module according to certain embodiments.

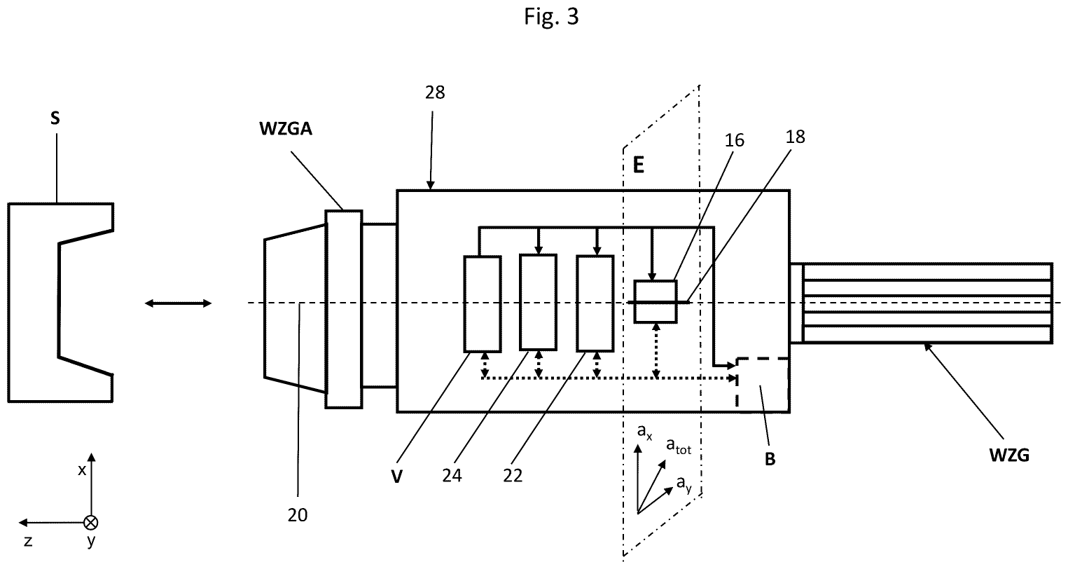

FIG. 3 shows a concentricity monitoring tool module according to certain embodiments.

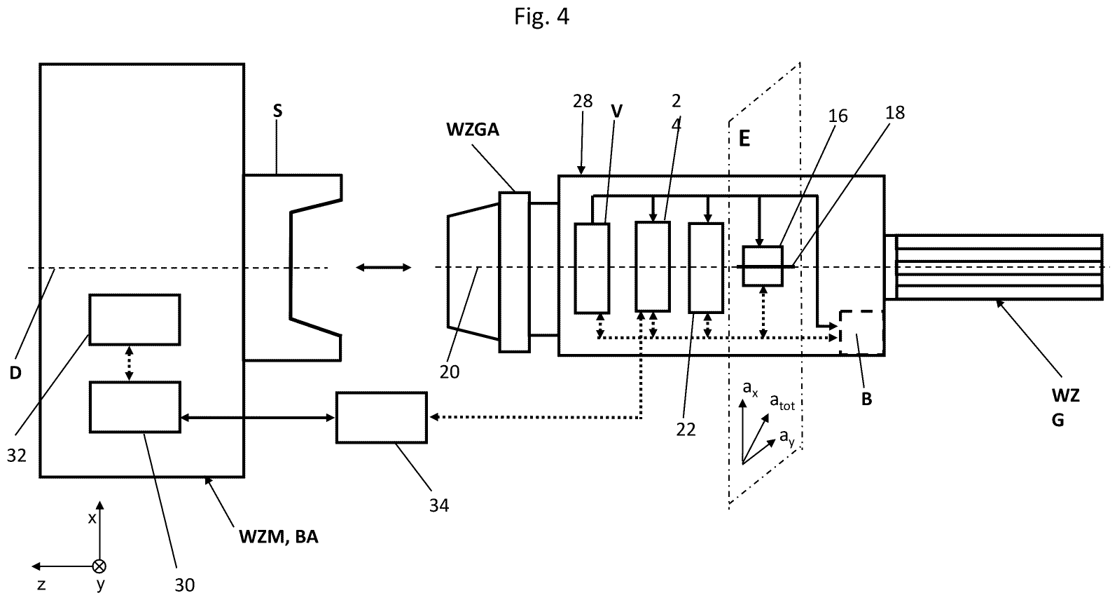

FIG. 4 shows a machine tool/machining center interacting with a monitoring module according to certain embodiments. according to certain embodiments.

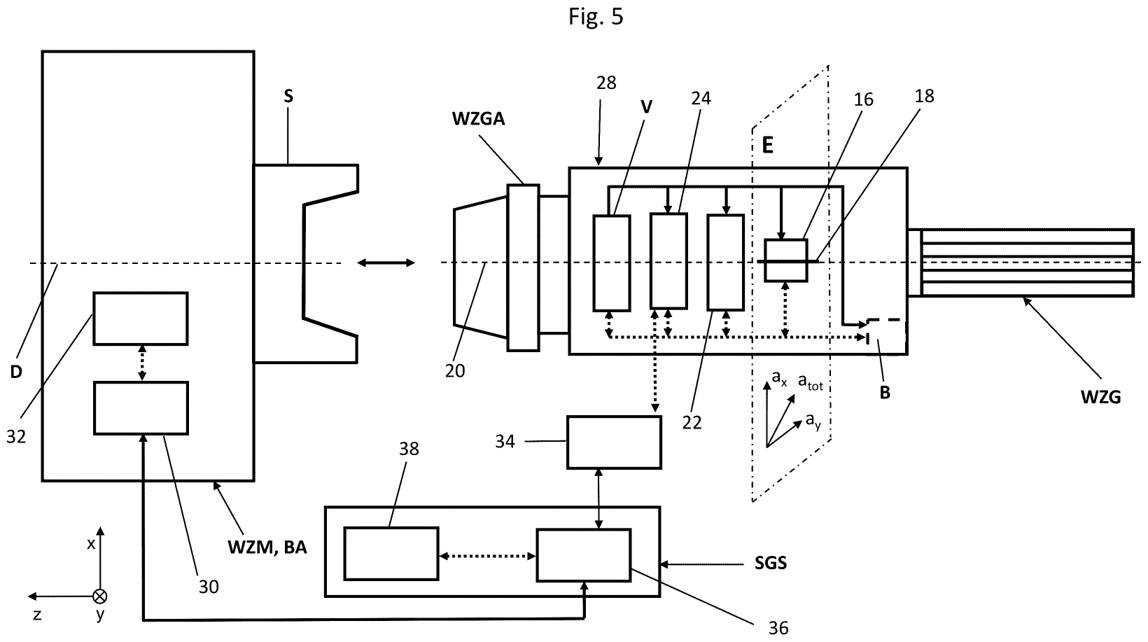

FIG. 5 shows a concentricity monitoring signal interface in interaction with a machine tool/machining center and with a monitoring module according to certain embodiments.

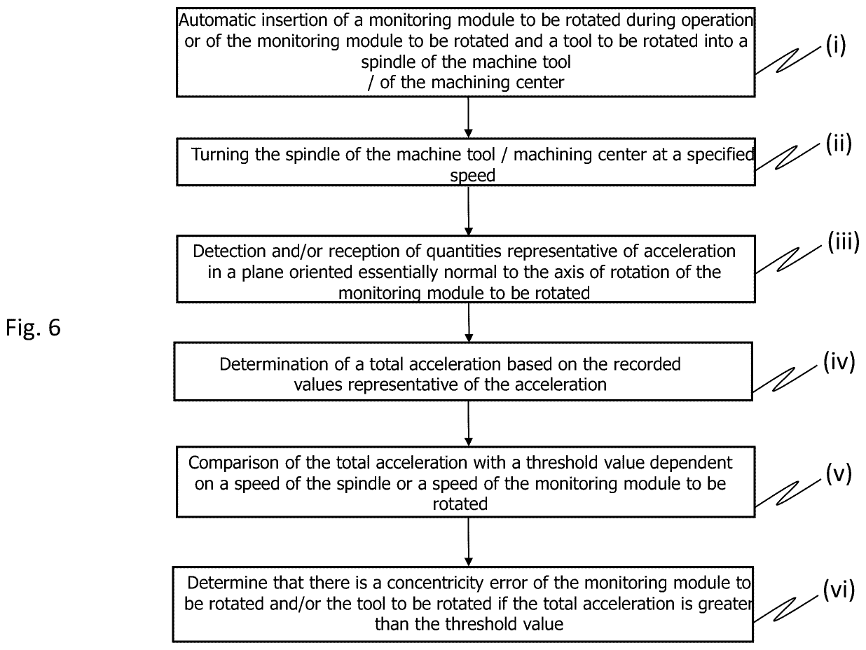

FIG. 6 shows a flow chart of a concentricity monitoring process according to certain embodiments.

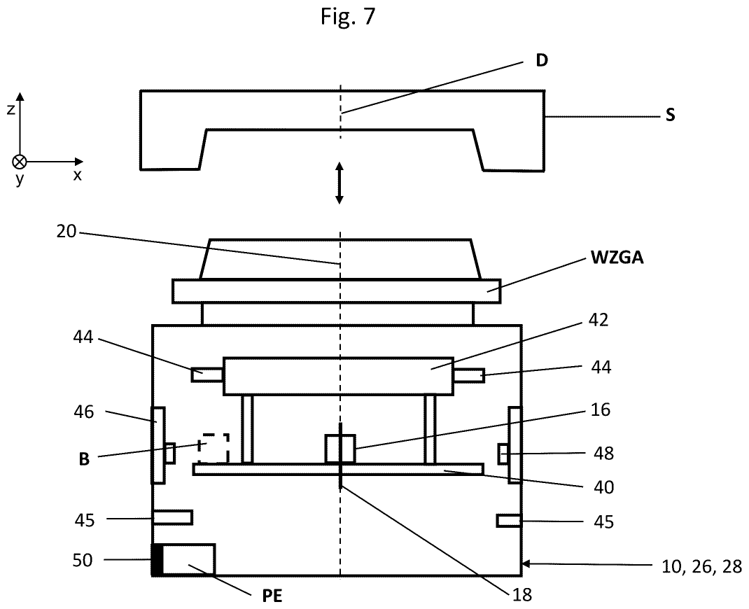

FIG. 7 shows an arrangement of a sensor circuit board, a circuit board holder, adjustment means for the circuit board holder, an antenna with antenna cover and a photosensitive unit within the monitoring module according to certain embodiments.

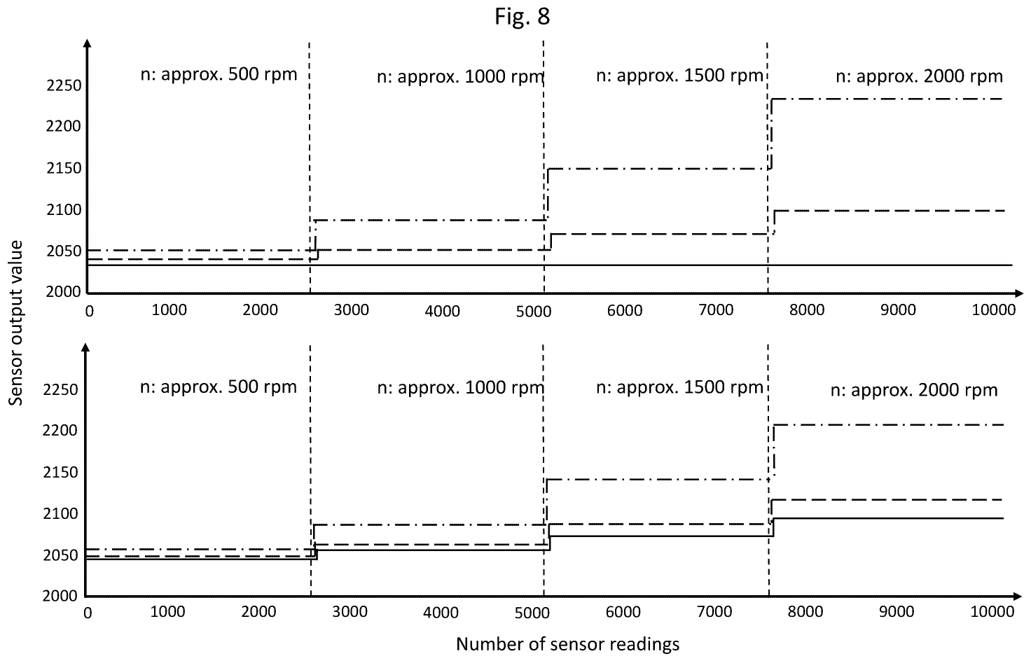

FIG. 8 shows variables representative of acceleration at different speeds recorded by the sensor unit of the monitoring module according to certain embodiments.

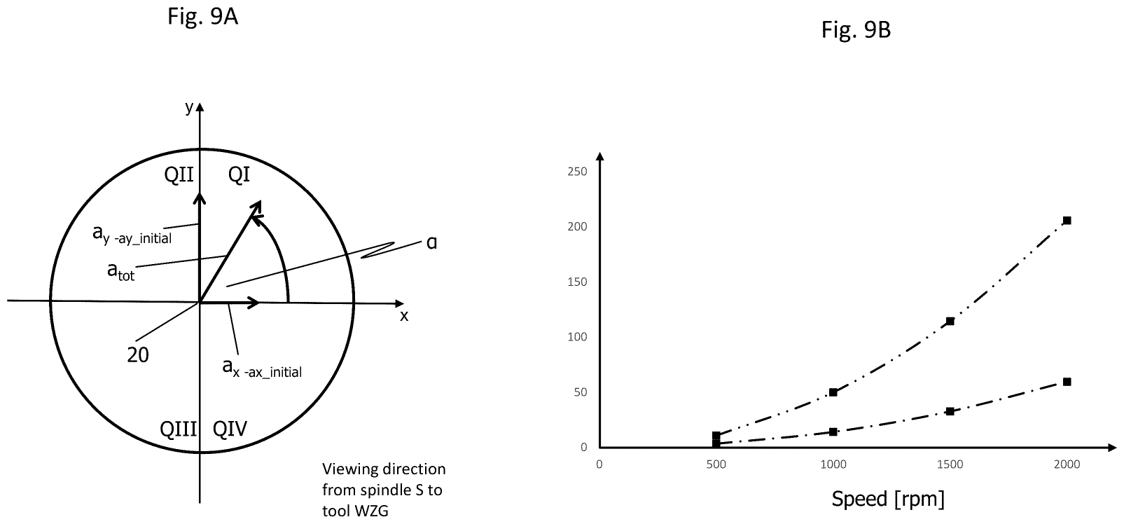

FIG. 9A shows schematically how an amount and an angle of a runout error of a monitoring module are determined according to certain embodiments.

FIG. 9B shows a total acceleration versus speed for different positions of a sensor unit according to certain embodiments.

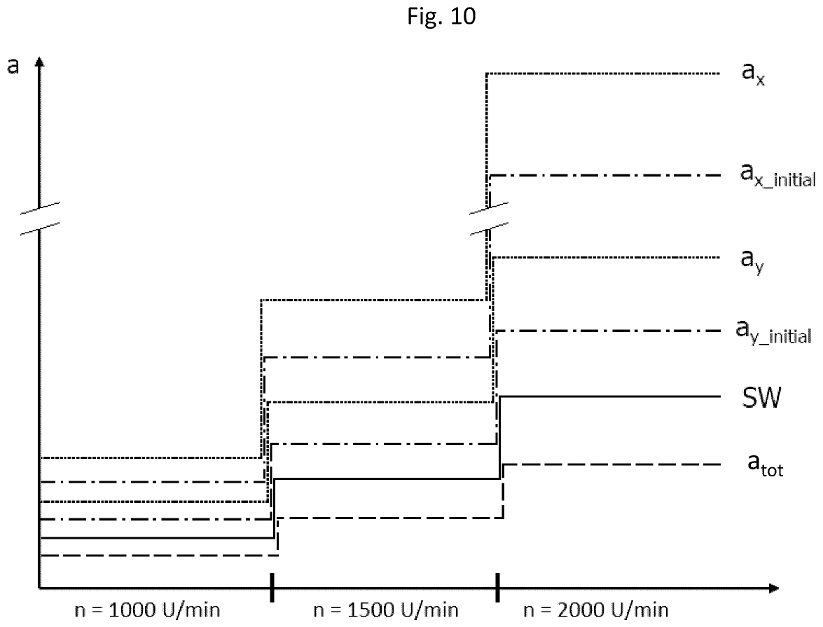

FIG. 10 shows quantities representative of acceleration, initial quantities representative of acceleration, a total acceleration and a threshold value above the speed according to certain embodiments.

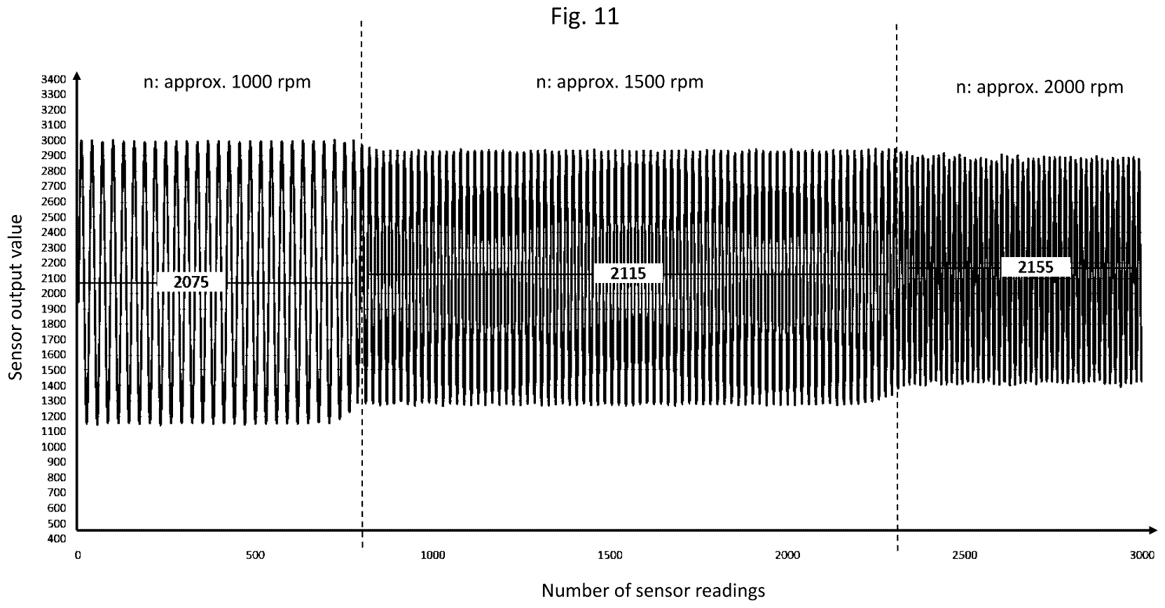

FIG. 11 shows a sinusoidal signal superimposed on a variable detected by the sensor unit when the monitoring module is aligned horizontally and at different speeds.

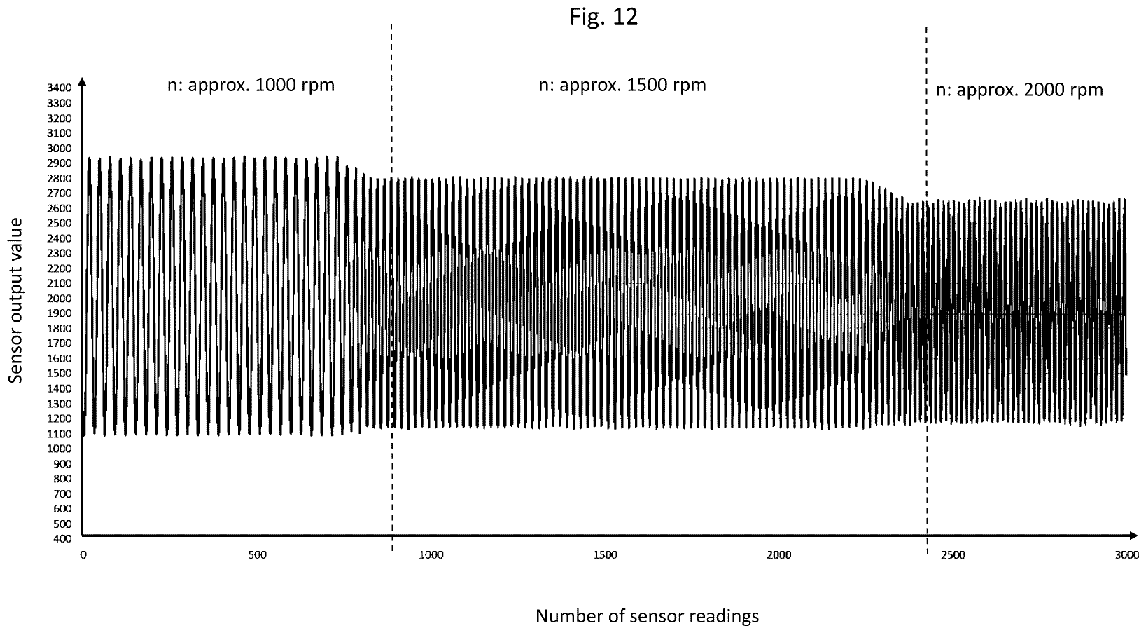

FIG. 12 shows a sinusoidal signal superimposed on a variable detected by the sensor unit when the monitoring module is aligned horizontally and at different speeds.

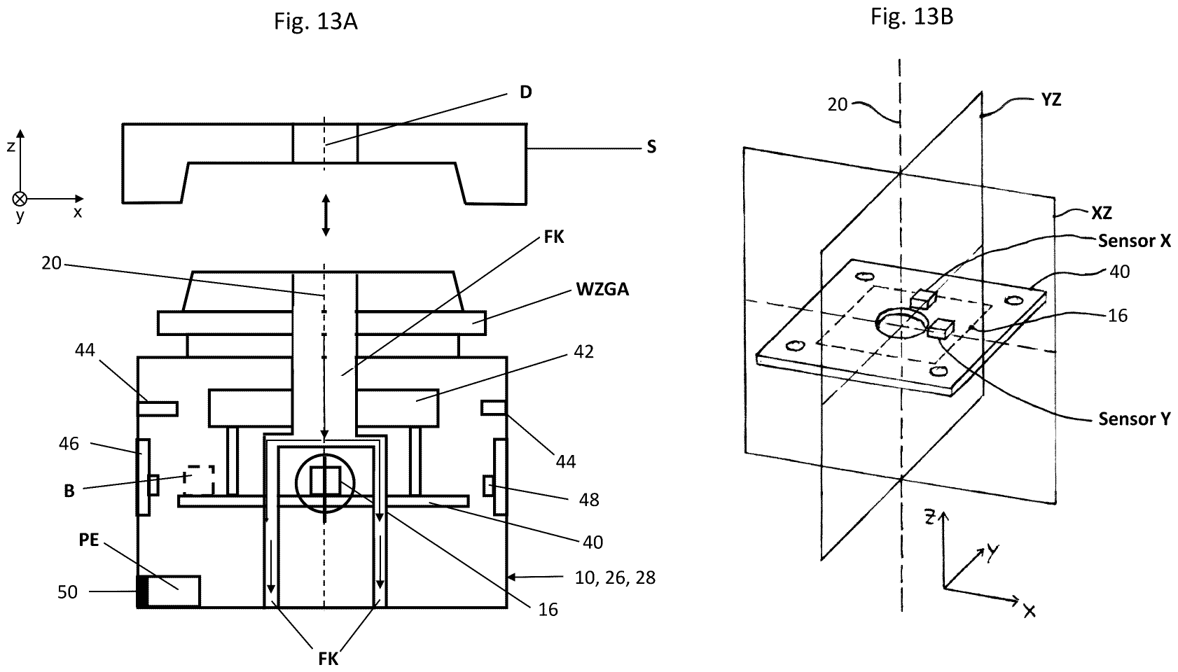

FIG. 13A shows the arrangement and design of a fluid channel and other optional components of a monitoring module according to certain embodiments.

FIG. 13B schematically shows a sensor board and a sensor unit with fluid channel according to certain embodiments.

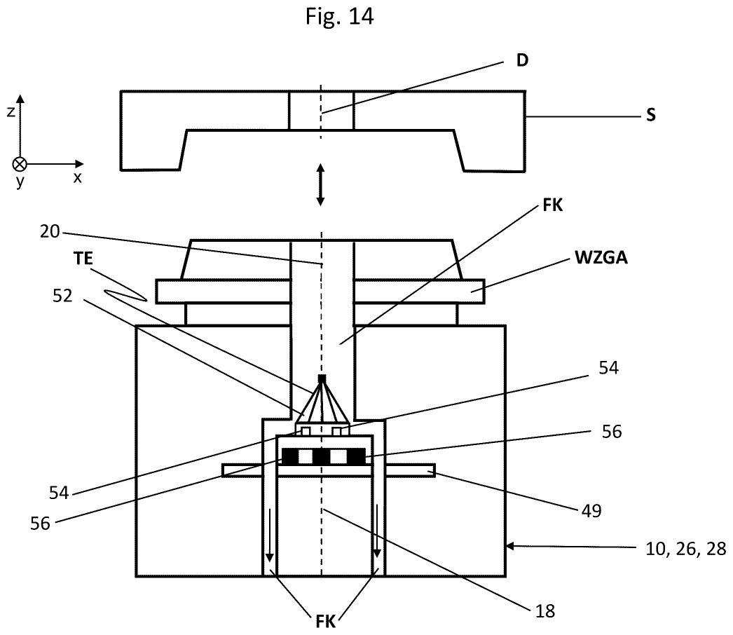

FIG. 14 shows a turbine unit for generating its own energy in a monitoring module according to certain embodiments.

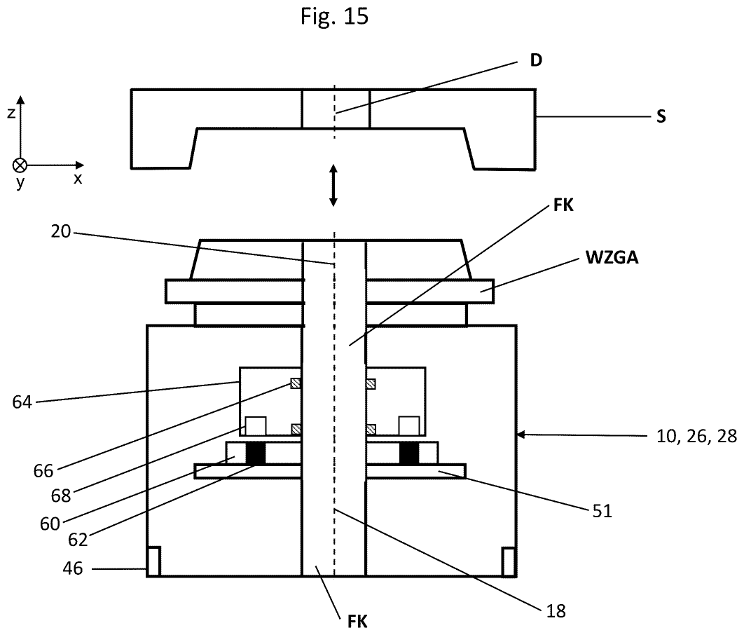

FIG. 15 shows a flywheel for generating its own energy in a monitoring module according to certain embodiments.

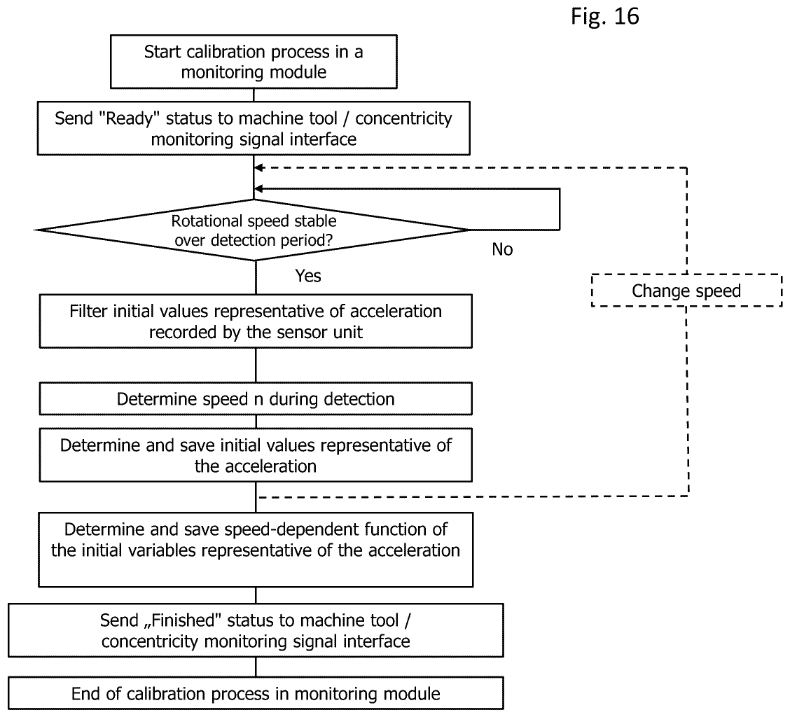

FIG. 16 shows the sequence of a calibration process with evaluation in the monitoring module according to certain embodiments.

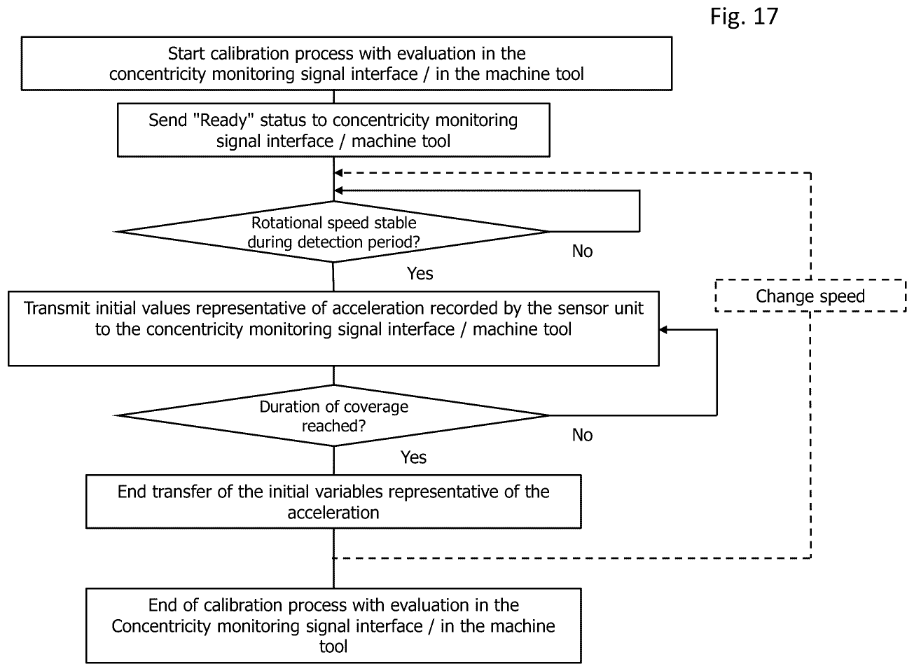

FIG. 17 shows the sequence of a calibration process with evaluation in the concentricity monitoring signal interface/in the machine tool according to certain embodiments.

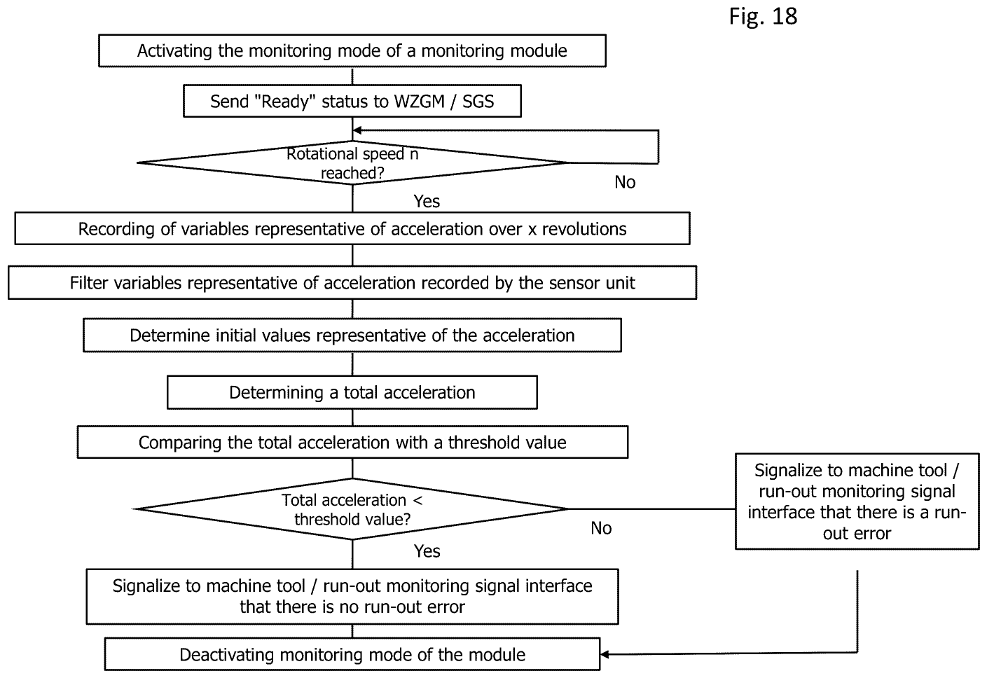

FIG. 18 shows a test sequence for concentricity monitoring of a tool to be rotated during operation with evaluation in the monitoring module at a single test speed according to certain embodiments.

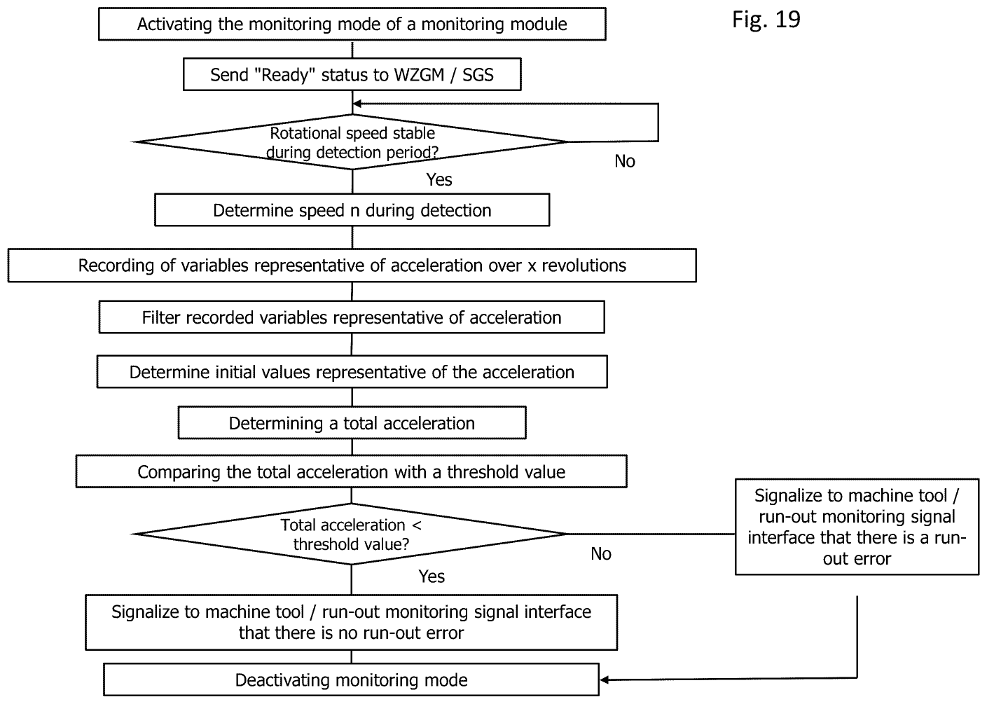

FIG. 19 shows a test sequence for concentricity monitoring of a tool to be rotated during operation with evaluation in the monitoring module at several test speeds according to certain embodiments.

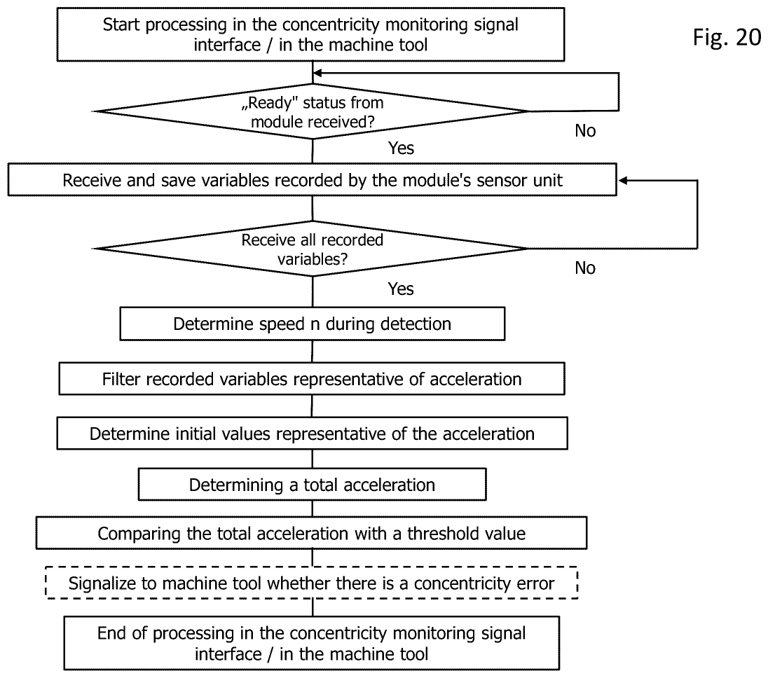

FIG. 20 shows a sequence for concentricity monitoring of a tool to be rotated during operation with evaluation in the concentricity monitoring signal interface/of the machine tool at several test speeds according to certain embodiments.

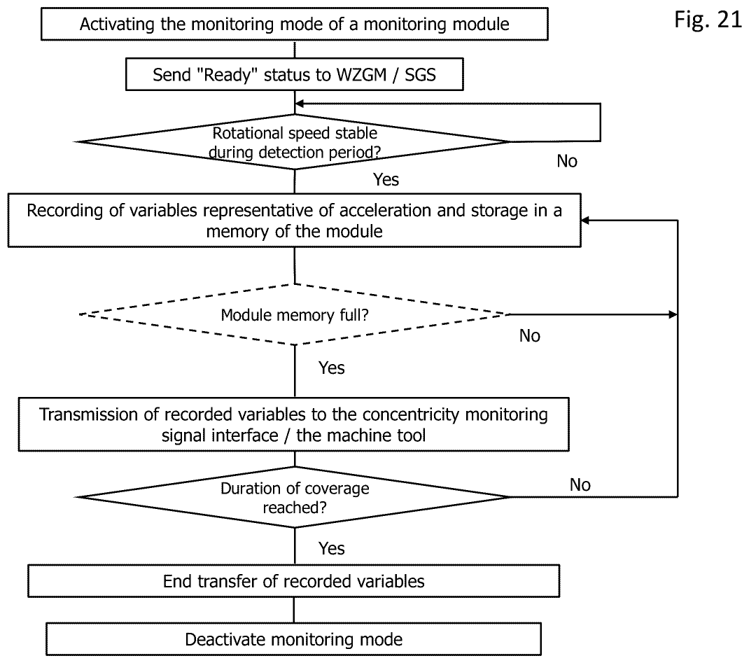

FIG. 21 shows a sequence of continuous process data transmission to the concentricity monitoring signal interface/the machine tool according to certain embodiments.

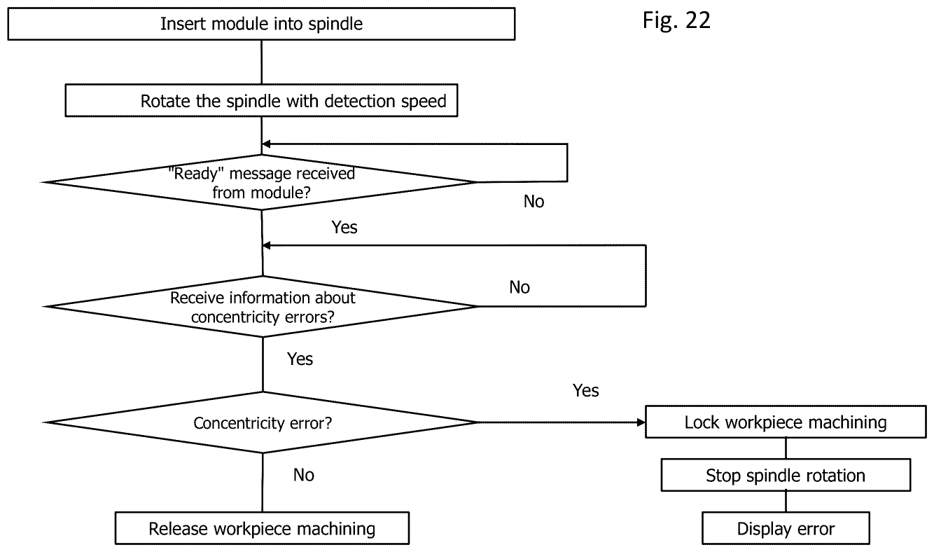

FIG. 22 shows a sequence on the machine tool during communication with the monitoring module/the concentricity monitoring signal interface via 10 signals according to certain embodiments.

### DETAILED DESCRIPTION OF THE FIGURES

FIG. 1 shows a concentricity monitoring module 10 (hereinafter also referred to as monitoring module 10), which is used to monitor the concentricity of a tool WZG to be rotated during operation. The concentricity monitoring module 10 comprises an essentially rotationally symmetrical hollow body in which all the supply, measuring, computing and communication units required for concentricity monitoring are accommodated.

The tool WZG is a tool WZG to be rotated during operation (for machining a workpiece), which is designed here, for example, as a milling cutter. In addition, a tool holder WZGA and a spindle S of a machine tool are shown in FIG. 1, which interact with the concentricity monitoring module 10 during concentricity monitoring. The tool holder WZGA is shown here outside the spindle S, but it can also be integrated into the spindle S when the concentricity monitoring module 10 is inserted into the spindle S of the machine tool to monitor the concentricity of the tool WZG. When the monitoring module 10 rotates together with the spindle S and the tool WZG to machine a workpiece, the concentricity of the monitoring module 10 and thus indirectly the concentricity of the tool WZG (or the concentricity of the combination of monitoring module 10, tool holder WZGA and tool WZG) is monitored. If a concentricity error is present, this indicates a faulty face or taper contact caused, for example, by chips adhering in the spindle S, in particular of the tool holder WZGA and therefore of the concentricity monitoring module 10 in the spindle S.

As can be seen in a sectional view of the concentricity monitoring module 10 according to FIG. 1, the concentricity monitoring module 10 has an essentially cylindrical body, which can be rotationally symmetrical with respect to its axis of rotation 20. The concentricity monitoring module 10 comprises a tool interface 12, which is designed to accommodate the tool WZG. In the present example, the tool interface 12 comprises a receptacle that fits together with a corresponding counterpart of the tool WZG (indicated in FIG. 1 as a double arrow between the interface 12 and the tool WZG).

Similarly, the concentricity monitoring module 10 has a tool holder interface 14, which fits together with a corresponding holder of the tool holder WZGA (indicated in FIG. 1 as a double arrow between the interface 14 and the tool holder me WZGA). The concentricity monitoring module 10 can therefore be coupled to the tool holder WZGA and the tool WZG via the interfaces 12, 14—either by the manufacturer or by an operator. If the concentricity monitoring module 10, the tool holder WZGA and the tool WZG are then inserted together into the spindle S of the machine tool in the assembled state (indicated in FIG. 1 as a double arrow between the spindle S and the tool holder WZGA), the tool holder WZGA, the concentricity monitoring module 10 and the tool WZG rotate together around the axis of rotation 20 of the concentricity monitoring module 10 to machine a workpiece. The speed is determined by the rotating spindle S.

An electronics unit is arranged within the monitoring module 10, which comprises a first sensor unit 16, a second optional sensor unit B, a computing unit 22, a communication unit 24 and a power supply unit V. As indicated in FIG. 1 by the arrows from the energy supply unit V to the corresponding components, the energy supply unit V supplies the first sensor unit 16, the second sensor unit B, the computing unit 22 and the communication unit 24 with the electrical energy necessary to perform the measuring, computing and communication operations described in this disclosure, which are necessary for the concentricity monitoring of the tool WZG.

Communication within the concentricity monitoring module 10 between the computing unit 22 and the first sensor unit 16, the second sensor unit B and the communication unit 24 takes place via communication lines shown as dashed arrows in FIG. 1, which are exemplified here as an SPI bus.

To monitor the concentricity of the concentricity monitoring module 10 and thus of the tool WZG, centrifugal accelerations in a plane of rotation E are observed by means of the first sensor unit 16 during a rotation of the concentricity monitoring module 10 about the axis of rotation 20—either before, after and/or during the machining of a workpiece. For this purpose, the first sensor unit 16 comprises a biaxial acceleration sensor, which is arranged in the concentricity monitoring module 10 in such a way that it detects accelerations in an x-y plane (plane of rotation E), which is orientated essentially normal to the axis of rotation 20. This plane of rotation E is indicated in FIG. 1 as running through the concentricity monitoring module 10.

In order to realise this type of acceleration detection, the first sensor unit 16 is arranged in the center of rotation of the concentricity monitoring module 10 in such a way that the axis of rotation of the concentricity monitoring module 10 runs through the sensor unit 16. As shown in FIG. 1, the axis of rotation 20 and an axis of inertia 18 of the acceleration sensor of the first sensor unit 16 ideally run essentially coaxially. Due to this arrangement of the axis of inertia of the sensor unit 16 in the z-direction, the other axes of inertia of the sensor unit 16 in the x- and y-directions are essentially orthogonal to the axis of rotation 20, so that the accelerations can be measured in the plane E. In this example, the sensor unit 16 only has two sensitive axes of inertia, namely in the x and y directions.

The third axis of inertia, namely that in the z direction, is not sensitive in the present example (no accelerations are detected along this axis) and therefore serves in particular to precisely align the sensor unit 16 with the axis of rotation 20. In other examples, however, the sensor unit 16 can be designed so that acceleration can also be measured in the z direction.

The following applies to the centrifugal acceleration a: a=ω²*r where ω=2*π*n and therefore a=4*π²*n²*r where n=rotational speed of the concentricity monitoring module 10 (and consequently of the sensor unit 16) in 1/sec, ω=angular velocity and r=radial distance of the sensor unit 16 from the rotational axis 20 of the monitoring module 10. Accordingly, the centrifugal acceleration acting on the sensor unit 16 increases with increasing rotational speed of the spindle S, whereby the rotational speed is included in the calculation as a square.

However, if the axis of inertia of the sensor unit 16 coincides exactly with the axis of rotation 20 of the monitoring module 10 and the axis of rotation 20 also runs coaxially to an axis of rotation D (see also FIG. 4) of the spindle S, this results in a centrifugal acceleration of zero, even at relatively high speeds of the spindle S, as the radial distance is zero (r=0). This is therefore the case with optimum alignment of the sensor unit 16 if there is no concentricity error.

However, if there is a clamping error of the tool holder WZGA in the spindle S, for example, because a chip is jammed when the tool holder WZGA is inserted into the spindle S, this results in an offset of the monitoring module 10 and thus of the sensor unit 16 relative to the axis of rotation D of the spindle S. The radial distance is then no longer zero (r≠0), so that a centrifugal acceleration acts on the sensor unit 16 during rotation. During rotation, the sensor unit 16 then records representative variables ax, ay for the acceleration in the x-direction and for the acceleration in the y-direction and transmits these to the computing unit 22, in particular in the form of digital sensor values that characterise the acceleration in the respective direction or can be converted into the acceleration in the respective direction in the computing unit 22. Based on the variables representative of the acceleration in the x and y directions ax, ay, a total acceleration value is then determined by the computing unit 22 and compared with a threshold value. a_tot=√(a_x\hat{ }2+a_y\hat{ }2) and compared with a threshold value. If the total acceleration is greater than the threshold value, there is a concentricity error in the monitoring module 10.

The optional further sensor unit B is exemplarily designed as a single-axis acceleration sensor, the sensitive axis of which is arranged orthogonally to the axis of rotation (20) in the radial direction and which is set up to detect at least one further variable representative of an acceleration (hereinafter also referred to as further acceleration variable). However, the present disclosure is not limited to this. For example, the optional sensor unit B can alternatively be designed in the same way as the first sensor unit B, i.e. as a biaxial acceleration sensor which is set up to detect further variables representative of acceleration (hereinafter also referred to as further acceleration variables) in two directions orthogonal to one another. Since the further sensor unit B can be designed as a single-axis or dual-axis acceleration sensor which measures either one or two further acceleration-representative variables, the expressions “further acceleration-representative variable” and “further acceleration-representative variables” are also used synonymously in the context of this disclosure, unless otherwise stated at the relevant point or a contrary technical meaning is apparent.

The further sensor unit B is radially spaced from the axis of rotation (20) and arranged in the concentricity monitoring module 10 in such a way that it also detects these further acceleration variable(s) in the plane E orientated normal to the axis of rotation 20 of the monitoring module, i.e. as centrifugal accelerations. In particular, the speed can be determined from these further acceleration variables during the detection of the variables ax, ay, which are representative of the acceleration, for example by using the formula a=4*π²*n²*r by converting to n and calculating the rotational speed n if the angular velocity is known. The off-center position of the additional sensor unit B causes a clear signal change (of the variable(s) representative of the acceleration) as the speed changes. A concentricity error of the monitoring module 10, 26, 28 causes only a very small change in radius in relation to the radius position (radial distance to the axis of rotation 20) of the additional sensor unit B, which means that the influence of the concentricity error on the accuracy of the speed determination is negligible.

FIG. 2 shows a concentricity monitoring tool mounting module 26 (hereinafter also referred to as monitoring module 26), with which the concentricity of a tool WZG to be rotated during operation is monitored. The concentricity monitoring tool mounting module 26 comprises an essentially rotationally symmetrical hollow body, which is preferably designed as a hollow cylinder and in which all the supply, measuring, computing and communication units required for concentricity monitoring are accommodated.

The tool WZG is a tool WZG to be rotated during operation (for machining a workpiece), which is designed here, for example, as a milling cutter. In addition, FIG. 2 shows a spindle S of a machine tool (see also FIG. 4), which interacts with the concentricity monitoring tool holder module 26 during concentricity monitoring. When the concentricity monitoring tool holder module 26 rotates together with the spindle S and the tool WZG to machine a workpiece, the concentricity of the tool WZG is monitored. If there is a concentricity error of the tool WZG, this indicates a faulty flat contact of the concentricity monitoring tool mounting module 26 in the spindle S caused, for example, by chips adhering in the spindle S.

The concentricity monitoring tool holder module 26 further comprises a tool holder WZGA, via which the concentricity monitoring tool holder module 26 is inserted into the spindle S of the machine tool. In this example, the tool holder WZGA is designed as a hollow shank taper (HSK) and is firmly coupled to the concentricity monitoring tool holder module 26.

Otherwise, the concentricity monitoring tool holder module 26 comprises the same components first sensor unit 16 (with non-sensitive inertia axis 18 in the z-direction), optional second sensor unit B, computing unit 22 and communication unit 24. These components have the same functionality in the concentricity monitoring tool holder module 26 as in the concentricity monitoring module 10 and are arranged identically and connected to each other operationally (for communication and for power supply), so that reference is made in this respect to the explanations relating to FIG. 1, including the explanations relating to the observation of the centrifugal accelerations in plane E.

FIG. 3 shows a concentricity monitoring tool module 28 (hereinafter also referred to as monitoring module 28), with which the concentricity of a tool WZG to be rotated during operation is monitored. The concentricity monitoring tool module 28 comprises an essentially rotationally symmetrical hollow body, which is preferably designed as a hollow cylinder and in which all the supply, measuring, computing and communication units required for concentricity monitoring are accommodated.

The tool WZG is a tool WZG to be rotated during operation (for machining a workpiece), which is designed here, for example, as a milling cutter. In addition, FIG. 3 shows a spindle S of a machine tool (see also FIG. 4), which interacts with the concentricity monitoring tool module 28 during concentricity monitoring. When the concentricity monitoring tool module 28 rotates together with the spindle S to machine a workpiece, the concentricity of the tool WZG is monitored. If there is a concentricity error of the tool WZG, this indicates a faulty flat contact of the concentricity monitoring tool module 28 in the spindle S caused by chips adhering to the spindle S, for example.

Similar to the concentricity monitoring tool module 26 shown in FIG. 2, the concentricity monitoring tool module 28 also comprises a tool holder WZGA, via which the concentricity monitoring tool module 28 is inserted into the spindle S of the machine tool. In this example, the tool holder WZGA is designed as a hollow shank taper (HSK) and is firmly coupled to the concentricity monitoring tool module 28.

In contrast to the monitoring modules 10 and 26 shown in FIGS. 1 and 2, the concentricity monitoring tool module 28 comprises the tool WZG. The tool WZG and the concentricity monitoring tool module 28 are permanently coupled to each other and are inserted into the spindle S as a complete unit together with the tool holder WZGA. Otherwise, the concentricity monitoring tool module 28 comprises the same components first sensor unit 16 (with non-sensitive inertia axis 18 in the zdirection), optional second sensor unit B, computing unit 22 and communication unit 24. These components have the same functionality in the concentricity monitoring tool module 28 as in the concentricity monitoring module 10 and are arranged identically and connected to each other operationally (for communication and for power supply), so that reference is made in this respect to the comments on FIG. 1 including the comments on the consideration of the centrifugal accelerations in the plane E.

With reference to FIG. 4, a machine tool WZM is described, which is exemplarily designed as a multi-axis machining center BA. The concentricity of a tool WZG to be rotated during operation is monitored by means of the machine tool WZM in co-operation with one of the monitoring modules 10, 26 or 28. The example in FIG. 4 is illustrated using the concentricity monitoring tool module 28. However, it should be noted that the concentricity monitoring tool module 28 is here only representative of one of the monitoring modules 10, 26, 28 and that the machine tool WZM can interact in the same way with the concentricity monitoring module 10 and the concentricity monitoring tool mounting module 26 during operation.

The machine tool WZM of FIG. 4 comprises a main spindle S which, by way of example, can be moved in three orthogonal directions X, Y, Z within a working space of the machine tool WZM and can be rotated about the Z-axis. Such a rotation about an axis of rotation D (which runs in the z-direction in the drawing plane of FIG. 4) of the spindle S of the machine tool WZM generally takes place during the machining of a workpiece by the machine tool WZM.

In addition, the machine tool comprises a control 32, a communication unit 30 and a tool changer (not shown in Fig.), which is set up to accommodate at least the monitoring modules 10, 26 and 28. In this way, a monitoring module 10, 26, 28 (the monitoring modules 10 and 26 are then in particular already coupled to a tool WZG) can be changed into the spindle S at any time before or after the machining of a workpiece in order to check the concentricity of the tool WZG, in particular during a subsequent machining step.

For this purpose, the control 32 of the machine tool WZM is also set up to set a speed of the spindle S. In addition, the control unit 32 is set up to control communication with the monitoring module 28 via the communication unit 30. For this purpose, the communication unit 30 of the machine tool WZM communicates by wire with a data transmission unit 34. The data transmission unit 34 is coupled via a radio link to the communication unit 24 of the monitoring module 28 and is set up and intended to receive signals and data such as the variables ax, ay and other variables described in the context of this disclosure from the communication unit 24 of the monitoring module 28 and to transmit them to the machine tool WZM, more precisely to its communication unit 30.

In an alternative variant, which is not shown in FIG. 4, the function of the data transmission unit 34 is included in the communication unit 30 of the machine tool WZM. The data transmission unit 34 is then omitted as a physical unit. In these cases, data and signals are transmitted between the machine tool and the monitoring module 28 directly and preferably by means of radio or infrared signals.

For concentricity monitoring, the sensor unit 16 of the monitoring module 28 records the variables ax, ay, which are representative of the acceleration, as described with reference to FIG. 1. The variables ax, ay are then transmitted to the computing unit 32 of the machine tool via the communication unit 24 (according to FIG. 4 via the data transmission unit 34 and via the communication unit 30 of the machine tool). The computing unit 32 determines the total acceleration atot from the variables ax, ay in order to then compare this with the threshold value. If the total acceleration atot is above the threshold value, the machine tool WZM determines that there is a concentricity error in the monitoring module 28.

FIG. 5 shows a concentricity monitoring signal interface SGS with a communication unit 36 and a computing unit 38. The concentricity monitoring signal interface SGS is set up to interact operatively with the machine tool WZM (e.g. the machine tool of FIG. 4) and with one of the monitoring modules 10, 26, 28 in order to monitor the concentricity of a tool WZG to be rotated during operation. The example in FIG. 5 is illustrated using the concentricity monitoring tool module 28. However, it should be noted that the concentricity monitoring tool module 28 is here only representative of one of the monitoring modules and that the concentricity monitoring signal interface SGS can interact in the same way with the concentricity monitoring module 10 and the concentricity monitoring tool holder module 26 during operation.

The computing unit 38 of the concentricity monitoring signal interface SGS is set up to control communication with the monitoring module 28 via the communication unit 36. For this purpose, the communication unit 36 of the runout monitoring signal interface SGS communicates by wire with a data transmission unit 34. The data transmission unit 34 is coupled via a radio link to the communication unit 24 of the monitoring module 28 and is set up and intended to receive signals and data such as the variables ax, ay and other variables described in the context of this disclosure from the communication unit 24 of the monitoring module 28 and to transmit them to the runout monitoring signal interface SGS, more specifically to its communication unit 36.

In an alternative variant, which is not shown in FIG. 5, the function of the data transmission unit 34 is included in the communication unit 36 of the runout monitoring signal interface SGS. The data transmission unit 34 is then omitted as a physical unit. In these cases, data and signals are transmitted between the concentricity monitoring signalling interface and the monitoring module 28 directly and preferably by means of radio or infrared signals.

In addition, the computing unit 38 of the concentricity monitoring signal interface SGS is set up to control communication with the machine tool WZM via a wired communication interface of the communication unit 36. This “communication connection”, which is exemplified here as a field bus system, is illustrated in FIG. 5 by the double arrow with a solid line between the communication unit 36 of the runout monitoring signal interface SGS and the communication unit 30 of the machine tool WZM.

The concentricity monitoring signal interface SGS is set up to receive the values ax, ay, which are representative of the acceleration, recorded by the monitoring module 28 in plane E via the communication unit 36. The computing unit 38 of the concentricity monitoring signal interface SGS is further set up and intended to determine the total acceleration atot from the variables ax, ay received from the monitoring module 28. The total acceleration atot is then compared with the threshold value. If the total acceleration atot is above the threshold value, the concentricity monitoring signal interface SGS determines that there is a concentricity error in the monitoring module 28.

The computing unit 38 of the concentricity monitoring signal interface SGS is also set up and intended to signal to the machine tool WZM whether a concentricity error is present or not. This takes place via the wired communication connection between the communication unit 36 of the concentricity monitoring signalling interface SGS and the communication unit 30 of the machine tool WZM, via which the concentricity monitoring signalling interface SGS informs the machine tool WZM by means of a test signal (OK/NOK) whether a concentricity error is present (NOK) or whether no concentricity error is present (OK).

With reference to FIG. 6, a concentricity monitoring method for a tool to be rotated in a machine tool is now described. All process steps can be carried out by the machine tool WZM described with reference to FIG. 4. Alternatively, it is possible that some of the process steps are carried out by the monitoring module 10, 26, 28 and/or some of the process steps are carried out by the runout monitoring signal interface SGS. In particular, determining the total acceleration atot, comparing the total acceleration with the threshold value and determining whether a concentricity error is present (these three steps are also referred to below as “evaluation”) can be carried out both by the monitoring modules 10, 26, 28 and by the concentricity monitoring signal interface SGS as well as by the machine tool WZM.

As shown in FIG. 6, the concentricity monitoring method has a first step (i) in which a monitoring module 10, 26, 28 to be rotated during operation or the monitoring module 10, 26 to be rotated during operation and the tool WZG to be rotated are automatically inserted into a spindle S of the machine tool WZM. In particular, the tool changer of the machine tool WZG is approached with the spindle S in order to change one of the monitoring modules 10, 26, 28 contained therein into the spindle S. If this is the monitoring module 10 or the monitoring module 26, these are usually already coupled with the tool WZG and the tool holder WZGA (monitoring module 10) or with the tool WZG (monitoring module 26).

In a second step (ii), the spindle S of the machine tool WZM is rotated at a predetermined speed. This rotational speed (also test rotational speed) is set by the machine tool (or a user of the machine tool) and transmitted by the machine tool—if necessary via the concentricity monitoring signal interface SGS—to the monitoring module 10, 26, 28 or transmitted directly to the concentricity monitoring signal interface SGS if the evaluation takes place in the monitoring module 10, 26, 28 or in the concentricity monitoring signal interface SGS.

In a third step (iii), the variables ax, ay representative of an acceleration are detected or received in a plane E orientated substantially normal to the axis of rotation 20 of the monitoring module 10, 26, 28 to be rotated, while the monitoring module 10, 26, 28 to be rotated rotates at the predetermined speed. This detection is carried out in particular with one of the monitoring modules 10, 26, 28, as described with reference to FIG. 1. The corresponding explanations for FIG. 1 are therefore also valid here. If the machine tool WZM or the concentricity monitoring signal interface SGS carries out the concentricity monitoring process, the acceleration variables ax, ay are transmitted from the monitoring module 10, 26, 28 as raw data to the machine tool/the concentricity monitoring signal interface SGS in the third step and received there.

The above-mentioned evaluation is then carried out in steps (iv) to (vi), wherein in a fourth step (iv) the total acceleration atot is determined based on the detected variables ax, ay representative of the acceleration, in a fifth step (v) the total acceleration atot is compared with a threshold value dependent on a rotational speed of the monitoring module 10 to be rotated, 26, 28 to be rotated during the detection of the variables ax, ay representative of the acceleration, and in a sixth step (vi) it is determined that a concentricity error of the monitoring module 10, 26, 28 to be rotated and/or of the tool WZG to be rotated is present if the total acceleration atot is greater than the threshold value.

In particular, if the evaluation (steps (iv) to (vi)) takes place in the monitoring module 10, 26, 28 or in the concentricity monitoring signal interface SGS, an optional step (vii) can follow, in which the monitoring module 10, 26, 28 or the concentricity monitoring signal interface SGS signals to the machine tool WZM via the described communication units 24 and/or 36 (see also FIG. 5) whether or not there is a concentricity error of the monitoring module 10, 26, 28 and thus of the tool WZG.

The present disclosure also relates to a computer program product (not shown in Fig.) comprising instructions which cause in particular the method steps (i) to (vi) described with reference to FIG. 6 and optionally the method step (vii) as well as further method steps described below to be executed. According to one example, the computer program product comprises instructions which cause the machine tool (as described with reference to FIG. 4) to carry out process steps (i) to (vi) of the concentricity monitoring process. According to a further example, the computer program product comprises instructions that cause the monitoring module 10, 26, 28 to perform method steps (iii) to (vi) of the concentricity monitoring method. According to a still further example, the computer program product comprises instructions that cause the runout monitoring signal interface (SGS) to perform method steps (iii) to (vi) of the runout monitoring method. These different variants can also be combined in a single computer program product.

In the following, with reference to FIGS. 7 to 22, further optional features and designs of the monitoring module 10, 26, 28 and further (partial) process aspects of the concentricity monitoring method are described when recording and/or evaluating the variables ax, ay representative of the acceleration as well as further process variables relevant for concentricity monitoring. The features described with reference to further optional steps of the concentricity monitoring method can also be transferred to the monitoring module 10, 26, 28 and vice versa. Whenever the first sensor unit 16 (with inertia axis 18 in the z-direction), the second sensor unit B, the energy supply unit V, the computing unit 22 or the communication unit 24 are mentioned in the description of FIGS. 7 to 22, these descriptions refer to the corresponding components of each monitoring module 10, 26 and 28.

FIG. 7 shows a sectional view through a monitoring module 10, 26, 28, a tool holder WZGA and a spindle S of a machine tool WZM (see also FIG. 4) in a clamping situation, i.e. shortly before the spindle S changes the monitoring module 10, 26, 28 from the tool changer into the spindle. The sectional view shows the first sensor unit 16 and the further optional sensor unit B, which are arranged on a sensor board 40. In this example, the sensor board 40 is connected to a board holder 42 via vertical struts. The circuit board holder 42 is floatingly mounted in the monitoring module 10, 26, 28, which is why no exact type of suspension is shown in FIG. 7. FIG. 7 also shows two threaded pins 44, which serve as adjustment means for the floatingly suspended circuit board holder 42 and which press directly on the circuit board holder 42. In addition, FIG. 7 shows that the monitoring module 10, 26, 28 comprises two optional antenna covers 46 and two optional antennas 48 (for better clarity, the reference signs 46, 48 are only shown once in FIG. 7). Finally, the monitoring module 10, 26, 28 comprises a photosensitive unit PE with a photosensitive surface 50 located on the outer circumference of the monitoring module 10, 26, 28 and directed radially outwards.

The antennas 48 and the antenna covers 46 together form an antenna unit. Here, the antenna covers 46 are arranged directly on the outer circumference of the monitoring module 10, 26, 28 by way of example and may comprise, for example, a body manufactured separately from the rest of the body of the monitoring module 10, 26, 28 and/or form a section of the monitoring module 10, 26, 28 consisting of a different material. The antennas 48 are arranged within the monitoring module 10, 26, 28 between the antenna covers 46 and the axis of rotation 20, wherein the horizontal position of the antennas 48 shown in FIG. 7 is merely exemplary; they may also be arranged further towards the axis of rotation 20. The antenna cover 46 extends in the axial direction of the axis of rotation 20 by four times the antennas 48 in this example. In other variants, the antenna cover 46 can extend in the axial direction of the axis of rotation 20 by a factor of two to ten, whereby all integer intermediate values are included as further possible range limits. The antenna covers 46 thus cover the antennas 48 on the outside in order to protect them from damage, dirt and cooling lubricants. The antenna covers 46 may comprise at least predominantly or completely non-conductive materials in order not to impair the propagation of the radio waves. The antenna covers may comprise, for example, plastics, glass, ceramics and/or moulding compounds.

The set screws 44 are used to arrange the floatingly suspended circuit board holder 42 and thus the sensor unit 16 or, as in the example here, its z-axis of inertia 18 directly in the center of rotation of the monitoring module 10, 26, 28. The threaded pins 44 thus serve to balance the sensor unit 16, whereby the sensor unit 16 or its z-axis of inertia is aligned at least almost coaxially to the axis of rotation 20 of the monitoring module 10, 26, 28. This centring is preferably already carried out during the manufacture of the monitoring module 10, 26, 28.

Further threaded pins 45 can be inserted into the body of the monitoring module 10, 26, 28 via radial threaded holes not shown in FIG. 7 and thus enable fine adjustment of the sensor unit 16, which can in particular also be carried out by the user. The radial threaded holes are designed to accommodate a large number of threaded pins 45 of different weights (the different weights of the threaded pins 45 are indicated in FIG. 7 by their different sizes) and all of these threaded pins can accommodate additional masses. As a result, the fine balancing can be carried out for each monitoring module 10, 26, 28, for example, depending on the optional components used and the resulting weight ratios in the monitoring module(s) 10, 26, 28 or also after a change of the tool WZG (this applies in particular to the monitoring modules 10 and 26 according to FIGS. 1 and 2).

FIG. 7 also shows that the further sensor unit B, which is also arranged on the sensor board 40, is radially spaced from the sensor unit 16. Here, the distance between the further sensor unit B and the sensor unit 16 normal to the axis of rotation 20 is approximately 75% of the radius of the monitoring module 10, 26, 28. However, the present disclosure is not limited to this. The distance may also be between 3% and 90% (all integer intermediate values being included as further possible range limits). It is only essential that the further sensor unit B is not aligned coaxially to the axis of rotation 20, since no reliable determination of the rotational speed is possible at this position.

With reference to FIG. 8, the measuring principle used for concentricity monitoring is explained in more detail using real measurement data. To illustrate this, the (absolute) digital output values of the sensor unit 16 are shown in two diagrams in the x-direction (ax, upper diagram) and in the y-direction (ay, lower diagram) over the number of measured values and in each case at different speeds.

In the measurement according to FIG. 8, the monitoring module 10, 26, 28 is arranged vertically in a spindle S, so that the axis of rotation 20 of the monitoring module 10, 26, 28 follows the vertical and the variables representative of the acceleration (the output values of the sensor) are recorded by the sensor unit 16 in the plane E orientated normal to the vertical, i.e. in a horizontal plane of rotation of the monitoring module 10, 26, 28. The test speeds are approximately 500 rpm, 1000 rpm, 1500 rpm and 2000 rpm and the corresponding sections of the diagrams of FIG. 8, which show the output values of the sensor unit 16 at these test speeds, are separated by dashed vertical lines. The measuring range of the sensor unit 16 is here exemplarily ±2 g, the resolution (sensitivity) of the sensor unit 16 is here exemplarily 1024 digital values (corresponding to 10 bits) per g and the sampling rate is—also exemplarily—0.5 kHz.

The diagrams in FIG. 8 differ in particular in that the upper diagram shows the output values of the sensor unit 16 in the x-direction (ax) and the lower diagram shows the output values of the sensor unit 16 in the y-direction (ay). In addition, three different curves are shown for each axis. The solid curves represent the output values of the sensor unit 16 when the z-axis of inertia 18 of the sensor unit 16 is aligned as coaxially as possible with the axis of rotation 20 of the monitoring module 10, 26, 28. The dashed curves represent the output values of the sensor unit 16 when its z-axis of inertia 18 is arranged at a radial distance of around 10 μm from the axis of rotation 20 due to tilting/eccentricity of the monitoring module 10, 26, 28. Finally, the dash-dotted curves represent the output values of the sensor unit 16 when its z-axis of inertia 18 is arranged at a radial distance of around 30 μm from the axis of rotation 20 due to tilting/eccentricity of the monitoring module 10, 26, 28.

As can be seen from the upper diagram in FIG. 8, the sensor unit 16 is actually arranged at least approximately coaxially to the axis of rotation 20 of the monitoring module 10, 26, 28 in the x-direction, which is complex due to tolerances in the production of the sensor unit 16, but also due to assembly and production tolerances of the monitoring module 10, 26, 28. As a result, there is no increased acceleration in the x-direction even if the speed is increased. The acceleration value ax therefore remains constant up to a speed of around 2000 rpm; no increased acceleration ax can be measured. In contrast, the dashed curve and the dotted line curve in the upper diagram in FIG. 8 show how the acceleration value ax behaves when the sensor unit is 10 am or 30 μm away from the axis of rotation 20 in the x-direction. At a speed of 500 rpm, there are slight changes in the acceleration values ax at 10 μm and 30 μm. The acceleration value ax then increases more strongly with each increase in speed, particularly with a center offset of the sensor unit 16 in the x-direction of 30 am (dotted line curve), so that at a speed of around 2000 rpm an ax value of over 2200 is already achieved, which corresponds to an additional acceleration of over 1 g (in this example around 1.3 m/s²). As shown in the lower diagram in FIG. 8, the acceleration curves in the y-direction with a center offset of 10 am (dashed curve) and with a center offset in the y-direction of 30 am (dotted curve) behave almost identically to the measurement of the corresponding center offset in the x-direction, which is why reference is made here to the description of the upper diagram in FIG. 8. The solid curve in the lower diagram in FIG. 8 represents the acceleration values recorded by the sensor unit 16 in the y-direction. While these ay values are still almost constantly close to zero at a relatively low speed of around 500 rpm (the sensor value of 2050 corresponds to around 0 g), they increase with increasing speed at around 2000 rpm to just under 2100, which corresponds to around 0.5 m/s². Although this is a comparatively low acceleration value, it characterises the fact that the sensor unit 16 was not exactly coaxial to the axis of rotation 20 during the measurement.

Since correct concentricity is extremely important in high-precision applications in the field of workpiece machining, such an “imbalance” of the sensor unit 16, which results from a slight radial and/or angular offset (which is still within corresponding tolerance limits) of the sensor unit 16 relative to the axis of rotation 20, can be compensated for, for example, by carrying out a calibration run. In this calibration run, initial variables ax, ay (hereinafter also referred to as initial (acceleration) variables) representative of the acceleration are measured by means of the sensor unit 16 installed in the monitoring module 10, 26, 28. This recording of the variables ax_initial, ay_initial representative of the initial acceleration is basically carried out in the same way as the recording of the variables ax, ay representative of the acceleration (see also the description of FIG. 1). The initial variables ax_initial, ay_initial are stored in a memory of the monitoring module 10, 26, 28 together with the test speed during the acquisition. Alternatively, the initial variables ax_initial, ay_initial can be transmitted via the communication unit 24 of the monitoring module 10, 26, 28 to the concentricity monitoring signal interface and/or to the machine tool WZM and stored there in local memories.

The calibration run, which can be performed for one or more test speeds, is performed separately from normal operation, in which a workpiece is machined in the machine tool WZM, when the spindle S has run up, i.e. when an essentially constant test speed prevails or this deviates by a maximum of 10% from the specified test speed. If several calibration runs are carried out for different speeds, this results in a speed-dependent function of the initial variables ax_initial, ay_initial, which is stored in the memory of the monitoring module 10, 26, 28 and/or the concentricity monitoring signal interface SGS and/or the machine tool WZM.

In addition, the calibration run is carried out here as an example under ideal conditions monitored by the manufacturer, whereby the spindle S and the monitoring module 10, 26, 28 are clean and there are no chips in the effective range of these components, so that the monitoring module 10, 26, 28 lies ideally flat against the spindle S.

The determined initial values ax_initial, ay_initial are then taken into account in the form of offset values when determining the total acceleration atot. The total acceleration value atot is calculated in terms of a resulting total acceleration a resulting as follows.

$$a\_tot = a\_resulting = √ ( ( a\_x - a\_ ( x\_initial ) ) ⋀ 2 + ( ( a\_y - a\_ ( y\_initial ) ) ⋀ 2 )$$

FIG. 9A illustrates how the total acceleration determined is composed of the acceleration components ax a_{resulting} is made up of the acceleration components ax, ax_initial, ay and ay_initial and, consequently, how an amount r and an angle of a radial acceleration a_{resulting} i.e. taking into account the initial acceleration values ax_initial and ay_initial, an amount r and an angle of a run-out error are determined. A unit circle divided into four quadrants is shown in FIG. 9A, through the center of which the axis of rotation 20 runs in the direction from the spindle S to the tool WZG.

While the amount r (in μm) of the run-out error is determined by taking into account the speed n prevailing when the acceleration variables are recorded as r=a_resulting/(4*π\hat{ }2*n²) the magnitude of the angle of the run-out error depends on the quadrant in which the direction vector of the total acceleration is a_resulting. The calculation of the direction angle α of the radial runout is calculated using a tangent function in accordance with the following table.

| ax − | ay − | Quad- | |
|---|---|---|---|
| ax_initial | ay_initial | rant | Calculation |
| >0 | >0 | QI | α = arctan((a_y − a_(y_initial))/ |
| | | | (a_x − a_(x_initial) )) |
| =0 | >0 | — | α = 90° |
| <0 | >0 | QII | α = arctan((a_y − a_(y_initial))/ |
| | | | (a_x − a_(x_initial) )) + 180° |
| <0 | <0 | QIII | α = arctan((a_y − a_(y_initial))/ |
| | | | (a_x − a_(x_initial) )) + 180° |
| =0 | <0 | — | α = 270° |
| >0 | <0 | QIV | α = arctan((a_y − a_(y_initial))/ |
| | | | (a_x − a_(x_initial) )) + 360° |

In FIG. 9B, the total acceleration atot is shown as an output value of a calibrated sensor unit 16 over various rotational speeds and with various positioning of the z-axis of inertia 18 of the sensor unit 16 relative to the axis of rotation of the monitoring module 10, 26, 28. The measuring range of the sensor unit 16 is again exemplarily ±2 g, the resolution (sensitivity) of the sensor unit 16 is again exemplarily 1024 digital values (corresponding to 10 bits) per g and the sampling rate is—again exemplarily−0.5 kHz. All calculations on which FIG. 9B is based are carried out using variables ax, ay, ax_initial and ay_initial averaged over eight revolutions of the monitoring module 10, 26, 28/the spindle S.

The solid curve (first from the bottom) in FIG. 9B shows the total acceleration atot when the sensor unit 16 assumes a position of “outer center 10 μm”. The dashed curve (second from the bottom) in FIG. 9B shows the total acceleration atot when the sensor unit 16 assumes a position of “outer center 30 μm”. The dash-dotted curve (third from the bottom) of FIG. 9B shows the total acceleration atot when the sensor unit 16 assumes a “center 10 μm” position. The dash-dotted curve with double dots (first from the top) of FIG. 9B shows the total acceleration atot when the sensor unit 16 assumes a “center 10 μm” position. The calculation results of the total acceleration are summarised in the following table.

| | Center | Outer center | Mid | Outer center |
|---|---|---|---|---|
| Speed | 10 μm | 10 μm | 30 μm | 30 μm |
| 500/min | 3 | 1 | 11 | 3 |
| 1000 rpm | 14 | 3 | 50 | 6 |
| 1500/min | 33 | 4 | 114 | 15 |
| 2000/min | 60 | 8 | 206 | 26 |

As can be seen from the table together with FIG. 9B, the total acceleration at the “center 30 μm” position in particular increases to a value of 114 at a speed of 1500 rpm and to 206 at 2000 rpm, which corresponds to approximately 0.2 g.

FIG. 9B also shows that regardless of the exact positioning or the center offset of the sensor unit 16, the total acceleration atot increases with increasing speed. For this reason, the threshold value with which the total acceleration atot is compared in order to check whether there is a concentricity error of the monitoring module 10, 26, 28 is not a static threshold value, but a “dynamic” threshold value that increases with increasing speed.

This is illustrated in FIG. 10, in which the acceleration variables ax, ay, ax_initial, ay_initial and atot (correspondingly a_resulting) as well as a threshold value SW are plotted above the speed of the monitoring module 10, 26, 28. FIG. 10 again shows that all of these variables increase with each increase in speed. The initial variables ax_initial, ay_initial, which are representative of the acceleration, each have a lower acceleration value than the variables ax, ay, which are representative of the acceleration according to the sensitivity direction, which is due, for example, to the fact that a certain (greater) eccentricity/tilting of the sensor unit 16 was present during the measurement of the variables ax, ay in a monitoring mode of the monitoring module 10, 26, 28 compared to the calibration run. However, the calculated total acceleration atot (correspondingly a_resulting) is below the threshold value SW at all speeds, i.e. within a tolerable range, so that there is no concentricity error in this evaluation, but the concentricity of the monitoring module 10, 26, 28 is OK (10). If such an evaluation is performed in the monitoring module 10, 26, 28, the result can be transmitted as a test signal 10 to the machine tool WZM and/or to the concentricity monitoring signal interface SGS. Alternatively, it is possible to transmit the raw data of the measured variables ax, ay, ax_initial, ay_initial to the machine tool WZM and/or to the concentricity monitoring signal interface SGS and to carry out the evaluation there.

Since the rotational speed is quadratic in the determination of the variables ax, ay, ax_initial, ay_initial, it is important that the component that performs the evaluation knows the exact rotational speed(es) at which these variables were determined. Several options are available for this within the scope of the present disclosure.

A first possibility is to determine the rotational speed using further acceleration variables (or a single further acceleration variable), which are determined by the further sensor unit B during the acquisition of the variables ax, ay (and in the calibration run during the acquisition of the initial variables ax_initial, ay_initial) that are representative of the acceleration. The detection principle for the rotational speed via the additional sensor unit B is described with reference to FIG. 1; the explanations there are also valid here.

A second possibility, in which the additional optional sensor unit B for speed detection can be dispensed with, is illustrated with reference to FIGS. 11 and 12. The sensor unit 16 has a measuring range of ±2 g and a resolution of 1024 digital values per g. The sampling rate is 1 kHz. The sampling rate is 1 kHz. In the measurements shown in FIGS. 11 and 12, the monitoring module 10, 26, 28 is orientated horizontally. As a result, a sinusoidal signal is superimposed on the actual variable to be measured (e.g. ax, ay, ax_initial, ay_initial) due to the acceleration due to gravity acting on the monitoring module 10, 26, 28 during the measurement.

FIG. 11 shows such a signal superposition, whereby output values (ax) of the sensor unit 16 are shown here in the x-direction at different speeds. Similarly, FIG. 12 shows such a signal superimposition, whereby output values (ay) of the sensor unit 16 are shown here in the y-direction at different speeds. The amplitude of the sinusoidal oscillations superimposed on the measured variables corresponds approximately to the acceleration due to gravity. This applies in particular at a speed of around 1000 rpm, as here (see FIGS. 11 and 12) there is an amplitude of around 1000, which corresponds approximately to the acceleration due to gravity of around 1 g. FIG. 11 also shows that the mean value of the sinusoidal signal increases with increasing speed. Thus, the mean value at about 1000 rpm is at a digital sensor value of 2075, while the mean value at about 1500 rpm rises to a digital sensor value of 2115 and at about 2000 rpm to a digital sensor value of about 2155.

As can also be seen from FIGS. 11 and 12, the frequency of the sinusoidal signal changes with increasing speed. The frequency therefore correlates with the speed, in particular the frequency corresponds to the speed. Thus, the frequency of the sinusoidal oscillation superimposed on the actual measured variables when the monitoring module 10, 26, 28 is aligned horizontally can be used to infer its rotational speed when the actual measured variables are detected using known calculation methods.

The photosensitive unit PE with the photosensitive surface 50 described with reference to FIG. 7 utilises yet another possibility for determining the speed during the detection of the acceleration variables ax, ay, ax_initial, ay_initial. This is an optical speed detection by means of a natural light pattern that is created during the detection. This light pattern is generated by the rotation of the monitoring module 10, 26, 28 and is converted by the computing unit 22 of the monitoring module 10, 26, 28 into a voltage pattern that is repeated with each rotation. The basic frequency of the voltage pattern or the underlying light pattern is then determined. This fundamental frequency φrresponds to the speed of the monitoring module 10, 26, 28 when the acceleration variables ax, ay, ax_initial, ay_initial are detected by the sensor unit 16. If there is insufficient ambient light in the application situation of the monitoring module 10, 26, 28, the photosensitive unit PE is an IR photodiode. In this case, it is not the ambient light that is detected, but infrared radiation, from which the speed can be determined. This infrared radiation is emitted by a transmitter and receiver module of the machine tool WZM for infrared rays. The transmitter comprises an IR LED.

Finally, it is also possible for the machine tool WZM to signal the exact test speed (as specified by the control 32 for the spindle S as the speed) to the monitoring module 10, 26, 28 and/or the concentricity monitoring signal interface SGS via its communication unit 30. This is particularly useful if the evaluation of the concentricity monitoring is carried out in the monitoring module 10, 26, 28 or in the concentricity monitoring signal interface SGS.

FIG. 13A shows a sectional view of an example of a monitoring module 10, 26, 28, which has an optional fluid channel FK. The fluid channel is also indicated in the center of the additional components spindle S and tool holder WZGA shown in FIG. 13A. The tool WZG, in particular of the monitoring module 28, can also have such a fluid channel. Tools WZG, which can be coupled with the monitoring modules 10, 26, can also have a fluid channel. During the machining of a workpiece, necessary coolants and/or lubricants are fed through these fluid channels through the spindle S, the monitoring module 10, 26, 28 and the tool WZG to the machining point, for example to prevent damage to the tool WZG and workpiece and to achieve better machining results.

If the sensor unit 16 is aligned at least approximately coaxially to the axis of rotation 20 of the monitoring module 10, 26, 28, as in the present example, the cooling lubricant flow is not guided exactly centrally in the monitoring module 10, 26, 28 in the example shown in FIG. 13A. As shown in FIG. 13A, the fluid channel FK, which initially starts centrally from a surface of the monitoring module 10, 26, 28 facing the spindle S, is divided into two subsections of the fluid channel FK by a cooling lubricant distributor shortly before the sensor unit 16. As a result, the cooling lubricant is channeled through the machine tool WZM with monitoring module 10, 26, 28 into the two subsections of the fluid channel FK during the machining of a workpiece and is thus guided around the sensor unit 16 or past the sensor unit 16. The fluid channel FK and its subsections are designed in such a way that the cooling lubricant flow from the machine tool WZM to the tool WZG is not impaired.

In an alternative variant, shown in FIG. 13B, the cooling lubricant flow is guided centrally in the monitoring module 10, 26, 28, although the sensor unit 16 (the housing of which is merely indicated in FIG. 13B for better clarity) is aligned at least approximately coaxially to the axis of rotation 20 of the monitoring module 10, 26, 28. For this purpose, both the sensor board 40 and the sensor unit 16 each comprise a central recess (shown here as a round example). As can be seen in FIG. 13B, these central recesses overlap and the axis of rotation 20 of the monitoring module 10, 26, 28 runs through the centers of the recesses. During operation of the monitoring module 10, 26, 28, the recesses serve as a fluid channel FK, which thus runs through the center of the monitoring module 10, 26, 28. In this variant, two single-axis acceleration sensors, sensor X and sensor Y, arranged at 90° to each other, are used within the sensor unit 16. Here, the sensor unit 16 can comprise a central recess that is aligned approximately coaxially to the axis of rotation 20 and comprises two acceleration sensors SX, SY. The first acceleration sensor SX is arranged on the y-z plane and has a sensitive axis orientated orthogonally to the y-z plane. The second acceleration sensor SY is arranged on the x-z plane and has a sensitive axis orientated orthogonally to the x-z plane. This makes it possible to carry out concentricity monitoring even if the sensors X and Y are slightly spaced apart from each other due to the central fluid channel. Due to the spatial arrangement of sensor X in the YZ plane, no centrifugal acceleration acts on the sensor during rotation if there is no tilting. In the event of tilting in the X direction, an acceleration acts in the tangential direction depending on the speed and concentricity error in the X direction. This also applies analogously in the Y direction. As explained above, both accelerations are recorded proportionally by both sensors according to amount and direction (vectorially). By analysing the tangential acceleration, the rotation has no influence on the acceleration value.

The monitoring module 10, 26, 28 must be supplied with electrical energy during operation. The energy supply unit V described with reference to FIG. 1 is provided in the monitoring module 10, 26, 28 for this purpose. This energy supply unit V comprises an energy storage unit, which in the simplest case consists of a replaceable or rechargeable battery or an accumulator. With reference to FIGS. 14 and 15, possibilities for generating energy in the monitoring module 10, 26, 28 are now described. In these cases, the energy storage of the energy supply unit V can also comprise batteries with a comparatively lower capacity or capacitors in which the generated energy is temporarily stored. This requires a generator unit, for example to convert rotational energy into electrical energy. This electrical energy is then fed to the energy storage unit via a rectifier circuit. The energy taken from the energy storage unit can be brought to the nominal voltage required for operating the monitoring module 10, 26, 28 by an optional voltage regulator.

FIG. 14 shows the arrangement of a turbine unit TE in the fluid channel of a monitoring module 10, 26, 28 (shown in sectional view). The turbine unit serves as a generator unit for generating its own power. The cooling (lubricating) medium flow is utilised by a turbine wheel 52. The turbine wheel 52, which has permanent magnets 54 (FIG. 14 shows two permanent magnets as an example), rotates due to this flow of cooling (lubricating) medium. The turbine wheel 52 then rotates relative to a circuit board 49, on which induction coils 56 (e.g. three coils, which are arranged offset by 120° relative to one another, but of which only two coils 56 are referenced in FIG. 14 for the sake of clarity) are arranged in a coil cage and coupled to one another. The turbine wheel 52 and the circuit board 49 are arranged and aligned with respect to each other in such a way that the relative rotational movement between the turbine wheel 52 and the induction coils 56 induces a voltage in the induction coils 56, which is then stored in the energy store of the energy supply unit V.

FIG. 15 shows the arrangement of a flywheel drive in a monitoring module 10, 26, 28 (shown in sectional view). The flywheel drive serves as a generator unit for generating its own power. A circuit board 51 serves as a stator, which is why it is directly coupled to the monitoring module 10, 26, 28. According to other examples, an indirect coupling of the circuit board 51 with the monitoring module 10, 26, 28 can alternatively be provided.

A coil cage 60 with induction coils 62 is arranged on the circuit board 51 as shown in FIG. 15.

To ensure stability at high processing speeds, the coils 62—in corresponding recesses in the coil cage 60—are firmly bonded to the latter (this also applies to the coils 56 described with reference to FIG. 14). In this example, the coils 62 have a manganese-zinc-ferrite core and are coupled to one another via the circuit board 51.

A flywheel 64, which is rotatably arranged inside the monitoring module via several ball bearings 66 (only one reference character 66 is indicated in FIG. 15 for the sake of clarity), has permanent magnets 68 (again, only one reference character 68 is indicated in FIG. 15 for the sake of clarity). When the spindle S and thus the monitoring module 10, 26, 28 is accelerated (positively or negatively), a speed difference arises between the flywheel 62 and the plate 51 due to the mass inertia of the flywheel 64. The flywheel 64 and the circuit board 51 are arranged and aligned in such a way that this speed difference induces a voltage in the induction coils 68 when the monitoring module 10, 26, 28 is accelerated between the flywheel 64 and the induction coils 68, which is then stored in the energy store of the energy supply unit V.

With reference to FIGS. 16 to 22, process sequences and partial process sequences that can be executed by the monitoring module 10, 26, 28, by the concentricity monitoring signal interface SGS and/or by the machine tool WZM are now described. In particular, process steps that are not described in the previous description of Fig. represent optional process steps for concentricity monitoring and/or for the calibration run. These optional process steps can be combined in particular with the process steps described with reference to FIG. 6 and with other process steps described in the context of this disclosure (in particular those relating to the calibration run).

FIG. 16 shows the sequence of a calibration process for one or more test speeds and for an evaluation of the concentricity in the concentricity monitoring module 10, 26, 28. According to FIG. 16, after the start of the calibration process in the monitoring module 10, 26, 28 of the machine tool WZM and/or the concentricity monitoring signal interface SGS, it is signalled that the monitoring module 10, 26, 28 is ready for the acquisition of the initial variables ax_initial, ay_initial. The monitoring module 10, 26, 28 is then in a calibration mode. When the spindle S rotates, the machine tool WZM, for example, monitors whether a specified test speed is stable during the acquisition. The detection lasts for a predetermined number of revolutions of the spindle S, which in this example is eight revolutions. However, the present disclosure is not limited to this exact number of revolutions for the detection duration (also evaluation time).

If the monitored test speed deviates significantly, e.g. by more than 10% from the specified test speed, no acceleration values are recorded by the sensor unit 16. However, if the speed is stable, the acceleration values ax_initial, ay_initial are recorded for the first (or only) test speed. In a subsequent step, the initial values ax_initial, ay_initial recorded by the sensor unit 16 are filtered. In addition, the exact test speed is determined during acquisition using one of the variants described above. For this purpose, further acceleration variables in the x and/or y direction can be determined by the additional sensor unit B, for example, which can then be filtered in the same way. Then, according to the example in FIG. 16, mean values of the variables ax_initial, ay_initial are determined via the number of revolutions (i.e. the detection period).

The test speed can then be changed (e.g. increased). The optional nature of this step is indicated by the dashed outline of the “Change speed” step in FIG. 16. The initial variables ax_initial, ay_initial are then recorded again for the increased test speed, as shown in FIG. 16. Once the initial acceleration variables ax_initial, ay_initial have been recorded for all test speeds, the initial variables ax_initial, ay_initial (in particular their mean values) are assigned to the exact test speed prevailing during the recording, so that a test speed-dependent function of the initial variables ax_initial, ay_initial is determined. This function is then stored in the memory of the monitoring module 10, 26, 28 and is therefore available for calculating the total acceleration atot when the concentricity of a tool WZG is monitored by the monitoring module 10, 26, 28. To exit the calibration mode, the monitoring module 10, 26, 28 signals to the machine tool WZM and/or the concentricity monitoring signal interface SGS that the calibration run is complete (“finished”).

FIG. 17 shows a partial sequence of a calibration run for one or more test speeds and for an evaluation of the initial variables ax_initial, ay_initial recorded in the calibration run in the machine tool WZG (see FIG. 4) or in the concentricity monitoring signal interface SGS (see FIG. 5). Some steps correspond to those of FIG. 16, so that instead of a redundant description, reference is made to the respective steps of FIG. 16, which apply equally to the sequence of FIG. 17.

According to FIG. 17, the machine tool WZM or the concentricity monitoring signal interface SGS in particular can trigger the calibration run using one of the monitoring modules 10, 26, 28, i.e. start it. After the “Ready” message of the monitoring module 10, 26, 28, the initial variables ax_initial, ay_initial recorded at stable speed are transmitted to the machine tool WZM/to the concentricity monitoring signal interface SGS. This continues until the recording duration is reached. The transmission of the initial variables ax_initial, ay_initial is then stopped and—in the variant of the calibration run for several test speeds—the speed is changed. The initial variables ax_initial, ay_initial are recorded and transmitted again at a stable speed until the recording duration is reached again. Once this sequence has been carried out for all test speeds (this is the case if the machine tool WZM/the concentricity monitoring signal interface SGS has received initial acceleration variables ax_initial, ay_initial for all specified test speeds), the machine tool WZM/the concentricity monitoring signal interface SGS ends the calibration process.

FIG. 18 shows the sequence of a concentricity test of a tool WZG carried out in the monitoring module 10, 26, 28 at a single test speed. The monitoring module 10, 26, 28 rotates together with the spindle S of the machine tool WZM and with the tool WZG, e.g. for machining a workpiece.

Firstly, the monitoring module 10, 26, 28 is activated. This is done by a wake-up signal, which causes the monitoring module 10, 26, 28 to switch from an energy-saving mode (standby mode) to a monitoring mode (also measurement mode). In the present example, the wake-up signal is transmitted from the machine tool WZM or from the concentricity monitoring signal interface SGS to the monitoring module 10, 26, 28. However, the present disclosure is not limited to this. In other variants, the wake-up signal is generated by the further sensor unit B when the further variables representative of the acceleration in the x and/or y direction exceed a wake-up threshold. The wake-up signal can also be generated when an amount of energy generated by the energy supply unit V exceeds a predetermined level. In this case, the monitoring module 10, 26, 28 is only set to monitoring mode when it is possible to generate its own power in the monitoring module 10, 26, 28. In addition to activation, the monitoring module 10, 26, 28 logs potential shock events such as falls onto the floor or collisions and stores these in the memory of the monitoring module 10, 26, 28.

In monitoring mode, the monitoring module 10, 26, 28 checks whether a speed is actually present at the monitoring module 10, 26, 28. If no speed is present, the monitoring module 10, 26, 28 switches back to energy-saving mode. However, if a rotational speed is actually present at the monitoring module 10, 26, 28, it remains in monitoring mode and signals its readiness for data acquisition to the machine tool WZM/the concentricity monitoring signal interface SGS (see also the description for FIG. 16). When the spindle S rotates, the machine tool WZM, for example, monitors whether a specified test speed is stable during data acquisition. The detection lasts for a predetermined number of X revolutions of the spindle S (see FIG. 18), which in this example is eight revolutions. However, the present disclosure is not limited to this exact number of revolutions for the detection period.

If the monitored test speed deviates significantly, e.g. by more than 10% from the specified test speed, no acceleration variables are recorded by the sensor unit 16. If the speed is stable, however, the variables ax, ay, which are representative of the acceleration, are recorded at the test speed. The acceleration variables ax, ay recorded by the sensor unit 16 are then filtered. In addition, before, after or during the detection and filtering (this also applies to all other embodiments of this disclosure with corresponding steps), the initial variables ax_initial, ay_initial representative of the acceleration are determined, e.g. by reading in the initial variables ax_initial, ay_initial detected in the calibration run according to FIG. 16. The total acceleration atot is determined and compared with the threshold value SW (see also FIG. 10). If the total acceleration is below the threshold value SW, the machine tool WZM/the runout monitoring signal interface SGS is signalled that there is no runout error (OK). If, on the other hand, the total acceleration atot is equal to or greater than the threshold value SW, the machine tool TCM/runout monitoring signal interface SGS is signalled that there is a runout error (NOK). The monitoring mode is then deactivated so that the monitoring module 10, 26, 28 switches back to energy-saving mode. Deactivation takes place here, for example, in response to a corresponding signal from the machine tool WZM/the concentricity monitoring signal interface SGS. Alternatively, this deactivation can generally (i.e. according to all examples described herein) also be carried out automatically by the monitoring module 10, 26, 28, e.g. if no acceleration variables are determined at all over a certain period of time, which indicates that the monitoring module 10, 26, 28 is currently not being used.

FIG. 19 shows the sequence of a concentricity test of a tool WZG carried out in the monitoring module 10, 26, 28 at several test speeds. The monitoring module 10, 26, 28 rotates together with the spindle S of the machine tool WZM and with the tool WZG, e.g. for machining a workpiece.

The sequence in FIG. 19 differs from that in FIG. 18 only in that the recording of the acceleration variables ax, ay, their filtering, the recording of the initial variables ax_initial, ay_initial, the determination of the total acceleration atot and their comparison with the threshold value SW are carried out for several test speeds. As a result, some steps correspond to those of FIG. 18, so that instead of a redundant description, reference is hereby made to the respective steps of FIG. 18, which apply equally in the context of the sequence of FIG. 19.

In contrast to FIG. 18, according to FIG. 19 the exact test speed n is determined for each detection run (detection of the acceleration variables etc.) during the detection of the variables ax, ay representative of the acceleration using one of the variants described above. The test speed is changed (e.g. increased) between the individual acquisition runs. After the test speed has been increased, the acquisition of the acceleration variables ax, ay for the increased test speed, the acquisition of the exact test speed, the filtering of the acceleration variables ax, ay, the determination of the initial acceleration variables ax_initial, ay_initial, the determination of the total acceleration atot and their comparison with the threshold value SW are carried out again until the acceleration variables ax, ay are acquired for all test speeds.

The increase in the test speed can take place either before the machine tool tool/concentricity monitoring signal interface SGS is signalled whether a concentricity error is present or not. In other words, the machine tool/concentricity monitoring signal interface SGS can be signalled, e.g. in a single data packet, whether a concentricity error has occurred at one of the test speeds (NOK) or whether no concentricity error has occurred (10). Alternatively, these results can be transmitted individually to the machine tool/the concentricity monitoring signal interface SGS for each test speed.

FIG. 20 shows the sequence of a concentricity test of a tool WZG carried out in the machine tool WZG (see FIG. 4) or in the concentricity monitoring signal interface SGS (see FIG. 5) at a single test speed and at different test speeds. One of the monitoring modules 10, 26, 28 rotates together with the spindle S of the machine tool WZM and with the tool WZG, e.g. for machining a workpiece.

After the concentricity check has been started by the machine tool WZM/the concentricity monitoring signal interface SGS, the system waits for the monitoring module 10, 26, 28 to signal that it is ready to perform acceleration measurements. Then (this is not shown in FIG. 20) the acquisition of the variables ax, ay representative of the acceleration takes place (as described, for example, with reference to FIG. 19). These acceleration variables ax, ay are received by the machine tool WZM/the concentricity monitoring signal interface SGS either continuously (as shown in FIG. 20) or when the acquisition in the monitoring module 10, 26, 28 is completed, and are stored in the memory of the machine tool WZM/the concentricity monitoring signal interface SGS. As soon as all recorded acceleration variables ax, ay and any associated test speeds have been received, the evaluation is started in the WZM machine tool/SGS concentricity monitoring signal interface. The test speed(s) are determined during the acquisition and the variables ax, ay representative of the acceleration are filtered.

In addition, the initial variables ax_initial, ay_initial (for several test speeds as a test speed-dependent function) representative of the acceleration are determined by, for example, reading from the memory of the machine tool/the concentricity monitoring signal interface SGS. The total acceleration atot is determined for each test speed and compared with a threshold value SW dependent on the test speed. If this evaluation takes place in the concentricity monitoring signal interface SGS, it can then signal to the machine tool WZM whether a concentricity error of the tool WZG is present (NOK) or not (10). However, this optional step, shown in FIG. 20 with a dashed frame, is not necessary if the evaluation was carried out in the machine tool WZM. The concentricity characteristics of the tool WZG at the corresponding test speeds are then known to the machine tool WZM/the concentricity monitoring signal interface SGS and the concentricity test in the machine tool WZM/the concentricity monitoring signal interface SGS is completed.

FIG. 21 shows a partial sequence of a concentricity test of a tool WZG carried out in a machine tool WZG (see FIG. 4) or in the concentricity monitoring signal interface SGS (see FIG. 5). One of the monitoring modules 10, 26, 28 rotates together with the spindle S of the machine tool WZM and with the tool WZG, e.g. for machining a workpiece. For detailed explanations of the steps for activating and deactivating the monitoring module 10, 26, 28, transmitting the “Ready” status to the machine tool/to the concentricity monitoring signal interface (abbreviated to WZM/SGS in FIG. 21) and checking the stability of the rotational speed during the detection period, please refer to the corresponding descriptions for FIG. 18, for example, which are equally valid here.

The sequence in FIG. 21 is a variant in which measured variables are continuously transmitted to the machine tool WZM/the concentricity monitoring signal interface SGS. The transmitted measured variables can then be analysed, for example, according to the sequence in FIG. 20 (not shown in FIG. 21).

While monitoring whether the speed is stable, the sensor unit 16 of one of the monitoring modules 10, 26, 28 records variables ax, ay that are representative of acceleration and continuously transmits them to the machine tool WZM/the concentricity monitoring signal interface SGS. According to FIG. 21, this can take place directly after the recording of individual acceleration variables ax, ay. Optionally (indicated by the dashed outline of the step in FIG. 21 in which a check is made as to whether the module memory is full), the acceleration variables ax, ay can also be stored in the memory of the monitoring module 10, 26, 28 until this memory is at least almost full or until a defined amount of data is reached. Alternatively, it is possible for defined data packets containing several acceleration variables ax, ay to be temporarily stored in the module memory over a period of time and transmitted to the machine tool WZM/the concentricity monitoring signal interface SGS after this period of time has elapsed. Once the recording duration has been reached, the transmission of the recorded acceleration variables ax, ay is terminated. Since the acceleration variables ax, ay are continuously monitored in this variant, the acquisition duration can, for example, last for an entire machining cycle of a workpiece or at least a part thereof, in particular if this (partial) machining cycle is performed using the same monitoring module 10, 26, 28 and with the same tool WZG. Alternatively, the detection duration can be adapted to the duration of one or more machining steps (drilling, milling, etc.) to be performed by the tool WZG. The module memory can be dimensioned so that it can hold all the values recorded during the recording period, particularly in cases where the recording period is known. Since this variant according to FIG. 21 requires a high energy input, the monitoring module 10, 26, 28 can in particular be equipped with a generator unit for generating its own energy as described with reference to FIG. 14 or 15.

FIG. 22 shows a partial sequence of a concentricity test (evaluation) of a tool WZG carried out in one of the monitoring modules 10, 26, 28 or in the concentricity monitoring signal interface SGS from the perspective of the machine tool WZM. One of the monitoring modules 10, 26, 28 rotates together with the spindle S of the machine tool WZM and with the tool WZG, e.g. for machining a workpiece.

First, the machine tool WZM causes the monitoring module 10, 26, 28 to be inserted into the spindle S of the machine tool WZM and the spindle S to be rotated at the required acquisition speed (see also the description of steps (i) and (ii) in FIG. 6). Then wait until the monitoring module 10, 26, 28 signals that it is ready for data acquisition. For detailed explanations of this step, reference is made, for example, to the corresponding descriptions of FIG. 18, which are equally valid here. When the monitoring module 10, 26, 28 is ready, the monitoring module 10, 26, 28 records the variables ax, ay that are representative of the acceleration. The evaluation can be carried out in the monitoring module 10, 26, 28 as shown in FIGS. 18 and 19 or in the concentricity monitoring signal interface SGS as shown in FIG. 20 (not shown in FIG. 22).

The machine tool WZM waits until information about a concentricity error of the tool WZG is available. This information is transmitted to the machine tool WZM by the evaluating unit, i.e. the monitoring module 10, 26, 28 or the runout monitoring signal interface SGS. If there is a concentricity error in the tool WZG (NOK), the machine tool WZM causes the monitoring module 10, 26, 28 to be removed from the spindle S and cleaned by blowing it off with a stream of compressed air (these steps are omitted in FIG. 22). The machine tool WZM then causes the monitoring module 10, 26, 28 to be replaced in the spindle and then waits again until information about a concentricity error (a concentricity test is performed again according to one of the described variants) of the tool is available (this step is also omitted in FIG. 22). If there is still a concentricity error, the machine tool WZM first blocks workpiece machining so that, for example, no further workpieces that are not dimensionally accurate (rejects) are produced. Furthermore, the rotation of the spindle S is stopped in order to bring the machine tool WZM and the monitoring module 10, 26, 28 with mounted tool WZG into a safe state. In addition, an error is displayed, e.g. on a display of the machine tool WZM, and/or an acoustic error signal is emitted. These three steps can essentially take place simultaneously. If there is no concentricity error (NOK), the machine tool WZM releases workpiece machining.

Subsequently, of course, one of the (partial) methods described in the context of the present disclosure for calibration and/or for concentricity checking etc. can be carried out again using the monitoring module 10, 26, 28 with mounted tool WZG, the machine tool WZM and/or the concentricity monitoring signal interface, possibly effected by the described computer program product.

It is understood that the exemplary embodiments and variants explained above are not exhaustive and do not limit the subject matter disclosed herein. In particular, it is apparent to the person skilled in the art that he can combine the features of the various embodiments and variants with one another and/or omit various features of the embodiments and variants without deviating from the subject matter disclosed herein.

1. Concentricity monitoring module for a tool to be rotated in operation (WZG), comprising:
a tool interface, set up to pick up the tool to be rotated (WZG);
a tool mounting interface, set up for insertion into a tool mounting (WZGA), in particular of a machine tool (WZM) or a machining center (BA);
a sensor unit which is assigned to the concentricity monitoring module in such a way that an axis of rotation of the concentricity monitoring module runs through the sensor unit, the sensor unit being set up to detect variables (ax, ay) in a plane (E) orientated essentially normal to the axis of rotation of the concentricity monitoring module when the concentricity monitoring module rotates, in particular together with the tool (WZG) to be rotated and/or with the tool holder (WZGA);
a computing unit which is arranged to:
to receive the values (ax, ay) representative of the acceleration recorded by the sensor unit;
to determine an overall acceleration (atot) based on the recorded values (ax, ay) representative of the acceleration;
to compare the total acceleration (atot) with a threshold value (SW) dependent on a rotational speed of the runout monitoring module during the detection of the quantities (ax, ay) representative of the acceleration; and
to determine that a concentricity error of the tool to be rotated (WZG), the concentricity monitoring module and/or the tool holder (WZGA) is present if the total acceleration (atot) is greater than the threshold value (SW); and
a communication unit which is communicatively connected to the computing unit and is set up to signal to the machine tool (WZM)/machining center (BA) whether or not there is a concentricity error in the tool to be rotated (WZG), the concentricity monitoring module and/or the tool holder (WZGA).

2. Concentricity monitoring tool holder module for a tool to be rotated in operation (WZG), comprising:
a tool interface, set up to receive the tool to be rotated ren the tool (WZG);
a tool holder (WZGA), set up for insertion into a spin del (S) of a machine tool (WZM) or a machining center (BA);
a sensor unit which is associated with the concentricity monitoring tool mounting me module in such a way that an axis of rotation of the concentricity monitoring tool mounting module extends through the sensor unit, the sensor sor unit being set up to detect variables (ax, ay) in a plane (E) oriented substantially normal to the axis of rotation of the concentricity via monitoring tool mounting module when the concentricity monitoring tool mounting module rotates, in particular together with the tool (WZG) to be rotated and/or with the spindle (S);
a computing unit which is set up for this purpose,
to receive the acceleration-re pre sentative variables (ax, ay) detected by the sensor unit;
to determine an overall acceleration (atot) based on the recorded values (ax, ay) representative of the acceleration;
to compare the total acceleration (atot) with a threshold len value (SW) dependent on a rotational speed of the concentricity monitoring tool holder module during the acquisition of the quantities (ax, ay) representative of the acceleration; and
to determine that a concentricity error of the tool to be rotated (WZG) and/or the tool holder (WZGA) is present if the total acceleration (atot) is greater than the threshold value (SW); and
a communication unit, which is communicatively connected to the computing unit and is set up to signal to the machine tool (WZM)/machining center (BA) whether or not there is a concentricity error of the tool to be rotated (WZG) and/or the tool holder (WZGA).

3. Concentricity monitoring tool module, comprising:
a tool to be rotated during operation (WZG);
a tool holder (WZGA), set up for insertion into a spin del (S) of a machine tool (WZM) or a machining center (BA);
a sensor unit which is assigned to the concentricity monitoring tool module in such a way that an axis of rotation of the concentricity run via monitoring tool module runs through the sensor unit, the sensor unit being set up for this purpose, to detect variables (ax, ay) representative of an acceleration in a plane (E) oriented essentially normal to the axis of rotation of the concentricity monitoring tool module when the concentricity monitoring tool module rotates, in particular together with the spindle (S);
a computing unit, set up for this purpose,
to receive the variables (ax, ay) detected by the sensor unit and relevant to the acceleration representation;
to determine an overall acceleration (atot) based on the recorded values (ax, ay) representative of the acceleration;
to compare the total acceleration (atot) with a threshold value (SW) dependent on a rotational speed of the runout monitoring tool module (28) during detection of the quantities (ax, ay) representative of the acceleration; and
to determine that a runout error of the runout monitoring tool module is present when the total acceleration (atot) is greater than the threshold value (SW); and
a communication unit, which is communicatively connected to the computing unit and is set up to signal to the machine tool (WZM)/the machining center (BA) whether or not there is a concentricity error of the concentricity via machining tool module.

4. Machine tool (WZM) or machining center (BA), comprising:
a spindle (S) to be rotated about an axis of rotation (D) during operation of the machine tool (WZM)/machining center (BA), which is set up to receive a tool mounting interface of a concentricity monitoring module according to claim 1 and to interact operatively therewith;
a communication unit arranged to receive signals from the communication unit of the runout monitoring module; and
a control unit which is connected to the communication unit of the tool machine (WZM)/machining center (BA) and is set up to:
to receive quantities (ax, ay) representative of the acceleration detected by the sensor unit of the runout monitoring module according to claim 1;
to determine an overall acceleration (atot) based on the recorded values (ax, ay) representative of the acceleration;
comparing the total acceleration (atot) with a threshold value (SW) dependent on a rotational speed of the spindle (S) during detection of the quantities (ax, ay) representative of the acceleration; and
to determine that a runout error of the runout monitoring module is present if the total acceleration (atot) is greater than the threshold value (SW).

5. Concentricity monitoring signalling interface (SGS), comprising:
a communication unit which is set up to receive signals from a communication unit of a runout monitoring module according to claim 1; and
a computing unit which is connected to the communication unit of the round run monitoring signalling interface (SGS) and is set up in order to:
to receive quantities (ax, ay) representative of the acceleration detected by the sensor unit of the runout monitoring module;
to determine an overall acceleration (atot) based on the recorded values (ax, ay) that are representative of the acceleration;
comparing the total acceleration (atot) with a threshold value (SW) dependent on a rotational speed of the spindle (S), a rotational speed of the runout monitoring module, a rotational speed of the runout monitoring tool holder module or a rotational speed of the runout monitoring tool module during the detection of the quantities (ax, ay) representative of the acceleration; and
to determine that there is a runout error of the runout monitoring module, if the total acceleration (atot) is greater than the threshold value (SW), wherein
the communication unitof the runout monitoring signal interface (SGS) is set up to signal to the machine tool (WZM)/machining center (BA) whether or not there is a runout error of the tool (WZG) to be rotated during operation.

6. Concentricity monitoring method for a tool (WZG) to be rotated in a machine tool (WZM) or in a machining center (BA) during operation, comprising the steps:
(i) automatically inserting a monitoring module to be rotated during operation or of the monitoring module to be rotated during operation and of the tool (WZG) to be rotated into a spindle (S) of the machine tool (WZM) (WZM)/of the machining center (BA), wherein the monitoring module to be rotated comprises a sensor unit which is assigned to the monitoring module to be rotated in such a way that an axis of rotation of the monitoring module to be rotated runs through the sensor unit;
(ii) Turning the spindle (S) of the machine tool (WZM)/machining itation center (BA) at a specified speed;
(iii) receiving and/or detecting quantities (ax, ay) representative of an acceleration in a plane (E) orientated substantially normal to the axis of rotation of the monitoring module to be rotated, while the monitoring module to be rotated rotates at the predetermined speed;
(iv) Determining a total acceleration (atot) based on the recorded acceleration representative quantities (ax, ay);
(v) comparing the total acceleration (atot) with a threshold value dependent on a rotational speed of the monitoring module to be rotated during the detection of the quantities (ax, ay) representative of the acceleration; and
(vi) Determine that there is a concentricity error of the monitoring module to be rotated and/or the tool (WZG) to be rotated if the total acceleration (atot) is greater than the threshold value (SW).

7. Computer program product comprising instructions that perform the method of claim 6.

8. A concentricity monitoring module according to claim 1, further comprising a further sensor unit (B) which is radially spaced from the axis of rotation and is ge r ted for this purpose, to detect further variables (ax, ay) representative of acceleration in a plane (E) orientated substantially normal to the axis of rotation substantially simultaneously with the detection of the variables (ax, ay) representative of acceleration; and wherein the computing unit is further arranged to to receive the further quantities representative of the acceleration detected by the further sensor unit (B); and to determine from the further quantities representative of the acceleration the rotational number of the concentricity monitoring module/the concentricity monitoring tool tool recording module/concentricity monitoring tool module during the detection of the quantities (ax, ay) representative of the acceleration; and/or wherein the further sensor unit (B) comprises two opposing acceleration sensors (B1, B2) which are spaced radially from the axis of rotation and which are arranged in a plane (E) orientated normal to the axis of rotation, wherein the acceleration sensors B1, B2 have measuring axes which lie in alignment or in a plane orthogonal to the plane (E) and containing the axis of rotation, wherein preferably the acceleration sensors (B1, B2) supply measured values from which respective mean values of the further quantities representative of the acceleration are formed.

9. Runout monitoring module according to claim 1, wherein the rake unit is set up for this purpose, the rotational speed of the concentricity monitoring module/the concentricity monitoring tool holder module/the rotation monitoring tool module during the detection of the quantities representative of the acceleration ni gation based on a signal frequency prevailing during the detection of the quantities (ax, ay) when the axis of rotation of the concentricity monitoring module/the concentricity monitoring tool on module/the concentricity monitoring tool module is orientated essentially horizontally or during the detection of the quantities (ax, ay) representative of the acceleration.

10. Concentricity monitoring module according to claim 1, further comprising a photosensitive unit (PE) having a photosensitive surface located on the outer periphery of the runout monitoring module/the runout via monitoring tool holder module/the runout monitoring tool module, wherein the photosensitive unit (PE) is set up to detect differences in brightness during the detection of the variables (ax, ay) representative of the acceleration, wherein the computing unit is set up for this purpose, the rotational speed of the concentricity monitoring module/the concentricity monitoring tool holder module/the concentricity run monitoring tool module is determined shortly before, after and/or during the detection of the variables (ax, ay) representative of the acceleration based on a frequency of the brightness differences.

11. Runout monitoring module according to claim 1, wherein at least the sensor unit and additionally the further sensor unit (B) is arranged on a sensor board, wherein the sensor circuit board is connected to a circuit board holder bun and wherein a position of the circuit board holder can be adjusted via adjustment means of the concentricity monitoring module/the concentricity monitoring tool receiving module/the concentricity monitoring tool module normal to the axis of rotation.

12. Concentricity monitoring module according to claim 1, wherein
the sensor unit comprises a central recess which is orientated approximately coaxially to the axis of rotation and comprises two acceleration sensors (B1, B2), wherein the first acceleration sensor is arranged on the y-z plane and comprises a sensitive axis orientated orthogonally to the y-z plane, and the second acceleration sensor is arranged on the x-z plane and comprises a sensitive axis orientated orthogonally to the x-z plane.

13. Runout monitoring module according to claim 1, further comprising an energy supply unit (V) arranged to preferably in response to a wake-up signal from an energy-saving or standby mode to a monitoring mode and/or to set the sensor unit, the further sensor unit (B), the computing unit and/or the communication unit, preferably in response to a wake-up signal from an energy-saving or standby mode to a monitoring mode.

14. Runout monitoring module according to claim 13, wherein the wake-up signal is a Signal or is triggered by a signal generated by the further sensor unit (B) as soon as the further variables representative of acceleration exceed a wake-up threshold; or
is generated by the further sensor unit (B) as soon as the further variables representative of the acceleration exceed a wake-up threshold; or
is received via the communication unit from the machine tool (WZM)/the machining center (BA) and/or from the rotation via monitoring signal interface (SGS); or
is generated when an amount of energy generated by the energy supply unit (V) exceeds a predetermined level.

15. Runout monitoring module according to claim 13, wherein the energy supply unit (V) comprises an energy storage unit for storing or a generator unit for generating electrical energy.

16. Runout monitoring module according to claim 15, wherein the generator unit comprises a tor, which is directly or indirectly coupled to the tool holder (WZGA) of the runout monitoring tool holder module/the runout monitoring tool module, or can be directly or indirectly coupled to the tool holder (WZGA), and wherein the generator unit further comprises a rotor which is associated with the runout monitoring module/runout monitoring tool holder module/runout monitoring tool module so that it acts together with the stator in such a men way, that the generator unit generates electrical energy during a rotational acceleration of the concentricity via monitoring module/rotation monitoring tool holder module/rotation monitoring tool module about the axis of rotation.

17. Runout monitoring module according to claim 1, wherein the sensor unit is set up to be operated separately in time from a normal operation, in which the concentricity monitoring module/the concentricity monitoring tool holder module/rotary run monitoring tool module rotates, in particular together with the spindle (S), to detect initial values (ax_initial, ay_initial) representative of an acceleration in the plane (E) orientated substantially normal to the axis of rotation at a substantially constant rotational speed or at several different substantially li constant rotational speeds, and wherein the computing unit is a directed in order to store the initial variables (ax_intial, ay_initial) representative of the acceleration together with the corresponding rotational speed(s) in a memory of the concentricity monitoring module/the concentricity monitoring tool holder module/the concentricity monitoring tool module, and/or wherein the communication unit is set up to transmit the initial variables (ax_initial, ay_initial) representative of the acceleration preferably together with the corresponding rotational speed/the rotational speeds corresponding to the machine tool (WZM)/the machining center (BA) and/or to the concentricity monitoring signal interface (SGS).

18. Runout monitoring module according to claim 1, wherein the computing unit is further arranged to process the variables (ax, ay) and/or the initial variables (ax_initial, ay_initial) representative of the acceleration detected by the further sensor unit and/or the further variables representative of the acceleration and/or the rotational speed of the concentricity monitoring module/the concentricity monitoring tool holder module/the concentricity monitoring tool module detected by the further sensor unit (B) during the detection of the variables representative of the acceleration (ax, ay) for a specific time window of preferably between 50 ms and 200 ms in the form of a data packet, the processing being performed by operations such as signal filtering, averaging and/or determination of a frequency spectrum per time window; and transmitting the data packet after processing to the machine tool (WZM)/machining center (BA) and/or to the runout monitoring signal interface (SGS).

19. Runout monitoring module according to claim 1, wherein the computing unit is further arranged to monitor at least one further process parameter when the runout monitoring module, in particular together with the tool (WZG) to be rotated and/or with the tool holder (WZGA), rotates, or when the concentricity monitoring tool holder module rotates, in particular together with the tool (WZG) to be rotated and/or with the spindle (S), or when the concentricity monitoring tool module rotates, in particular together with the spindle S, wherein the at least one process parameter comprises a vibration, a temperature, a coolant pressure, a coolant flow rate, a cutting force and/or a torque.

20. Concentricity monitoring module according to claim 19, wherein the computing unit is set up to determine the total acceleration (atot) based on a subtraction of the variables (ax_initial, ay_initial) representative of the initial acceleration from the corresponding variables (ax, ay) representative of the acceleration representation.

21. Runout monitoring module according to claim 1,
wherein the computing unit is set up to determine the amount of the runout error and/or the direction of the runout error when a runout error is present; and wherein the communication unit is set up to transmit the amount and/or the direction of the runout error to the machine tool (WZM)/the machining center (BA) according to claim 4 or to the runout monitoring signal interface (SGS) according to claim 5. transmit and/or
wherein the communication unit is set up to signal the presence of the concentricity error to the machine tool (WZM)/the machining center (BA) according to claim 4 and/or the concentricity monitoring signal interface (SGS) according to claim 5 when a concentricity error is present, while the concentricity monitoring module/the concentricity monitoring tool module/the concentricity monitoring tool module rotates, in particular together with the spindle (S).

22. Runout monitoring module according to claim 1, which are each set up for this purpose, detecting the variables representative of the acceleration (ax, ay), detecting the further variables representative of the acceleration, determining the total acceleration (atot), determining whether a concentricity error is present and signalling whether a concentricity error is present, the runout monitoring module/the runout monitoring tool module/the runout monitoring tool module, in particular to together with the spindle (S), is moved by a machine tool (WZM)/a machining center (BA) from a spindle start position to a machining position of a work piece, and wherein this time period is in particular less than 5 seconds.

23. Runout monitoring module in particular according to claim 1, wherein the module is adapted to recognise, by means of predefined speed profiles, functions to be executed by the module or to be initiated in other modules or assemblies, wherein the predefined speed profiles comprise at least (i) a speed, (ii) a duration of a predefined speed (sequence), (iii) a slope of a change in the speed, (iv) a duration of a predefined speed (sequence), and (v) a duration of a predefined speed (sequence), (iii) a gradient of a change from one speed stage to a next speed stage and/or (iv) a duration of a change from one speed stage to a next speed stage of the spindle of the machine tool, in particular detected via an evaluation of the generator voltage, and wherein in particular the functions “execute teach-in or pairing process”, “execute calibration process”, “generate wake-up or wake-up signal”, “enter monitoring or measuring mode”, and/or “enter deep sleep or standby mode” may be included.

24. Runout monitoring module in particular according to claim 1, wherein the module is adapted to perform the detection of the quantities (ax, ay) representative of the acceleration, the detection of the further variables representative of the acceleration, the determination of the total acceleration (atot), the determination of whether a concentricity error is present and the signalling of whether a concentricity error is present only begins when a defined rotational speed is reached, characterised in that during the evaluation time the spindle rotational speed is essentially constant or varies within a range of at most 10% of the rotational speed.
